(19) United States
(12) Patent Application Publication
(10) Pub. No.: US 2015/0295808 A1
(43) Pub. Date: Oct. 15, 2015

(54) SYSTEM AND METHOD FOR DYNAMICALLY MONITORING, ANALYZING, MANAGING, AND ALERTING PACKET DATA TRAFFIC AND APPLICATIONS

(71) Applicant: Matt O'MALLEY, Lake Balboa, CA (US)

(72) Inventors: Matt O'Malley, Lake Balboa, CA (US); Lance Ware, Huntington Beach, CA (US)

(21) Appl. No.: 14/439,949

(22) PCT Filed: Oct. 31, 2013
(86) PCT No.: PCT/US13/67895

§ 371 Date: Apr. 30, 2015

Related U.S. Application Data
(60) Provisional application No. 61/720,996, filed on Oct. 31, 2012.

(51) Int. Cl. H04L 12/26

(52) U.S. Cl. CPC H04L 43/10; H04L 43/0876

(57) ABSTRACT

A computer-implemented system and method is describe, having a usage and performance analyzer system (UP AS) for receiving a data packet or information from a computer or mobile device via a usage and performance analyzer module (UP AM) for evaluating and implementing policies via a dynamic offender polices and enforcement (DOPE) module. Further, wherein the DOPE module comprises a past actions, status, and timers (PAST) module for classifying specific users. A targeted offers notifications and enforcement (TONE) module is for interacting with specific users and devices.

### CROSS REFERENCE

### Claim for Priority and Cross Reference to Related Application

This International Patent Application claims the priority benefit of U.S. Provisional Patent Application Ser. No. 61/720,996, filed on Oct. 31, 2012, the disclosure of which is specifically incorporated herein by reference.

### BACKGROUND

### Field

The present disclosure is directed to quality of service (QoS) management in a communications network, and in particular data traffic in mobile networks, to improve methods and systems for monitoring, analyzing, managing, modifying, routing, throttling, varying, suspending, terminating, upselling, and alerting.

### SUMMARY

This summary herein is provided to introduce a selection of concepts in a simplified form that are further described below in the Detailed Description. This summary is not intended to exclusively identify key features or essential features of the claimed subject matter, nor is it intended as an aid in determining the scope of the claimed subject matter. Further, the numbering employed in this summary is not related to the numbering of specific parts or steps, but rather for contextual relationships.

In various non-limiting embodiments, a computer-implemented method, comprising: receiving a data packet from a second node at a first node, wherein the first node comprises a usage and performance analyzer module (UPAM); determining a data attribute from the data packet, wherein the data attribute identifies the second node; classifying the data attribute according to a predetermined stored policy, the policy with an association with a predetermined behavior of the second node or of an application of the second node; determining, if the classification meets a predefined criteria; generating and transmitting a message to the second node in accordance with the predetermined stored policy. Further, wherein in various non-limiting embodiments, preferably the second node comprises a mobile device.

Further, wherein in various non-limiting embodiments, preferably the mobile device includes an on-device applet for monitoring usage and performance. Furthermore, wherein in various non-limiting embodiments, preferably the usage and performance analyzer module (UPAM) implements the predetermined stored policy, and the policy comprises a dynamic offender policies and enforcement (DOPE) module, the dynamic offender policies and enforcement module comprising a dynamic offender policies and enforcement criteria and parameters. Furthermore, wherein in various non-limiting embodiments, preferably the dynamic offender policies and enforcement criteria and parameters comprise: a past actions status and timers (PAST) module comprising past actions status and timers criteria and parameters; a targeted offers notifications and enforcement (TONE) module comprising targeted offers notifications and enforcement criteria and parameters; a success of offers remedies and termination (SORT) module comprising success of offers notifications and enforcement criteria and parameters; a potential offender profile score (POPS) module comprising potential offender profile score criteria and parameters.

### BRIEF DESCRIPTION OF THE DRAWINGS

Various features and characteristics of the non-limiting and non-exhaustive embodiments disclosed and described in this specification may be better understood by reference to the accompanying figures, in which:

FIG. 1 depicts a network diagram of an embodiment of a NCS 20 for monitoring, analyzing, and managing network traffic.

FIG. 2 depicts a block diagram of an embodiment of the U-PAS 50 system and a U-PAS Server 52.

FIG. 3 depicts a block diagram of an embodiment of a variety of modules and parameters for monitor, analyzing, and managing packets in a data packet network.

FIG. 4a depicts an embodiment of a network communication stack, an illustrative embodiment of associations among different identifiers.

FIG. 4b depicts an illustrative embodiment of a decision tree for relative prompt determinations of the identifiers of applications (e.g. mobile applications) utilizing the network communication stack in FIG. 4a.

FIG. 5 depicts a flowchart of an embodiment of the U-PAS 50/UPAM 53 generating parameters and employing a Dynamic Offender Policies and Enforcement (DOPE) 70 module.

FIG. 6 depicts a flowchart of an embodiment of the U-PAS 50/UPAM 53 generating parameters and employing the DOPE 70 module in association with a Past Actions, Status, and Timers (PAST) module 306.

FIG. 7 depicts a flowchart of an embodiment of the U-PAS 50/UPAM 53 generating parameters and employing the DOPE 70 module in association with the PAST module 306, a Targeted Offers, Notifications, and Enforcement (TONE) 307 module and a Success of Offers, Remedies, or Termination (SORT) 308 module.

FIG. 8 depicts a flowchart of an embodiment of the U-PAS 50/UPAM 53 generating parameters and employing the TONE 307 module.

FIG. 9 depicts a flowchart of an embodiment of the U-PAS 50/UPAM 53 generating iterations employing the DOPE 70 module in association with the PAST module 306, the TONE 307 module, the SORT 308 module, and a Potential Offender Profile Score (POPS) 309 module.

FIG. 10a depicts a flowchart of an embodiment of the U-PAS 50/UPAM 53 generating parameters and employing the POPS 309 module.

FIG. 10b depicts a flowchart of an embodiment of the POPS 309 module for query selection and querying methods.

FIG. 11 depicts a flowchart of an embodiment of the POPS 309 module for query selection and querying methods in more detail.

FIG. 12a depicts a flowchart of an embodiment of the POPS 309 module analysis and methods in more detail.

FIG. 12b depicts a flowchart of an embodiment of the SORT 308 module analysis and methods in more detail.

FIG. 13a is an embodiment of an example screenshot of a graphical user-interface for mobile monitoring and alerts.

FIG. 13b is an embodiment of an Overage Options of the graphical user-interface for mobile monitoring and alerts in FIG. 13a.

FIG. 13c is an embodiment of a Content Options of the graphical user-interface for mobile monitoring and alerts in FIG. 13a.

FIG. 14a is an embodiment of an example screenshot of a graphical user-interface for mobile monitoring usage and performance details.

FIG. 14b is an embodiment of an Upgrade Options of the graphical user-interface for mobile monitoring usage and performance details in FIG. 14a.

FIG. 14c is an embodiment of a Past Alerts/Replies of the graphical user-interface for mobile monitoring usage and performance details in FIG. 14a.

FIG. 15a is an embodiment of an example screenshot of a graphical user-interface for a data usage alert prompted by a threshold with Upgrade Options.

FIG. 15b is an embodiment of an example screenshot of a graphical user-interface for the Upgrade Options for the data usage alert in FIG. 15a.

FIG. 16a is an embodiment of an example screenshot of a graphical user-interface for the data usage alert prompted by the threshold with the Overage Options.

FIG. 16b is an embodiment of an example screenshot of a graphical user-interface for the Overage Options for the data usage alert in FIG. 16a.

FIG. 17 is a block diagram depicting an embodiment of a typical GPRS/UMTS mobile network.

FIG. 18 is a block diagram depicting an embodiment of a Network Communication System 20 as presented.

FIG. 19 is a structural diagram depicting an embodiment of the Network Communication System 20, where there a variety of interconnected communication networks.

FIG. 20 depicts a flowchart of an embodiment of the QoS module and mechanisms.

### DETAILED DESCRIPTION

Described in various non-limiting embodiments of the present disclosure is a system (via a computer processor) and computer-implemented method of variable dynamic management of network traffic in a network for monitoring and managing performance, QoS, policies, and consumption. The network comprising a network host or first node/computer/server (e.g. “Usage-and-Performance-Analyzer-System” (U.-P.A.S., UPAS, or U-PAS) 50) that receives data communications packets from a second node/computer (e.g. computer or mobile device 61, etc.) in the network. From a high-level, the variable dynamic management of the second node/computer on the network is conducted by the U-PAS 50 via a “Usage & Performance Analyzer Module” (U.-P.A.M., U-PAM, U.P.A.M. or UPAM) 53 comprising a “Packet Capture, Analyze, Index & Inject” (P.C.A.I.I. or PCAII) 303 module. In various non-limiting embodiments, when the first node/computer/server comprises the U-PAS 50, UPAM 53, and the PCAII 303 module, the first node/computer/server (e.g. a U-PAS-Server 52) can be assigned to capture and analyze each data communication packet from the second node/computer, wherein the data communication packet is indexed according to a set of packet attributes and electronically stored; and wherein each set of attributes are assigned a unique iterative identifier (UII). Further, the set of packet attributes comprise a packet data element, value, and/or relationship associated with the packet, along with a time-stamp, a packet count, and a data consumption count.

In addition, the UPAM 53 comprises and performs an initializing of a timer and a set of statistics coupled to the PCAII module in the first node/computer/server; an initializing of a “Dynamic Offender Polices & Enforcement” (D.O.P.E. or DOPE) module with a set of DOPE parameters, wherein the DOPE parameters comprise a usage history, current usage plan, packet count thresholds, and current consumption to generate a DOPE criteria with an associated DOPE unique identifier in the first node/computer/server, which in various non-limiting embodiments, would preferably be sent and tracked at the second node/computer.

In various non-limiting embodiments, a parameter broad refers to an individual data point or statistic associated with a function, module, rule, instruction, criteria, and/or the like. In various non-limiting embodiments, the parameter broad refers to any factor that defines a particular system, portion of a particular system, and determines (or limits) its performance. In various non-limiting embodiments, the parameter broad refers to a quantity that that characterizes a statistical population and that can be estimated by calculations from sample data and/or the like. In various non-limiting embodiments, a criteria (or criterion) broad refers to a principle or standard by which something may be judged or decided. In various non-limiting embodiments, a criteria (or criterion) broad refers to a characterizing mark or trait.

Next, the UPAM 53 analysis relatively compares a particular set of DOPE criteria (e.g. a latest set of DOPE criteria) with a particular set of packet attributes (e.g. the latest UII associated with the set of packet attributes) to determine if a particular threshold within the particular set of DOPE criteria has been exceeded. If a particular threshold has been exceeded, then the UPAS/UPAM/DOPE can trigger an appropriate reaction per rules and policies within the DOPE, which may include a variety of modules and associated functions, comprising a “Past Actions, Status, & Timers” (P.A.S.T. or PAST) module, a “Targeted Offers, Notifications, & Enforcement” (T.O.N.E. or TONE) module, a “Success of Offers, Remedies, or Termination” (S.O.R.T. or SORT) module, a “Potential Offender Profile Score(s)” (P.O.P.S. or POPS) module, and/or a “Quality-of-Service” (Q-o-S or QoS) module. Further, wherein a pre-approved and/or appropriate modification by the first node/computer/server and/or second node/computer generates a new UII per the PCAII and, if necessary or required, can also reset the timer and statistics, and generate a new DOPE criteria per the DOPE, PAST, TONE, SORT, POPS, and QoS modules instructions associated with the second node/computer.

In various non-limiting embodiments, the PAST module comprises a list of PAST parameters and instructions for tracking a packet count and data amount per threshold offense committed by the second node/computer. In addition, the list of PAST parameters comprises an assigning and tracking of a list of PAST classifications comprising a “habitual offender,” a “repeat offender,” a “first-time-offender,” and a “perceived-non-offender,” wherein each has a set of associated rules, criteria, and thresholds.

In various non-limiting embodiments, the TONE module can attempt and track a series of TONE interactions, options, and instructions between the first node/computer/server and the second node/computer, wherein a TONE list of interactions/options available, attempted, relatively-successful-interactions, results, interaction-success-scores and/or the like, are generated per PAST classifications and/or users/devices. The TONE list of interactions/options available, attempted, relatively-successful-interactions, results, and interaction-success-scores, further comprising what specifically is considered an overage or an exception; upgrade/not; upsell/not; not-allowed or allowed; not-remedied or remedied; unresolved or resolved; ignored or acknowledged; non-validated or validated; non-verified or verified; and/or unknown, assumed, or a fact; per the associated criteria, thresholds, PAST classifications, and/or second node/computer usage, rules, criteria, and/or the like.

In various non-limiting embodiments, the SORT module monitors and performs a set of SORT policies and criteria for an acceptable resolution to a particular offense that was performed, produced, and/or likely to occur by/at/with the second node/computer, wherein the acceptable resolution to the particular offense by the second node/computer comprises an ability to modify the current usage plan, receive a payment, engage a variable-bit-rate, change a content format, throttle service, inject packets, modify packets, suspend service, terminate service, negotiate a resolution and/or the like. In addition, the TONE list of interactions/options available, attempted, relatively-successful-interactions, results, interaction-success-scores and/or the like, that are sent to and/or performed by second node/computer are tracked by the SORT module and analyzed for relative likelihood of success when compared to a particular past/history, current, and/or future (e.g. usage, behaviors, patterns, value, score, resolution, performance, result, success, etc.) by the UPAM/DOPE 53/70 per the associated criteria, thresholds, PAST classifications, and/or second node/computer usage, rules, criteria, and/or the like.

In various non-limiting embodiments, the POPS module comprises a list of POPS criteria and instructions for interrogating data and sources for determining whether a particular data collected meets a fact criteria, assumption criteria, pending criteria, insufficient criteria, or no criteria. In addition, wherein the list of POPS criteria, searches, webcrawls, queries, interrogates, analyzes, and sources, for POPS data relative to each user/device, where, for example, the network, devices, sources, traffic, packets and/or POPS data/criteria are persistently monitored, interrogated, tested, incremented, validated, verified, isolated, reviewed, calibrated, and/or re-tested.

In various non-limiting embodiments, the DOPE, PAST, TONE, SORT, POPS, and QoS modules track and analyze applications, application behaviors, application usage, and/or the like. In various non-limiting embodiments, the application tracking and analyzing by the DOPE, PAST, TONE, SORT, POPS, and QoS modules may or may not include the tracking of packet data. For example, the application tracking and analysis could be generated metrics, data, criteria, and statistics per a set tools and methods described later herein where the ability to analyze the packet data is not required.

With the ever increasing proliferation of communication modes, features, and applications, especially with mobile devices 61; network providers, mobile network operators (MNO 25), hardware manufacturers, application providers, and/or the like, are continually searching for systems and methods to best deliver and monitor enhanced services and products. Features and applications may incorporate such content as text, images, audio, video, maps, polls, and/or the like, where users may wish to communicate/interact (e.g. via voice, voicemail, email, IM, SMS, MMS, Chat, Social, interactive applications, interactive audio, interactive video, interactive presentations, and/or the like), consume content and applications (e.g. view text/images/video, hear audio, feel alerts, download/use applications, and/or the like), and share content and applications (e.g. playlists, calendars, tasks, feedback, chat/social threads, contacts, mobile apps, and/or the like).

These enhanced services and products also create QoS management issues, where network providers (e.g. MNO 25) are challenged by peak demands, site/network bottlenecks, congestion, overloading, bandwidth constraints, limited resources, subscriber plan overages, billing, event and location capacity, roaming activity, upselling requests, malicious content/applications, and/or the like. Consequently customer support services may become overwhelmed with every new upgrade, device, feature, application, content format, OS upgrade, on-site event, computer virus, and/or the like with issues, concerns, and questions, where accurate information/data, sufficient knowledge, and appropriate remedies may also be a significant challenge for effective MNO 25 and user dialogs.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” “in another embodiment,” “in various non-limiting embodiments,” and similar language throughout this specification may, but do not necessarily, all refer to the same embodiment.

As used herein, the term “modules,” is considered a computer-executable program stored on a computer-readable storage medium. The term “modules” is used in some embodiments of the present disclosure. These modules (e.g. U-PAS (or an IN-U-PAS 51—more later), UPAM, DOPE, PAST, TONE, SORT, POPS, and QoS) modules (e.g. in/at the first node/computer/server) provide information to the second node/computer/device (e.g. to the user of the second node/computer/device), with the modules carrying one or more sequences of instructions, wherein execution of the one or more sequences of instructions by one or more processors embodied therein causes the one or more processors to perform a method for providing interactive information to the user using a computer/device (e.g. a laptop computer, a desktop computer, a mobile device 61, cellular phone, a wireless-enable-computer, and/or the like), typically with a display and input method (e.g. keypad, touchscreen, audio commands, speaker, audio translator, motion detection, and/or the like) as a communication/interaction device. In various non-limiting embodiments, a party or user who is operationally connected to a U-PAS 50 (&/or IN-U-PAS 51) using the communication device with an “on-device” applet 43 and/or who is operationally connected to a Network Communication System (“NCS”) 20, where he/she/it may be potentially exchanging information with the U-PAS 50 (&/or IN-U-PAS 51), is hereinafter together referred to as the user, or sometimes: user/device or device/user. In various non-limiting embodiments, the mobile device 61 may or may not imply the user, where for example some functions and/or mobile devices 61 may function automatically, systematically, and/or conditionally without user inputs.

In various non-limiting embodiments, the communication device may be a phone, such as a cell phone, mobile phone, smart phone, landlines, PDA phone, mobile device 61, or the like that may be employed in a cellular network, LTE network or similar. In various non-limiting embodiments, the mobile device 61 may support various mobile telecommunication standards such as, without limitation, Global System for Mobile communication (GSM), Code Division Multiple Access (CDMA), Time Division Multiple Access (TDMA) or Long Term Evolution (LTE) (or sometimes 4G-LTE). In various non-limiting embodiments, the communication device may also be a Voice over Internet Protocol (VoIP) device/client. For example, the communication device may be a computing device, such as the desktop computer, laptop computer, tablet computer, or PDA, with software enabling the computing device to make VoIP calls over the Internet, or the communication device could simply be a device that plays audio and accepts commands, such as voice commands or motion detection. Some embodiments do not require the communication device to have voice communication capabilities and/or where voice communications or commands are not required or utilized. Some examples of the mobile device 61 may include, without limitation, the Personal Digital Assistant (PDA) 62, cell phone, smart-phone, tablet computer 65, laptop computer 63, netbook, “Vehicle GPS & Computer” 23, Television/IPTV 68, or other network appliance capable of communicating over the network 300, such as private networks, WiFi, WiMax, mesh networks, and/or the like.

Modules can be implemented in software for execution by various types of processors. An identified module of executable code can, for instance, comprises one or more physical or logical blocks of computer instructions, which can, for instance, be organized as an object, procedure, or function. Nevertheless, the executables of an identified module need not be physically located together, but can comprise disparate instructions electronically stored in different locations which, when joined logically together, comprise the module and achieve the stated purpose for the module.

Further, storage medium can include, but is not limited to, one or more of the following: any type of physical media, including floppy disks, optical discs, DVDs, CD-ROMs, microdrives, magneto-optical disks, holographic storage devices, ROMs, RAMs, EPROMs, EEPROMs, DRAMs, PRAMS, VRAMs, flash memory devices, magnetic or optical cards, nano-systems (including molecular memory ICs); paper or paper-based media; and any type of media or device suitable for storing instructions and/or information. Various embodiments include a computer program product that can be transmitted in whole or in part and over one or more public and/or private networks wherein the transmission includes instructions and/or information which can be used by one or more processors to perform any of the features presented herein.

A module of executable code can be a single instruction, or many instructions, and may even be distributed over several different code segments, among different programs, and across several memory devices. Similarly, operational data may be identified and illustrated herein within modules, and may be embodied in any suitable form and organized within any suitable type of data structure. In various non-limiting embodiments, the operational data may be collected as a single data set, or may be distributed over different locations including over different storage devices, and may exist, at least partially, merely as electronic signals on a system or network. In an embodiment, these modules track and analyze data traffic of the NCS 20, carrying one or more sequences of instructions, wherein execution of the one or more sequences of instructions by one or more processors embodied therein causes the one or more processors to perform a method for exchanging information with the U-PAS 50, to a user of the NCS 20.

In an embodiment, these modules track and analyze data traffic of the network 300, carrying one or more sequences of instructions, wherein execution of the one or more sequences of instructions by one or more processors embodied therein causes the one or more processors to perform a method for exchanging information via the U-PAS 50 to a user of the network 300. In various non-limiting embodiments, the U-PAS monitors and manages QoS of a plurality of network communication devices/users. The plurality of network communication devices/users, in general, the network communication user utilizes a computer client/communication device comprising the laptop computer 63, the desktop computer 67, the mobile device (e.g. cellular phone) 61, personal digital assistant (PDA) 62, a wireless-enabled-computer, the tablet computer 65, a “vehicle with GPS and computer” 23, a Television/IPTV 68, the VOIP phone/client 66, a server 42, and/or the like, typically with a display and input method (e.g. keypad, touchscreen, audio commands, speaker, audio translator, and/or the like) as the communication device. In various non-limiting embodiments, the U-PAS 50 system, modules, and associated computer implemented methods track and analyze data traffic of the networks 300 (e.g. packet networks) and the plurality of operationally connected network communication devices/users, where, for example, the devices employ an at least one packet 44 to communicate what data is sent from a first node/computer/server to a second node/computer. In various non-limiting embodiments, the U-PAS monitors the packets 44 and manages the QoS in the networks 300 and the plurality of network communication devices/users. In various non-limiting embodiments, the U-PAS monitors the utilization of applications and manages the QoS in the networks 300 and the plurality of network communication devices/users accordingly as described herein.

### RELATED APPLICATIONS

Implementing, determining, and providing a system for dynamic mobile application quality-of-service monitor (operational via a computer processor) and (computer-processor-based) method is described in U.S. Pub. No. 2012/0069748 A1, Van Den Bogaert, is hereby incorporated by reference in its entirety for all purposes, which can be implemented in various non-limiting embodiments of the present disclosure.

Implementing, determining, and providing a system for a real time parser for data packets in a communications network (operational via a computer processor) and (computer-processor-based) method is described in U.S. Pat. No. 5,805,808, Hasani et. al, is hereby incorporated by reference in its entirety for all purposes, which can be implemented in various non-limiting embodiments of the present disclosure.

Implementing, determining, and providing a system for variable dynamic throttling of network traffic for intrusion prevention (operational via a computer processor) and (computer-processor-based) method is described in U.S. Pat. No. 7,719,976 B2, Christenson et. al., is hereby incorporated by reference in its entirety for all purposes, which can be implemented in various non-limiting embodiments of the present disclosure.

Implementing, determining, and providing a system for edge transversal dormancy (operational via a computer processor) and (computer-processor-based) method is described in U.S. Pat. No. 8,028,076 B2, Abzarian et. al., is hereby incorporated by reference in its entirety for all purposes, which can be implemented in various non-limiting embodiments of the present disclosure.

Implementing, determining, and providing a system for auto-IP traffic optimization in mobile telecommunications (operational via a computer processor) and (computer-processor-based) method is described in U.S. Pat. No. 7,466,652 B2, Lau et al., is hereby incorporated by reference in its entirety for all purposes, which can be implemented in various non-limiting embodiments of the present disclosure.

Implementing, determining, and providing a system of data transmission (operational via a computer processor) and (computer-processor-based) method is described in U.S. Pat. No. 8,064,095 B2, Gasparroni et al., is hereby incorporated by reference in its entirety for all purposes, which can be implemented in various non-limiting embodiments of the present disclosure.

Implementing, determining, and providing a network for realizing local roaming for subscribers system (operational via a computer processor) and (computer-processor-based) method is described in U.S. Pat. No. 7,613,454 B2, Zhang, is hereby incorporated by reference in its entirety for all purposes, which can be implemented in various non-limiting embodiments of the present disclosure.

Implementing, determining, and providing a system for providing network support services and premises gateway support infrastructure (operational via a computer processor) and (computer-processor-based) method is described in U.S. Pat. No. 8,281,010 B2, Ansari et al., is hereby incorporated by reference in its entirety for all purposes, which can be implemented in various non-limiting embodiments of the present disclosure.

The following description and the annexed drawings set forth in detail certain illustrative features of the one or more aspects. These features are indicative, however, of but a few of the various ways in which the principles of various aspects may be employed, and this description is intended to include all such aspects and their equivalents.

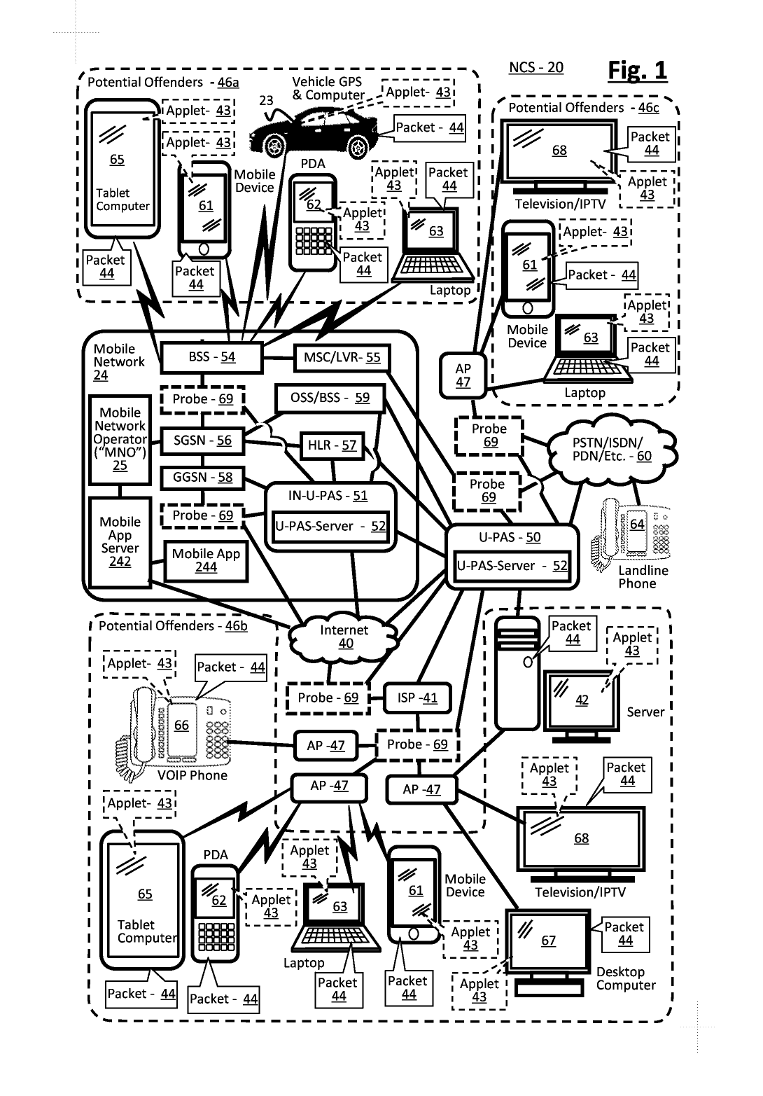

FIG. 1 depicts a network diagram of an embodiment of the NCS 20 for monitoring, analyzing, and managing network traffic. Here, a plurality of Potential Offenders 46 are interconnected via a variety of methods (e.g. networks and computer clients/devices). In various non-limiting embodiments, the U-PAS 50 would preferably provide the computer devices/clients (e.g. devices with associated potential offenders 46, 46a, 46b, and 46c) an ability track data traffic over the network 300 (e.g. via an Internet 40; a Mobile Network 24; and/or a Public Switched Telephone Network (PSTN), an Integrated Services Digital Network (ISDN), Public Data Network (PDN), etc. (collectively referred to here as a PSTN/ISDN/PDN/Etc.) 60, with any type of viable and operational communication connection and computer/device, where, for example, the U-PAS 50/IN-U-PAS 51 may monitor, analyze, and/or manage traffic.

In various non-limiting embodiments, the network 300 may be, without limitation, a wireless network, such as a mobile network (MN) 24 (e.g., GSM, CDMA, TDMA, or LTE), a wireless local area network (WLAN), a wireless Metropolitan area network (WMAN), or the like or any combination thereof. In various non-limiting embodiments, the Mobile Network 24 comprises a MSC or Mobile Switching Center (MSC) and a VLR or Visiting/Visitor Location Register (VLR), collectively a MSC/LVR 55; a OSS or Operations Support Systems (OSS) and a BSS or Business Support Systems (BSS—and not to be confused with a BSS 54—ahead), collectively a OSS/BSS 59; a HLR or Home Location Register (HLR) 57; the BSS 54 or Base Station Subsystem (BSS) 54 (not to be confused with the earlier BSS of OSS/BSS 59).

The OSS or Operations Support Systems (OSS) are computer systems used by telecommunications service providers (e.g. MNOs 25). The term OSS broadly refers to “network systems” dealing with the telecom network itself, supporting processes such as maintaining network inventory, provisioning services, configuring network components, and managing faults. The complementary term, business support systems or BSS (of the OSS/BSS 59), is a relatively newer term and typically refers to “business systems” dealing with customers, supporting processes such as taking orders, processing bills, and collecting payments. The two systems together are often abbreviated OSS/BSS 59, BSS/OSS or simply B/OSS.

Whereas, the BSS 54 broadly refers to the section of a traditional cellular telephone network (e.g. mobile network 24) which is responsible for handling traffic and signaling between the mobile device/phone and a network switching subsystem. The MSC or Mobile Switching Center (MSC) broadly refers a 3G (or similar, e.g. 4G/LTE) core network element which controls the network switching subsystem elements. The VLR or Visiting/Visitor Location Register (VLR) broadly refers to a database of the subscribers who have roamed into the jurisdiction of the MSC (Mobile Switching Center) which it serves.

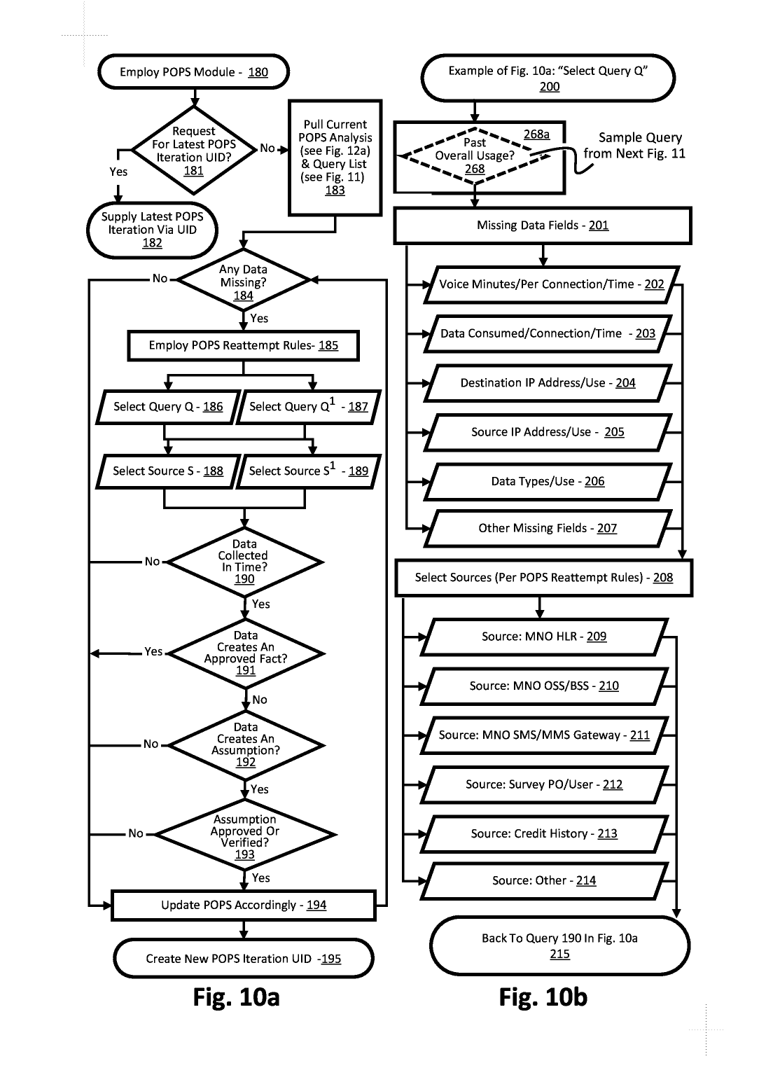

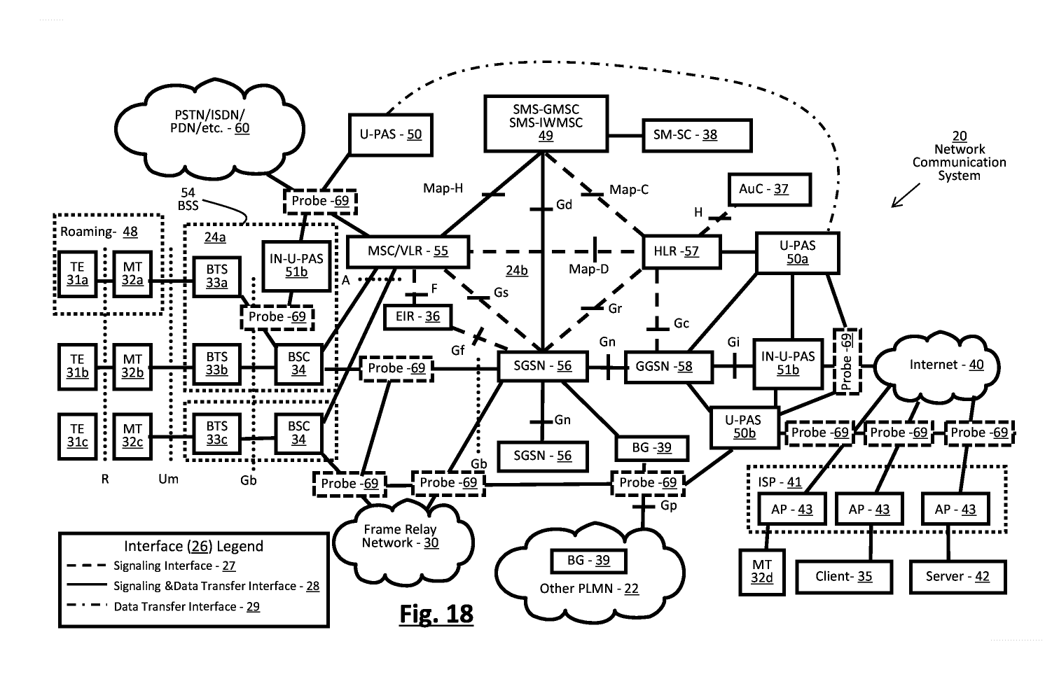

The HLR 57 or Home Location Register (HLR) broadly refers to a central database that comprises details of each mobile phone/device subscriber that is authorized to use the GSM core network (or similar communications network). There can be several logical, and physical, HLRs 57 per public land mobile network (PLMN), though one international mobile subscriber identity (IMSI)/MSISDN pair can be associated with only one logical HLR 57 (which can span several physical nodes) at a time. Also see FIG. 10b for OSS/BSS 59 and FIGS. 18 & 19 regarding MSC, HLR, and VLR.

In various non-limiting embodiments, the Mobile Network 24 comprises a plurality of MNOs 25, which may or may not interconnected. In various non-limiting embodiments, wherein the plurality of MNOs 25 are operationally interconnected, some MNO elements may or may not be operationally interconnected, such as the MSC, VLR, MSC/LVR 55, OSS/BSS 59, HLR 57, BSS 54. Further, where the U-PAS 50 (&/or IN-U-PAS 51) can become an interchange for the MNO elements, and/or provide a same, similar, redundant, and/or the like, functionality, purpose, and/or the like.

In various non-limiting embodiments, the network 300 may also be a wired network, such as local area network (LAN), wide area network (WAN), metropolitan area network (MAN), global area network such as the Internet, a Fiber Channel fabric, or any combination of such interconnects. Network communications, such as HTTP requests/responses, Wireless Application Protocol (WAP) messages, Mobile Terminated (MT) Short Message Service (SMS) messages, Mobile Originated (MO) SMS messages, or any type of network messages may be exchanged among the devices coupled to the network 300.

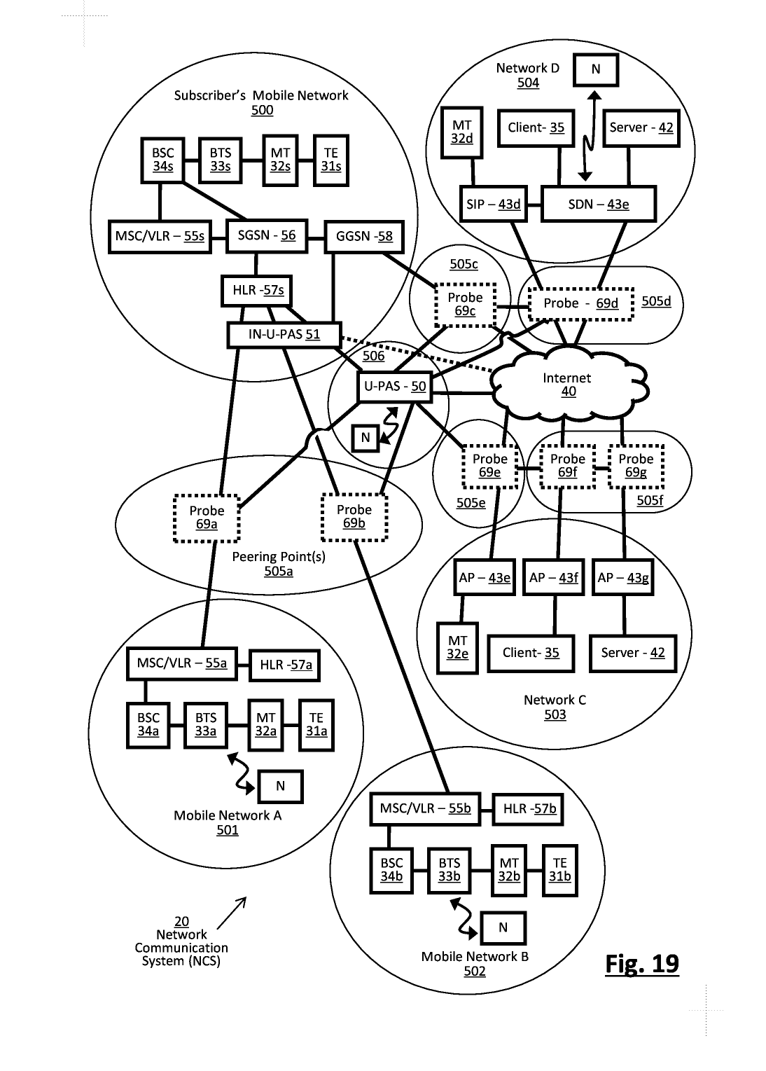

In various non-limiting embodiments, the Potential Offender 46 is typically someone or a machine that generally consumes minutes, data, content, and may also interact, request, search, query, answer, challenge, verify, organize, track, comment, pull data, download, stream, push/share, chat, text, and/or the like; via data packets 44 contained in data, content, media, and/or the like. In various non-limiting embodiments, the Potential Offenders 46 are computer clients/users, comprising the Tablet Computer 65, the Mobile Device 61, the PDA 62, the Laptop 63, the “Vehicle GPS and Computer” 23, a mobile network subscriber/user, and/or the like; who are operationally connected to the Mobile Network 24 via his/her/its Communication Device. In various non-limiting embodiments, the Potential Offenders 46a may all be operationally connected to the same Mobile Network Operator 25 or via a variety of Mobile Network Operators 25, including roaming, a variety of countries and/or the like (also see FIG. 19). In various non-limiting embodiments, the Potential Offenders 46a are operationally connected and contained within to the same Mobile Network 24.

In various non-limiting embodiments, the Potential Offenders 46b are computer clients/users, comprising the VOIP Phone 66, the Tablet Computer 65, the PDA 62, the Laptop 63, the Mobile Device 61, the Desktop Computer 67, the Television/IPTV 68, the Server 42 (e.g. a Third Party Server) and/or the like; who are operationally connected to the Access Point (AP) 47 via his/her/its Communication Device/Client. In various non-limiting embodiments, the Potential Offenders 46b may all be operationally connected to the same Network 300 (not depicted) or Internet 40 via the same Access Point 47 and/or the same Internet Service Provider (ISP) 41; and/or via a variety of Access Points 47 and/or a variety of ISPs 41.

In various non-limiting embodiments, the Potential Offender 46c are computer clients/users, comprising the Television/IPTV 68, the Mobile Device 61, the Laptop 63, and, not depicted in 46c: the VOIP Phone 66, the Tablet Computer 65, the PDA 62, the Desktop Computer 67, the Server 42 (e.g. the Third Party Server) and/or the like; who are operationally connected to the PSTN/ISDN/PDN/Etc. 60 directly and/or via an Access Point (AP) 47 and/or an Internet Service Provider (ISP) 41 or via a variety of Access Points 47, and/or a variety of ISPs 41, and/or a variety of the PSTN/ISDN/PDN/Etc. 60; and/or the like. In various non-limiting embodiments, the MN 24, PSTN/ISDN/PDN/Etc. 60, and Internet 40 may be operationally interconnected. In various non-limiting embodiments, the Potential Offenders 46a, 46b, and 46c may be operationally interconnected, where some communication devices may, for example, seamlessly transfer from one network to another. In various non-limiting embodiments, the Potential Offenders 46a, 46b, and 46c may be collectively interchangeable and/or referred to as the Potential Offender (PO) 46.

In various non-limiting embodiments, the Potential Offender 46a/b/c are operationally connected to the U-PAS (IN-U-PAS) directly (not depicted here) and/or via a Probe 69. In various non-limiting embodiments, the Probe 69 receives and/or sends data, data packets, traffic flow, and/or the like with/to/from the U-PAS 50 (&/or IN-U-PAS 51). In various non-limiting embodiments, the Probe 69 has some or all the functionality of the U-PAS 50/UPAM 53.

Generally speaking, in a computer network, a proxy server is a server (a computer system or an application) that acts as an intermediary for requests from a client (e.g. device, computer) seeking resources from other servers. A client connects to the proxy server, requesting some service, such as a file, connection, web page, streaming content, or other resource available from a different server and the proxy server evaluates the request as a way to simplify and control its complexity. Broadly speaking, proxies (or proxy servers) provide additional structure and encapsulation to distributed systems (e.g. mobile networks, Internet, networks, etc.), where most proxies are web proxies, facilitating access to content on the World Wide Web.

In various non-limiting embodiments of the present disclosure, the U-PAS 50 (&/or IN-U-PAS 51) and/or the like, is a proxy server. In various non-limiting embodiments of the present disclosure, the U-PAS 50 (&/or IN-U-PAS 51) and/or the like, performs and/or provides the same or similar functionality as the proxy server. In various non-limiting embodiments of the present disclosure, the U-PAS 50 (&/or IN-U-PAS 51) and/or the like, perform and function in conjunction with a particular proxy server and/or a plurality of proxy servers. In various non-limiting embodiments, the terms “U-PAS” and “proxy server” are interchangeable.

In various non-limiting embodiments, the communication devices may support an application where, for example, the network connection may or may not require a connection or persistent connection. An application, also referred to as an “app,” generally refers to a software application that executes on the computing device, such as the mobile device 61 (e.g., the mobile device refers to a computing device that includes a processor for executing a software application). For example, mobile devices 61 include smart phones, tablets 65, laptops 63, and/or other mobile devices 61. Various application platforms exist for different operating systems, such as Microsoft Windows® platforms, Google Android® platforms, and Apple iOS® platforms. Application markets (e.g., app stores) exist for each of these application platforms, which can make available thousands to millions of different apps for such platforms. For example, various apps are available for executing on smart phones such as the HTC EVO® or Apple iPhone®, tablets such as the Samsung Galaxay Tab®, Microsoft Surface®, Motorola Xoom® or Apple iPad®, embedded devices executing the Google Android® operating system, and computer operating systems such as Apple Mac OS X® and Microsoft Windows 8®.

Also, as these operating system platforms for mobile devices 61 converge with legacy computer desktop and laptop operating system platforms (e.g., Microsoft Windows® 8 and Apple Mac OS X®), similar app markets and availability of common apps across such platforms are becoming increasingly common.

With hundreds of thousands to millions of different apps for such platforms available to consumers, enterprises (e.g., various entities, including corporate entities, government entities, and other entities) are confronted with supporting and/or managing these various devices that can have a variety of such apps on users' devices. Enterprise challenges include the increasing usage by, for example, employees of their own devices that can have access to corporate resources (e.g., employee smart phones, tablets, etc.). The ever growing number and variety of apps also poses a significant challenge for entities to manage and monitor the downloading, installation, and usage of such apps by users on devices that can have access to corporate resources. Further, where content, playlists, event-list, requests-lists and/or the like, may be transferred peer-to-peer (e.g. via ad-hoc networks, mesh networks, Bluetooth, Wi-Fi, NFR, and/or the like) and/or may employ transferrable media methods, cabling, and/or the like, to transfer some data/content.

In various non-limiting embodiments, the device, mobile device 61, or Communication Devices used by Potential Offender's 46 can be referred to as a transceiver (e.g. computer, mobile device 61, mobile phone, PDA, cellular phone, and/or the like) that allows communication and data exchange from itself and the U-PAS 50. Using a cellular communication as an example, where a mobile subscriber, here a first Potential Offender 46x uses a mobile device 61 as the communication device and may operationally connect to second Potential Offender 46y via the MNO 25, where the U-PAS 50 (&/or IN-U-PAS 51) may also be employed. In various non-limiting embodiments, the U-PAS 50 and/or some components of the U-PAS 50 may be physically located separately from the MNO 25 and/or where all or some components are physically located inside the MN 24 or inside the MNO's 25 network (or “In Network” OR “IN”), generally referred to as the IN-U-PAS 51.

In addition, on many mobile devices 61, particularly smart phones, tablets, and embedded devices, the devices themselves can be resource constrained (e.g., limited CPU capabilities, limited memory capabilities, limited storage, antenna range/reception, and/or strong dependency on the battery). These resource limitations can put tight constraints on resource-intensive operations. Traditional “on-device” dynamic analysis for both hardware and software can not only constrain and sandbox the hardware and/or software, but can also make for impractical and/or undesirable results. To help limit “on-device” resource-intensive detection and over-restrictive results, the present disclosure can generate permission models and/or criteria that can be implemented on the mobile device 61. In various non-limiting embodiments, the permission models and/or criteria can successfully analyze packets 44 and apps 244 for potential overages, opportunities (e.g. upsell) and/or the like. These permission models and/or criteria can include conditions that restrict a level of data throughput, performance, and accessibility, along with potential remedies, and/or cap data access/usage per preset thresholds, criteria and/or conditions.

In addition, “on device” applications can monitor usage and isolate packets for further analysis based upon such characteristics as user patterns/behaviors per device, user, a group of users, a segment of users, a device characteristic, software characteristic, and/or the like. Further, the “on device” monitoring can store behavior patterns unique to the device, software, user, location, time of day, and/or the like.

In some embodiments, on-device monitoring includes receiving a software inventory for the mobile device 61, in which the software inventory identifies a plurality of applications 244 installed on the mobile device 61; and determining whether one or more of the plurality of applications 244 identified in the software inventory are associated with behaviors likely to produce an overage, e.g. of data, bandwidth, throughput, volume, capacity, characters, minutes, and/or the like. In various non-limiting embodiments, the on-device monitoring includes enforcing the policy on the mobile device 61 via a specific application 244 or Applet 43. In various non-limiting embodiments, the policy includes one or more of the following: a DOPE criteria, PAST criteria, TONE criteria, POPS criteria (explained more herein), a malware policy, privacy policy, and/or, say an enterprise configured app security policy and/or the like.

In various non-limiting embodiments, the U-PAS 50 implements a holistic approach to monitoring and analyzing data, and can automatically analyze packets 44 and apps 244 to determine various data attributes and properties, such as one or more of the following: market reputation of the packet source, packet destination, app utilized, and/or the like; the likely presence of video, audio; SMS, text; app-ware; firm-ware; instructions; programming practices; timing, speed, volume, reliability, concerns, relative changes (e.g. historically, recently, currently, etc.); malware; malicious changes to existing apps; data exfiltration; corporate intellectual property (IP) impacts; cryptographic weakness or implementation faults; security issues/risks; privacy concerns (e.g., location tracking, extracting contact book, sharing browsing history, etc.); energy usage (e.g., CPU cycles measured and compared with apps in similar categories or other versions of the same app, such as Facebook® app (e.g. version X v. version Y), Netflix® app (e.g. content A v. content B); along with network performance, analysis, statistics, and usage metrics (e.g. cellular v. LTE v. Wifi; home network v. roaming; tethered or not usage) and/or the like.

For example, these techniques performed by the U-PAS 50 can be implemented as a fully automated solution for quantifying the likelihood of problem (e.g. an overage of a particular potential offender or traffic route) that in turn can increase the detection of known offenders, screen for new and/or unknown offenders, identify behaviors, applications, and operating systems (e.g., including the Google Android® operating system and the Apple iOS® operating system), say relative to an event, location, time of day, and/or the like. For example, some government offices experienced network slowdowns, latency, and outages during the 2012 Olympics®, where employees were downloading and/or streaming relatively large amounts of data of, say the on-going Olympic® events.

In various non-limiting embodiments, the potential offender (46) is characterized as ‘potential’ because it is possible that he/she may not-have or has-never offended, or that some non-offending data communications packets are incorrectly indicative of suspicious and/or are incorrectly perceived as indicative of contract-offending activity. That is, legitimate, non-offending data packets may initially appear to the network host or U-PAS-Server (52) as offending data packets. Where, in various non-limiting embodiments, the U-PAS/UPAM would preferably perform subsequent analysis that would attempt to isolate such packets for further verification, validation, correction/modification, reassignment, and/or the like.

In various non-limiting embodiments, the U-PAS 50/UPAM 53 modules track and analyze data traffic of the network 300 of the network communication device, via a data packet analysis of a data packet (or packet) 44 flowing along a communication link, including communication links in the mobile network 24. In various non-limiting embodiments, the mobile network 24 data traffic is tracked and analyzed by the U-PAS 50. In various non-limiting embodiments, the U-PAS 50 would preferably monitor packets in near real-time, if not real-time. In various non-limiting embodiments, the U-PAS 50 packet monitoring would preferably provide means and computer-implement methods to control the packet 44, an associated communication device, an associated packet flow, an associated packet source, an associated packet destination, an associated packet network, an associated subscription plan, an associated insurance policy, and/or the like. In various non-limiting embodiments, the U-PAS 50 packet monitoring would preferably provide means and computer-implement methods to control the packets 44 associated with the mobile device 61 comprising such means and methods as a throttle, a variable-bit-rate (VBR), cap, injection (e.g. modify), suspension, routing, re-routing, termination, and/or the like.

In various non-limiting embodiments, the U-PAS 50 would preferably continually monitor and analyze packet transmissions per communication device. In various non-limiting embodiments, the U-PAS 50 would continually monitor and analyze packet transmissions per communication device, and would preferably automatically, conditionally, and/or user-selectively send a notification/alert to the computer client/communication device/user of a confidence factor (e.g. a known, discerned, and/or relatively perceived confidence) of a particular traffic event (e.g. issue, incident, concern, potential overage, overage, opportunity, and/or the like). In various non-limiting embodiments, the network communication device/user would preferably employ a packet data protocol/communications. In various non-limiting embodiments, the plurality of network communication devices/users comprises the Potential Offenders 46 (e.g. 46a, 46b, 46c, and a Perceived Non-Offender (PNO) 284), Offenders 280 (e.g. a Habitual Offender (HO) 281, a Repeat Offender (RO) 282, a First Time Offender (FTO) 283, and/or the like), and/or the like.

In various non-limiting embodiments, the analysis of the confidence factor and/or each particular traffic event (or application event) would preferably incorporate a threshold, range, and/or the like; where the analysis would preferably incorporate computer instructions, logic, rules, filters, weighting, conditions, and/or the like. In various non-limiting embodiments, the analysis of the confidence factor and/or each particular traffic event (or application event) would preferably include values that define each incorporated and associated threshold value, range start/end, and/or the like. In various non-limiting embodiments, the values that define each incorporated and associated threshold value, range start/end, and/or the like; would preferably incorporate near-real-time, if not real-time, network intelligence, to generate values dynamically. In various non-limiting embodiments, the analysis of the confidence factor and/or each particular traffic event (or application event) would preferably generate a collective value which could be utilized for additional analysis, scoring, criteria, thresholds, comparisons, and/or the like.

Implementing, evaluating, determining, and providing a system (operational via a computer processor) and method (computer-processor-based) for messages is described in Ser. No. 13/127,993, O'Malley et al., is hereby incorporated by reference in its entirety for all purposes, which can be implemented in various non-limiting embodiments of the present disclosure. Here O'Malley et al. explain systems and methods for messaging a user, e.g. with a selected message (an audio message) initiated during the call setup of a mobile call and where the selected message is selected by a “Message Selection Engine” (MSE). Further, the selected message would preferably include an associated action, wherein the associated action is selected by an “Action Selection Engine” (ASE) (more below).

In an embodiment, a particular traffic event (e.g. a particular data count obtained by a specific device/plan) or application event (e.g. a particular input obtained by a specific device/plan per a particular application and/or version of the application) would preferably prompt an alert when the analysis produced, say a particular value that exceeds/surpasses a particular set threshold value and/or a particular dynamic threshold value (and/or where the value fell within the set range and/or the dynamic range). In various non-limiting embodiments, the alert would preferably prompt the (MSE) with an associated module to send a message (e.g. DOPE-notification/TONE-option) to the communication device/user accordingly. In various non-limiting embodiments, the alert would preferably prompt the MSE with the associated module and the (ASE) with an associated module to collectively send a message/action (e.g. DOPE-notification/TONE-option(s)) to the communication device/user accordingly. For example, the message/action may be generated per an analysis perception, assumption, consumption, expectation, bill, payment method, limit, restriction, and/or the like (e.g. an alert of a potential overage sent per a particular threshold) Further, the message/action may produce an acknowledgement, response, modification, resolution, and/or the like, from the particular user/device. In various non-limiting embodiments, the U-PAS/UPAM tracks each message, alert, and/or the like, where a subsequent message, action, and/or message/action is sent, attempted, tracked, modified, analyzed, isolated, scored, and/or the like.

In various non-limiting embodiments, the audio message alert (also referred to as an Actionable Audio Message (AAM)) that is sent by the U-PAS 50, may be initiated by a flagging of the network communication device/user by a mobile network operator (MNO) 25, wherein the flagging of the network communication device/user prompts the U-PAS 50 to employ the MSE that may send and/or play the AAM during the call setup time of a phone call. In various non-limiting embodiments, the AAM may be played, paused, delayed, forwarded, electronically stored, retrieved, and/or the like. In various non-limiting embodiments, the AAM may be played, triggered, paused, delayed, forwarded, electronically stored, retrieved, and/or the like.

In various non-limiting embodiments, the AAM may incorporate a variety of associated actions (e.g. a DTMF for a particular campaign and campaign rules), where the U-PAS 50 would employ an action selection engine (ASE) to select a specific action to associate with the AAM (e.g. and the particular campaign and campaign rules) sent to the network communication device/user via an audio message alert (e.g. the AAM) sent by the U-PAS 50, may be initiated by a flagging of the network communication device/user by the MNO 25, where, for example, the flagging of the network communication device/user prompts the U-PAS 50 to employ the MSE that may send and/or play the AAM during the call setup time of a phone call.

In various non-limiting embodiments, the AAM is an audio message that may be played and/or where voice communications or commands are not required or utilized. Some embodiments do not require the communication device to have voice communication capabilities and/or where voice communications or commands are not required or utilized. In various non-limiting embodiments, the sending/playing of the AAM by the U-PAS 50 to the network communication device/user may be sent/played to any type of network communication device, whether the device employs the packet 44 data protocol/communications or not.

In various non-limiting embodiments, the U-PAS 50 includes user login capabilities, billing management, the ability to specify and/or modify a mobile plan, data plan, payment method, insurance, roaming allowance, territory allowance, exceptions, temporary allowance, options, threshold settings, and/or the like. In various non-limiting embodiments, the U-PAS 50 further allows users and network operators (e.g. MNO 25) to create, manage, distribute, measure, report, offer, track, sequence, revert, insure, score, adjust, and/or the like, their content, data, billing, service, contract, terms, media, insurance, and/or the like; for the potential offenders 46. In various non-limiting embodiments, the MNO 25 may access the U-PAS 50 through a standard web interfaces, and the U-PAS 50 may also provide a unique Application Programming Interface (API) solution for MNO 25 (and/or the like) who wish to provide direct and/or conditional (e.g. paid, limited, subscription, lease, streamed, downloaded, and/or the like) access to their content, media, data, applications, tools, and/or the like.

In various non-limiting embodiments, the U-PAS 50 allows the MNO 25 (and/or the like) to setup specific and/or conditional rules for access, as well as what specific requests, follow-up actions, feedback, logic, and/or the like a particular Potential Offenders 46/46a or a particular Potential Offenders 46/46a segment type, a particular access type or a particular access segment type, another segmentation type, a particular application, application type, application user/device, device, user, a particular window of time, a particular network type, a particular account type, and/or the like, setup with rules and instructions for each particular subscriber/user, communication device, mobile plan, OS, application, version, data plan (e.g. Current Plan), piece of content, data, rule, and/or the like. In addition, the U-PAS 50 provides accounts organization capabilities and reporting functionality, including revenue reports with various ways to view data, such as summary totals by Potential Offenders 46a segmentations (e.g. Demographics, Psychographics, Location, Motion, Contact History, Behavioral, etc.); timing, and usage tracking; feedback, requests, consumption, application, content type, content source, alert metrics, action metrics and/or conversion metrics; and event optimization and completion goals.

Exemplary embodiments of the present disclosure are described largely in the context of a fully functional computer system for variable dynamic management of network traffic for tracking data consumption, remedying overages, and upselling opportunities. Readers of skill in the art will recognize, however, that the present disclosure also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the disclosure as embodied in a program product. Persons skilled in the art will recognize immediately that, although some of the exemplary embodiments described in this specification are oriented to software installed and executed on computer hardware, nevertheless, alternative embodiments implemented as firmware or as hardware are well within the scope of the present disclosure.

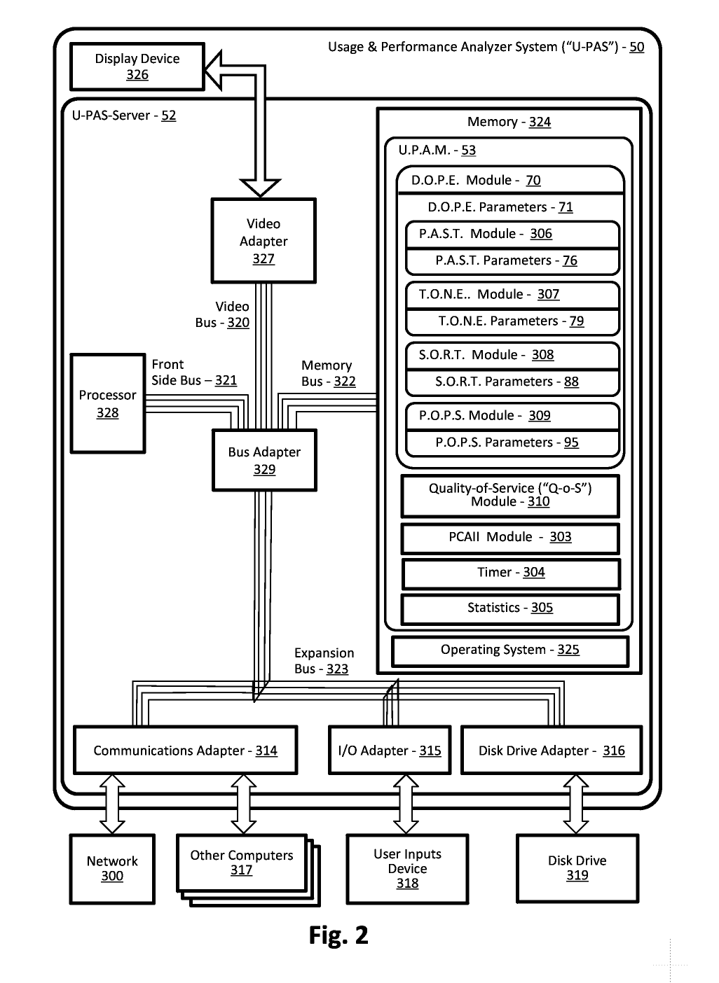

FIG. 2 depicts a block diagram of an embodiment of the U-PAS 50 system for automated computing machinery comprising an exemplary network host or U-PAS Server 52 useful in variable dynamic management of network traffic for data monitoring (e.g. packets), analysis, and overage prevention according to various non-limiting embodiments of the present disclosure. In various non-limiting embodiments, the U-PAS Server 52 of FIG. 2 includes at least one computer processor (328) or ‘CPU’ as well as a Memory (324) which is connected through a Memory Bus (322) and a Bus Adapter (329) to a processor (328) and to other components of the network host or U-PAS Server 52.

Electronically stored in the Memory (324) is the UPAM (53), a module of computer program instructions for variable dynamic management of network traffic for data monitoring (e.g. packets), analysis, and overage prevention according to embodiments of the present disclosure that initialize, the DOPE (70) module with DOPE Parameters (71), the PAST (306) module with PAST Parameters (76), the TONE (307) module with TONE Parameters (79), the SORT (308) module with SORT Parameters (88), the POPS (309) module with POPS Parameters (95), and the PCAII (303) module.

In various non-limiting embodiments, the UPAM (53) and the D.O.P.E. Module (70) with the D.O.P.E. Parameters (71), also starts a timer (304). In various non-limiting embodiments, the timer (304) may incorporate a set of conditions, where for example, a particular set of conditions could cause the timer 304 to remain on no longer than a predefined time interval. In various non-limiting embodiments, the UPAM (53) also maintains, while the timer (304) is on/open, statistics (305) including a packet count by the PCAII (303). For each packet received by the UPAM (53) (e.g. via the PCAII (303)), the UPAM (53)/PCAII (303) also determines, in dependence upon the statistics (305) and the QoS module (310). Also electronically stored in Memory (324) is an operating system (325) (or OS). Operating systems useful in network hosts (e.g. U-PAS Server 52) according to embodiments of the present disclosure include UNIX™, Linux™, Microsoft Windows® platforms, Google Android® platforms, and Apple iOS® platforms.AIX™, IBM's i5/OS™, and others as will occur to those of skill in the art. Operating system (325), the UPAM (53), the D.O.P.E. Module (70) with the D.O.P.E. Parameters (71), the PAST Module (306) with the PAST Parameters (76), the TONE Module (307) with the TONE Parameters (79), the SORT Module (308) with the SORT Parameters (88), the POPS Module (309) with the POPS Parameters (95), the QoS Module (310), the PCAII Module (303), statistics (305), timer (304), and data communications packet per the PCAII Module (303) in the example of FIG. 2 are shown in RAM Memory (324), but many components of such software typically are stored in non-volatile memory also, for example, on a disk drive (319).

In various non-limiting embodiments, the U-PAS Server 52 of FIG. 2 includes the bus adapter (329), a computer hardware component that comprises drive electronics for the high speed buses, a front side bus (321), a video bus (320), and the memory bus (322), as well as drive electronics for a slower expansion bus (323). Examples of bus adapters useful for variable dynamic management of network traffic for data monitoring (e.g. packets), analysis, and overage prevention according to embodiments of the present disclosure include the Intel Northbridge, the Intel Memory Controller Hub, the Intel Southbridge, and the Intel I/O Controller Hub. Examples of expansion buses useful for variable dynamic management of network traffic for data monitoring (e.g. packets), analysis, and overage prevention according to embodiments of the present disclosure include Industry Standard Architecture (‘ISA’) buses, Peripheral Component Interconnect (‘PCI’) buses, and/or the like.

In various non-limiting embodiments, the U-PAS Server 52 of FIG. 2 includes a disk drive adapter (316) coupled through Expansion Bus (323) and bus adapter (329) to processor (328) and other components of the U-PAS Server 52, a Disk drive adapter (316) connects non-volatile data storage to the U-PAS Server 52 in the form of a disk drive (319). Disk drive adapters useful in network hosts include Integrated Drive Electronics (‘IDE’) adapters, Small Computer System Interface (‘SCSI’) adapters, and others as will occur to those of skill in the art. In addition, non-volatile computer memory may be implemented for the network host as an optical disk drive, electrically erasable programmable read-only memory (so-called ‘EEPROM’ or ‘Flash’ memory), RAM drives, and so on, as will occur to those of skill in the art.

In various non-limiting embodiments, the example U-PAS Server 52 of FIG. 2 includes one or more input/output (′I/O′) adapters (315). I/O adapters in network hosts implement user-oriented input/output through, for example, software drivers and computer hardware for controlling output to display devices such as computer display screens, as well as user input from user input devices (318) such as keyboards and mice. The example U-PAS Server 52 of FIG. 2 includes a video adapter (327), which is an example of an I/O adapter specially designed for graphic output to a display device (326) such as a display screen or computer monitor. Video adapter (327) is connected to processor (328) through a high speed video bus (320), bus adapter (329), and the front side bus (321), which is also a high speed bus.

The exemplary U-PAS Server 52 of FIG. 2 includes a communications adapter (314) for data communications with other computers (317) and for data communications with a data communications network (300). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for variable dynamic management of network traffic for data monitoring (e.g. packets), analysis, and overage prevention according to embodiments of the present disclosure include modems for wired dial-up communications, Ethernet (IEEE 802.3) adapters for wired data communications network communications, and 802.11 adapters for wireless data communications network communications, cellular.

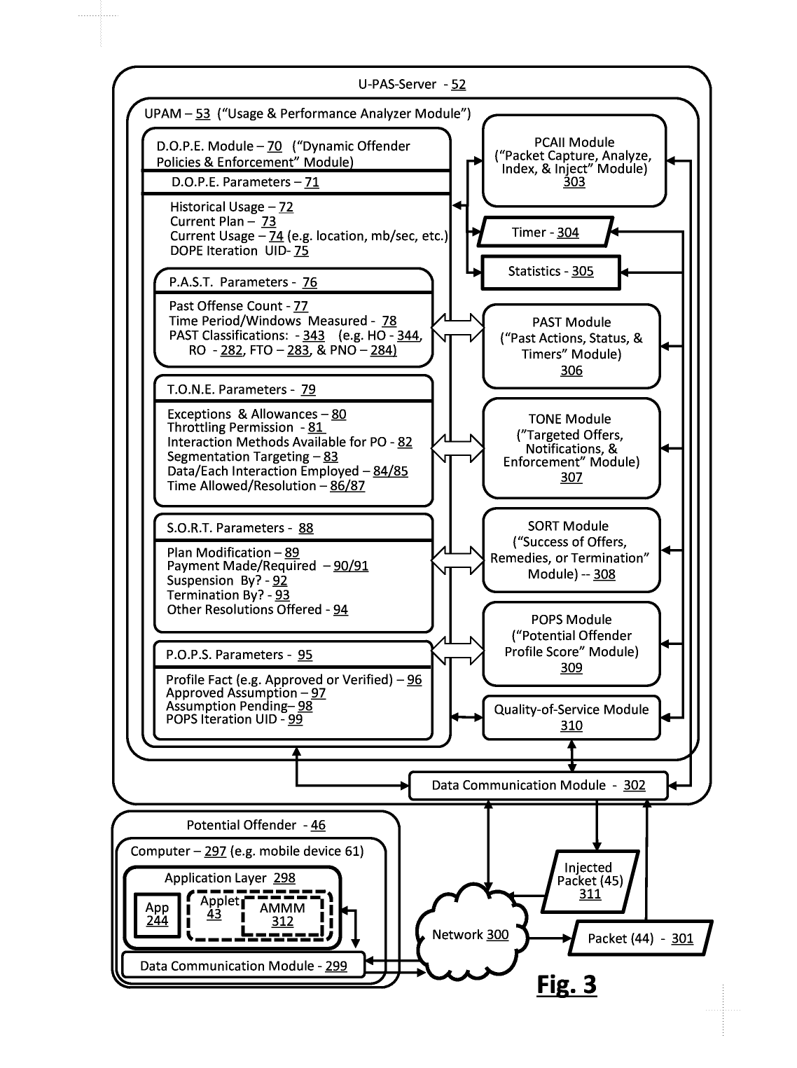

FIG. 3 depicts a block diagram of an exemplary system for variable dynamic management of network traffic for data monitoring (e.g. packets), analysis, and overage prevention according to embodiments of the present disclosure. A host environment of FIG. 3 (e.g. as depicted in the lower left) includes the potential offender (46). In various non-limiting embodiments, the potential offender (46) includes a computer (297) with an Application Layer (298) which comprises an Application 244, an Applet (43) (e.g. an on-device Applet 43), an “Application Monitoring & Management Module” (AMMM) 312 (more herein), and data communications module (299). In various non-limiting embodiments, the data communications module (299) is a module of computer program instructions for sending to the network host or U-PAS-Server (52), through a data communications network (101), data communications packets (44) in step 301.

In various non-limiting embodiments, the data communications packet (44) is a formatted block of information transmitted through the data communications network. The packet (44) may be transmitted through the network in accordance with a number of communications protocols such as, for example, a Transmission Control Protocol (‘TCP’), a User Datagram Protocol (‘UDP’), a Datagram Congestion Control Protocol (‘DCCP’), a Reliable User Datagram Protocol (‘RUDP’) and so on. Data communications packets (44) may be sent through the network (300) to the network host or U-PAS-Server (52) from/by the potential offender (46).

In various non-limiting embodiments, the system of FIG. 3 also includes the network host or U-PAS-Server (52) having installed upon it a data communications module (302). In various non-limiting embodiments, the data communications module (302) is a module of computer program instructions for receiving data communications packets from the network (300). In addition to the data communications module (302), the network host or U-PAS-Server (52) also has installed upon it the UPAM (53) containing the DOPE (70) module containing a set of DOPE Parameters (71), a set of PAST Parameters (76) coupled with the PAST Module (306), a set of TONE Parameters (79) coupled with the TONE Module (307), a set of SORT Parameters (88) coupled with the SORT Module (308), a set of POPS Parameters (95) coupled with the POPS module (309), the PCAII module (303), the timer (304), the statistics (305) and the QoS Module (310).

In various non-limiting embodiments, the D.O.P.E. Parameters (71) comprises a Historical Usage (72) parameter, a Current Plan (73) parameter, a Current Usage 74 (e.g. location, mb/sec, etc.), and a DOPE Iteration unique identifier (UID) 75 parameter. In various non-limiting embodiments, the Current Plan (73) parameter is an allowance. In various non-limiting embodiments, the Current Plan (73) parameter is a consumption allowance relative to temporal parameters, such as per month, or spatial, such as per a specific location or boundary. In various non-limiting embodiments, the Current Usage 74 is a consumption or consumption rate. In various non-limiting embodiments, the Current Usage (74) parameter comprises an Account, Usage Plan, Data, minutes, testing, roaming, and/or the like; relative to temporal parameters, such as per month, or spatial, such as per a specific location or boundary.

In various non-limiting embodiments, the Historical Usage (72) parameter includes such historical data as overall usage, usage comparisons, usage patterns, previous overages, previous remedies, previous PAST classifications, location usage/patterns, roaming usage/patterns, peak usage/patterns, data/application usage/patterns, mb/sec usage/patterns and/or the like, per windows of time, per device, per user, per contract (e.g. Current Plan), and/or the like. In various non-limiting embodiments, the Current Plan (73) parameter includes such data as whether the plan is pre-paid, post-paid, monthly, time-remaining, obligations, allowable-overages, allowable remedies, roaming allowed, allowable thresholds, credit limits, previous-upsells/downgrades, and/or the like, per device, per user, per contract (e.g. Current Plan), and/or the like on the plan (e.g. Current Plan). The Current Usage 74 parameter includes such data as current location, usage, usage pattern, current data consumed/allowed, text messages consumed/allowed, downloads consumed/allowed, applications running/allowed, content streamed/allowed, roaming usage/allowed, tethered usage/allowed, cellular minutes consumed/allowed, and/or the like, per user, per device and/or the like on the plan. Each update in data generates a new DOPE Iteration UID 75 parameter.

In various non-limiting embodiments, the PAST Parameters (76) comprise a Past Offense Count 77 parameter, a Time Period/Windows Measured 78 parameter, the PAST Parameters 343 and classifications: e.g. the HO 344 and HO parameters, the RO 282 and RO parameters, the FTO 283 and FTO parameters, and the PNO 284 and PNO parameters. The Past Offense Count 77 parameter includes a count towards past offenses, and may include a range and/or variation of Past Offenses and Counts. Further, it may include such data as the time, location, circumstances, if-predicted/when/how, and/or the like. The Time Period/Windows Measured 78 parameter includes a window of time used per PAST Offense Count. For example, where the time period or window could be measured per a monthly time window that coincides with each monthly billing cycle of the Current Plan/contact, the time window history of the Current Plan, or entire history of the user/device.

The PAST Classifications 343, such as the HO 344, the RO 282, the FTO 283, and the PNO 284 are utilized to delineate or classify a variety of users as potential offenders or offenders, by a particular measurement, &/or collection of measurements, such as a degree, volume, length of time, dollar amount, data amount, text amount, video amount, application type, and/or the like. For example, a collection of data and thresholds would establish a defined difference between the RO and the HO.

In various non-limiting embodiments, the TONE Parameters (79) comprise an Exceptions and Allowances 80 parameter, a Throttling Permission 81 parameter, an Interaction Methods Available for PO 82 parameter, a Segmentation Targeting 83 parameter, a Data/Each Interaction Employed 84/85 parameters, and a Time Allowed/Time Resolution 86/87 parameters (where the Time Allowed 86 maybe expressed over and/or relative to the time required to obtain a particular resolution per a criteria, threshold, and/or the like; or here the Time Resolution 87).

In various non-limiting embodiments, the Exceptions and Allowances 80 parameter may include such parameters as user, contracts, locations, times, events, and/or conditions that shall and/or may conditionally trigger, say an overage exception and/or allowance, say for a particular window of time, within a particular designated location, due to a particular event, contract provision, contract insurance, network outage, emergency, and/or the like. In various non-limiting embodiments, the Throttling Permission 81 is a set of conditions whereby the user's computer, device, mobile phone, laptop, IPTV, and/or the like has it's input and/or output throttled. The Throttle Permission 81 parameter would preferably include a pre-approved and/or set by the contract provider, network provider, device manufacturer, an employer, a contract manager, a contract user, a subscriber party, and/or the like, and/or some combination, permutation, and/or the like of these.

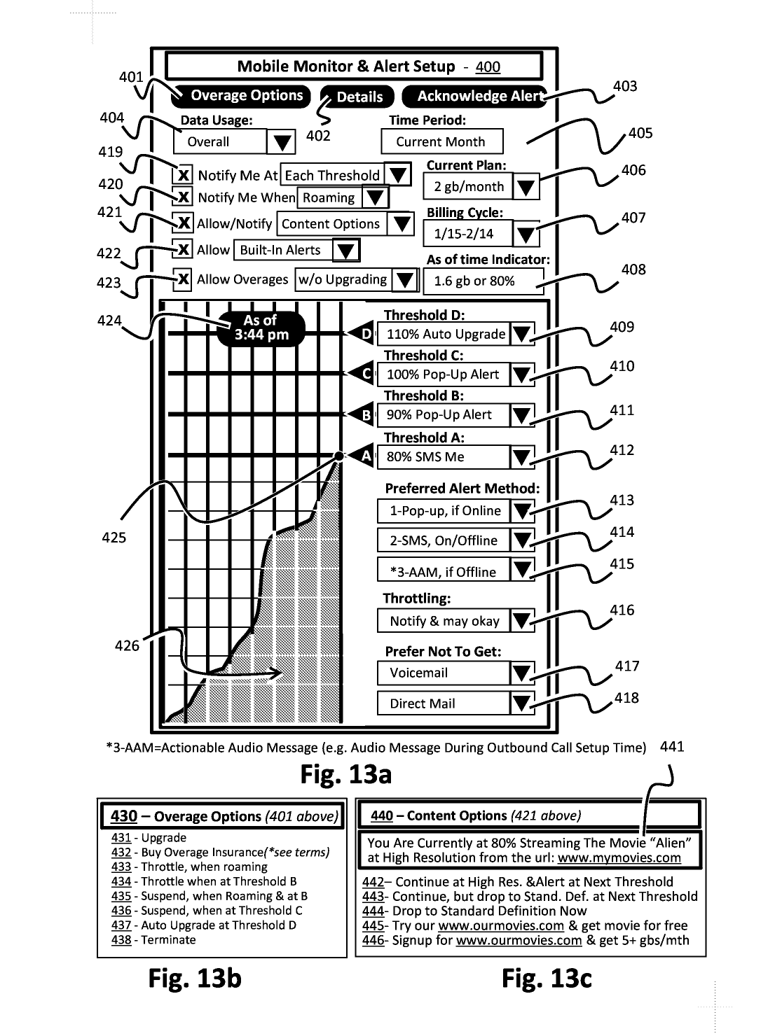

In various non-limiting embodiments, the Interaction Methods Available for PO (Potential Offenders) 82 parameter would preferably include a list of communication methods and/or protocols pre-approved for communication between service/contract provider (e.g. MNO 25, ISP 41, and/or the like) and/or the user of the computer (e.g. device, phone, laptop, IPTV, and/or the like), where, for example, the list of communication methods may include input, conditions, rules, options, fees, and/or the like set by the service/contract provider, network provider, device manufacturer, an employer, a contract manager, a contract user, a subscriber party, and/or the like, and/or some combination, permutation, and/or the like of these (also see FIGS. 13a-16b).

In various non-limiting embodiments, the Segmentation Targeting 83 parameter would preferably include the ability to selectively target a segment of data, say for users, devices, contracts, behaviors, temporal, locations, habits, offensives, potential offenses, and/or the like. In various non-limiting embodiments, the Data/Each Interaction Employed 84/85 parameters would preferably include the data collected per each interaction employed to interact with a user per interaction. In addition, the data collected may include information regarding the type of communication method employed, the user reaction, and/or the like per interaction attempted, along with a relative success score per interaction, per communication method employed, per event, per user and/or the like (also see FIGS. 13a-16b).

In various non-limiting embodiments, the Time Allowed/Time Resolution 86/87 parameters would preferably include a pre-approved timer allowed per interaction, and/or a timer per resolution offered, where, for example, the timers are pre-approved and/or set by the service contract provider (e.g. MNO 25) and agreed to by the user. Further, where, for example, the timers can be dynamically modified due to changing conditions such as changes to data usage by the device, the user, other users, the network, temporal conditions, location changes, weather changes, event changes, emergencies, and/or the like. In addition, others, such as network providers, device manufacturers, weather feeds, news feeds, twitter, an employer, a contract manager and/or the like, may be allowed to view, monitor, request changes, provide conditions, rules, thresholds, criteria, updates, and/or the like. In various non-limiting embodiments, the data collected regarding time allowed/time-to-resolve may include relative information regarding other devices, users, patterns, behaviors, and/or the like per resolution, along with a relative-success-score per resolution, per communication method employed, per event, per user, per contract, per outcome, and/or the like. Further, where future patterns may also be compared for continually improving monitoring, communications, and resolution methods.

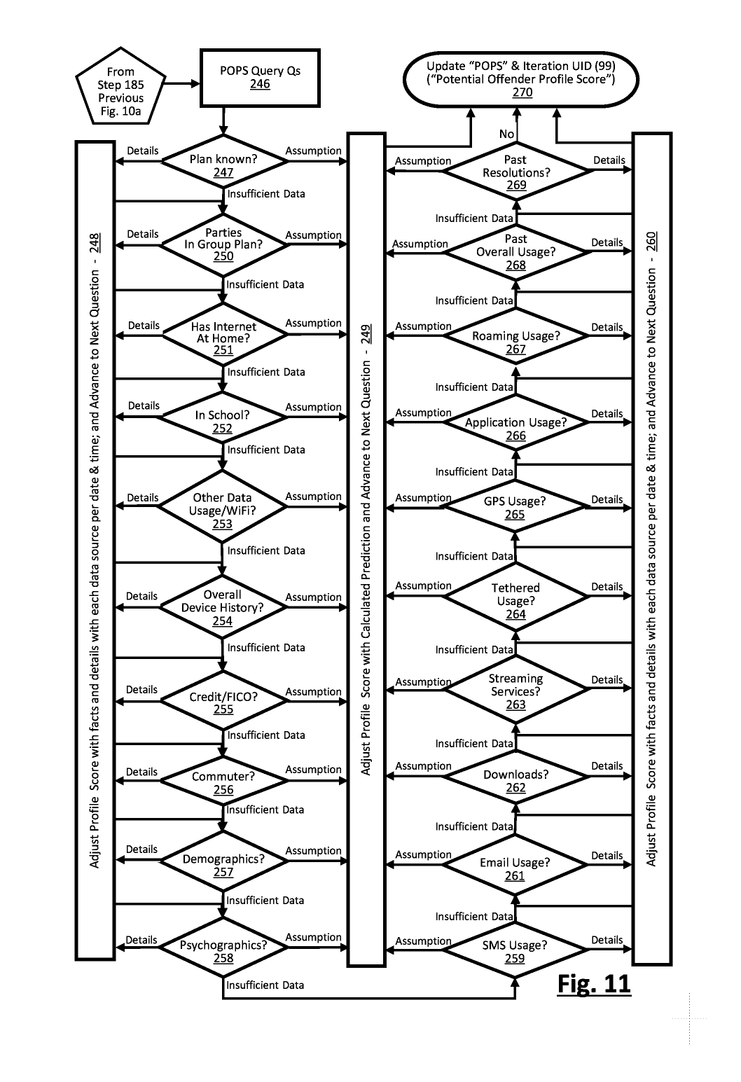

In various non-limiting embodiments, the SORT Parameters (88) comprise a “Plan Modification” 89 parameter, a “Payment Made/Required” 90/91 parameter, a “Suspension By?” 92 parameter, a “Termination By?” 93 parameter, and an “Other Resolutions Offered” 94 parameter; along with a tracking of “by-who” along with how, where, when and who “has-permission-to” for each. In various non-limiting embodiments, the POPS Parameters (95) comprises a “Profile Fact (e.g. Approved or Verified)” 96 parameter, an “Approved Assumption” 97 parameter, an “Assumption Pending” 98 parameter, and a “POPS Iteration UID” 99 parameter (also see FIGS. 10a, 10b, 11, & 12).

In various non-limiting embodiments, the data packets 44 received by the computer or U-PAS-Server 53 at the data communications module (302) can be passed to the Q-o-S Module (310), the DOPE (70), and the PCAII (303), for monitoring, storing, analyzing, interrogating, comparing, indexing, delaying, interrupting, throttling, and/or the like. In various non-limiting embodiments, the PCAII (303) module monitors data and network traffic for variable dynamic management. In various non-limiting embodiments, the Q-o-S Module (310) would preferably be implemented as computer program instructions that initialize the DOPE and the QoS parameters (432), retrieving as conditions and rules require, then tracking and updating the Statistics 305 per the DOPE (70) and Timer 304, where a predefined time interval would preferably initiate the timer 304 and statistics 395 when/as requested.

In various non-limiting embodiments, the U-PAS/UPAM would also preform network and data analysis relative to data and application usage, where, for example, the analysis may or may not include packet analysis. In various non-limiting embodiments, the DOPE, PAST, TONE, SORT, POPS, and QoS modules would preferably track and analyze applications, application behaviors, application usage, and/or the like, per device/user. In various non-limiting embodiments, the application tracking and analyzing by the DOPE, PAST, TONE, SORT, POPS, and QoS modules may or may not include “on-device” tracking. Further, an on-device tracking and/or analysis does not specifically require a data packet from the device, to track and analyze “on-device” applications, usage, metrics, data, criteria, statistics, and/or the like. In addition, such tacking and analysis could be set back to the DOPE, PAST, TONE, SORT, POPS, and QoS modules for further analysis in real-time, near-real-time, batches, incrementally, automatically, systematically, conditionally, and/or user-selectively.

For clarity, examples herein denote applications that are locally and electronically stored on user equipment, mobile devices 61, handset, access terminals, etc. However, implementations can encompass applications that are remotely and electronically stored. Similarly, for clarity distributing of the applications to the mobile devices 61 can be described as being wirelessly downloaded from a WWAN or WLAN or P2P. However, implementations can include wired distribution, manual insertion of non-transitory computer readable storage medium, and unlocking a previously installed software object.

In various non-limiting embodiments, computer based applications are described herein. In various non-limiting embodiments, applications used herein that can also refer to widgets, which can be a code set installed or executed in a webpage without compilation. Examples of widget information which can be downloaded through the Internet include information of weather, sports, financial news, stock data/ticks/reports, stock market data/ticks/reports, medical records, prescription records/data, traffic, real-time search ranking, photos, slides, presentations, videos, playlists, Post-it Notes™, Horoscopes, Etc. Widgets can be Added to Social Networking Profiles, blogs, or websites. Examples of types of widgets include (1) a widget engine, (2) GUI widgets (which are a component of a graphical user interface in which the user interacts), (3) Web widgets (which refer to a third party item that can be embedded in a Web page), and (4) mobile widgets (a third party item that can be embedded in a mobile phone/device).

The term “network usage measurements” may broadly refer to relative usage, performance, status, or exception information associated with one or more network communication sessions. Some example performance and status information may include, without limitation, application usage bandwidth, network layer and protocol utilization, port mappings, packet statistics, or routing tables. Some example exception information may include, without limitation, packet transmission, packet loss, packet retransmissions, bit error rate, error bursts, signal-to-noise ratio, noise margin, or error correction code data. Furthermore, the network usage measurements and/or characteristics may be associated with a mobile application 244 and/or a plurality of mobile applications 244. That is, the network usage measurements and/or characteristics may be collected for a single network connection when the plurality of mobile applications 244 are simultaneously conducting network communications through this network connection.

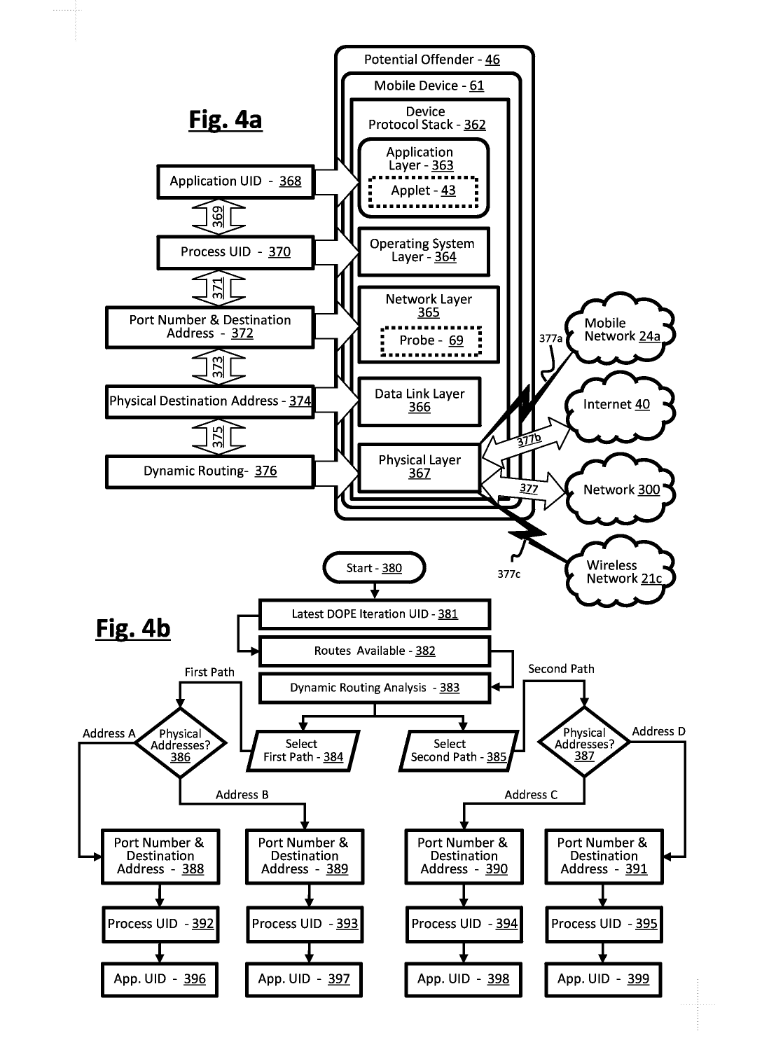

The term “application-specific usage data” may broadly refer to a set of network usage data that are derived from the network usage measurements and/or characteristics and are associated with a specific mobile application 244. As described above and herein, the network usage measurements and/or characteristics collected from the networking device may be generated by a plurality of mobile applications 244. In some embodiments, some of the network usage measurements and/or characteristics that are associated with a specific mobile application 244 may first be identified. The identified network usage measurements may reflect the specific mobile application's 244 networking activities, and may be highly relevant in analyzing the relative usage and performance of the specific mobile application 244. These identified network usage measurements may be further analyzed to generate the application-specific usage data (also see FIGS. 4a/4b).

For example, the analysis may generate a maximum, minimum, average, or median network throughput value for a particular mobile application 244, device, OS, packet source, content source, content format, usage pattern, usage method, connection method, connection location, event, moment in time, group plan, segment of users, specific user, and/or the like. In alternative embodiments, the identified network usage measurements may be deemed the application-specific usage data without any further analysis. Based on the application-specific usage data, values from the DOPE 70, PAST 306, TONE 307, SORT 308, POPS 309, and, QoS 310, new criteria, data, and values for the specific mobile application 244 may be generated. In addition, based on the application-specific usage data and the DOPE 70, PAST 306, TONE 307, SORT 308, POPS 309, and, QoS 310 new criteria, data, and values per and/or along with data, values from the specific mobile application 244, a variety of application-specific profiles, values, and scores may be generated where, for example, the application-specific profile and scores includes characteristics, values, and/or thresholds. In addition, these application-specific profiles, values, and scores can be relative to a particular device, usage pattern, usage method, connection method, connection location, event, moment in time, time of day, group plan, segment of users, specific user, commute/distance/location, and/or the like.

For example, a particular application-specific profile may include a particular score where the score represents the likelihood of a specific mobile application 244 or particular application type consuming data in excess of the Current Plan (e.g. an overage) per a particular mobile network provider or MNO 25, with a particular user plan (e.g. Current Plan) with a particular threshold of data usage. Further, the particular application-specific profile may also include scores and thresholds relative to the likelihood of a specific mobile application 244 consuming a particular volume of data per a particular mobile network provider or MNO 25 with a particular user plan (e.g. Current Plan). In addition, the particular application-specific profile may also include scores and thresholds relative to the likelihood of a specific mobile application 244 consuming a particular volume of data per a moment in time relative to a particular user, group of users, device, OS, packet source, content source, content format, usage pattern, usage method, connection method, connection location, event, moment in time, time of day, group plan, segment of users, specific user, commute/distance/location, and/or the like.

Referring back to FIG. 3, in various non-limiting embodiments, the data communications module (302) may be instructed to perform certain function, such as injecting a packet per step 311, where an “injected packet” 45 is depicted. Here, the injected packet 45 is routed back to the computer 297 of the Potential Offender 46 via the Network 300 and then through the computer's data communication module 299. Here, the injected packet 45 can perform a variety of functions, such as effecting a particular series of packets, say for a streamed, downloaded and/or the like, event, content or application. In various non-limiting embodiments, the injected packet 45 can comprise or produce a content or application, wherein the content or application is an html format. In various non-limiting embodiments, the term injected packet 45, may also be referred to as an injection, a packet injection, and/or the like, and vice versa for each.

In various non-limiting embodiments, the terms “inject, injecting, injected, injection, and/or the like,” may be interchangeable with a respective “intercept, intercepting, intercepted, interception, and/or the like,” and vice versa for each for each permutation. In various non-limiting embodiments, the terms “inject, injected, injecting, injection, and/or the like,” may be interchangeable with a respective “modify, modifying, modified, modification, and/or the like,” and vice versa for each for each permutation. In various non-limiting embodiments, a particular packet may be intercepted and modified, then transmitted to a destination. In various non-limiting embodiments, the modified packet or series of modified packets could produce/display a html pop-up, streaming video, application, offer, message, prompt, alert, and/or the like. In various non-limiting embodiments, the modified packet or series of modified packets could be injected in place of another particular packet or series of particular packets. In various non-limiting embodiments, the packet, the particular packet, and/or series of particular packets, may be intercepted at any point along a network, including at any tower equipment, edge, edge devices, handoff point, switching point, aggregation point, peering point, probe 69, and/or the like.

In general, an “edge device” is a device that provides an entry point into an enterprise or a service provider's core network(s). For example, the entry points could comprise routers, routing switches, integrated access devices (IADs), multiplexers, and a variety of metropolitan area network (MAN) and wide area network (WAN) access devices. Edge devices also provide connections into carriers (e.g. MNO) and service provider networks (e.g. MO).

In various non-limiting embodiments of the present disclosure, the U-PAS 50, IN-U-PAS 51, UPAM53, Probe 69, and/or the like is an edge device. In various non-limiting embodiments of the present disclosure, the U-PAS 50, IN-U-PAS 51, UPAM53, Probe 69, and/or the like, performs and/or provides the same or similar functionality as the edge device. In various non-limiting embodiments of the present disclosure, the U-PAS 50, IN-U-PAS 51, UPAM53, Probe 69, and/or the like, perform and function in conjunction with a particular edge device and/or a plurality of edge devices. In various non-limiting embodiments, the terms “edge” and “edge devices” are interchangeable.

In various non-limiting embodiments, the U-PAS 50, IN-U-PAS 51, UPAM53, Probe 69, and/or the like may be positioned, located, inserted, operationally connected/coupled and/or the like, including via the on-device applet 43, AMMM 312, UPAM 53, with/at any tower connection, with/at any edge connection, with/at any Peering Point, with/at any MNO connection point (e.g. internally or externally), with/at any handoff location, with/at any aggregation point, with/at any destination, and/or the like. In various non-limiting embodiments, the particular intercepted packet may or may not prompt a policy. In various non-limiting embodiments, the particular intercepted packet that prompts the policy may in turn enforce or engage the policy, where in the policy enforcement includes transmitted injected or modified packets to a destination.

In various non-limiting embodiments, a particular packet may also be intercepted or evaluated at any point, say where the U-PAS 50, IN-U-PAS 51, UPAM53, Probe 69, Applet 43, and/or AMMM 312 may be positioned, located, inserted, operationally connected/coupled and/or the like, including via the on-device applet 43, AMMM 312, UPAM 53, with/at any tower connection, with/at any edge connection, with/at any Peering Point, with/at any MNO connection point (e.g. internally or externally), with/at any handoff location, with/at any aggregation point, with/at any destination, and/or the like.

In various non-limiting embodiments, a particular packet or a first packet is intercepted and modified, where a particular injected packet 311 is then transmitted to a particular destination or a first destination. In various non-limiting embodiments, the intercepted packet or the first packet may be transmitted to the first destination and/or a second destination. In various non-limiting embodiments, the transmission of the intercepted packet or the first packet may be delayed the first destination and/or a second destination, and/or sent asynchronously, or sent simultaneously to the second destination.

Implementing, evaluating, determining, and providing a system (operational via a computer processor) and method (computer-processor-based) for evaluating the quality of packet-switched voice signals is described in EP Pub. No. 20020760989, Hardy, (which is hereby incorporated by reference in its entirety for all purposes) by reference in its entirety for all purpose which can be implemented in various non-limiting embodiments the present disclosure. Here Hardy explains a function for injecting packets, where a digital signal processor (DSP) may be employed to emulate codec functions and may be used to inject artificial packet loss at various rates and purposes.

In various non-limiting embodiments, the U-PAS 50 (&/or IN-U-PAS 51) implements the holistic approach to screening applications (apps) using a phased implementation to risk assessment of potential offenders. In various non-limiting embodiments, the U-PAS 50 for quantifying the risk of apps has the following characteristics: varying a number of phases of data collection and analysis, depending upon the platform and type of app; a series of phases of analysis that run, for purposes of collecting data, followed by a collection of rules that then process the collected data; rules that identify behaviors, characteristics, or properties, which present patterns, say for overages, network congestion, upsell opportunities, billing issues, or risks to an event, location, employer, content source, enterprise, or consumer; and a report generation phase, in which the relevant findings/results from the rules execution phase are reported to end users (e.g., the event, location, employer, content source, enterprise, or consumer).

Returning to FIG. 1 which depicts a block diagram of an operational environment in which illustrative embodiments of a mobile monitoring application and an application experience monitoring system may operate to determine the DOPE 70, PAST 306, TONE 307, SORT 308, POPS 309, QoS 310 parameters, rules, thresholds, criteria, triggered instructions and/or the like of mobile applications 244. Here, the mobile device 61 may be configured to communicate with a mobile application server 242 via the network 300 (as depicted in Mobile Network 24). In various non-limiting embodiments, the network 300 may be provided and managed by the MNO 25, or some other service provider. In various non-limiting embodiments, the mobile device 61 may contain, among other things, multiple hardware or software components, such as the processor, one or more mobile applications 244, and a mobile monitoring application or Applet 43.

In various non-limiting embodiments, the mobile device 61 may be configured to communicate with other applications and/or devices in the network environment. In various non-limiting embodiments, the mobile OS may provide functions to and support communication standards for the mobile device 61. Some examples of the mobile OS may include, without limitation, Symbian®, RIM Blackberry®, Apple iPhone®, Windows Mobile®, or Google Android®. In various non-limiting embodiments, the mobile OS may also provide a common programming platform or executing environment for the mobile applications 244 and the Applet 43 (which may include the UPAM 53 or an UPAM-like module/functionality).

In various non-limiting embodiments, the UPAM 53 and/or the Applet 43 may monitor the mobile applications 244 and interact with a Probe 69 and/or with an “on-device” Applet 43. Returning to FIG. 3, the on-device applet 43 may include the functionality of the AMMM 312 and/or a separate standalone AMMM 312 may exist. In various non-limiting embodiments, the on-device applet 43 with the coupled AMMM 312 may exist as an on-device/UPAM that may or may not be standalone; and/or with the UPAM-like module/functionality. In various non-limiting embodiments, the AMMM 312 may comprise, among other things, an AMMM-DOPE 70a, AMMM-PAST 306a, AMMM-TONE 307a, AMMM-SORT 308a, AMMM-POPS 309a, and, QoS 310 (AMMM-QoS 310a) on-device analysis modules, with their associated parameters, criteria, one or more processors 328a, and a memory 324a. In various non-limiting embodiments, references to the AMMM-DOPE 70a, AMMM-PAST 306a, AMMM-TONE 307a, AMMM-SORT 308a, AMMM-POPS 309a, and, QoS 310 (AMMM-QoS 310a); and its functionality; may also apply to the respective DOPE 70, PAST 306, TONE 307, SORT 308, POPS 309, and, QoS 310 and vice versa.

In various non-limiting embodiments, the Applet 43 with the AMMM 312, the Probe 69, the U-PAS 50, and/or the IN-U-PAS 51 may share, electronically store, synchronize and analyze data. In various non-limiting embodiments, the Applet 43 with the AMMM 312, the Probe 69, the U-PAS 50, and/or the IN-U-PAS 51 may analyze the data communication between the mobile applications 244 and the mobile application server 242 and/or the U-PAS 50, and determine the AMMM-DOPE 70a, AMMM-PAST 306a, AMMM-TONE 307a, AMMM-SORT 308a, AMMM-POPS 309a, and, QoS 310 (AMMM-QoS 310a); and/or the DOPE 70, PAST 306, TONE 307, SORT 308, POPS 309, and, QoS 310 values for the mobile applications 244 on/at the device, on/at the U-PAS Server 52 on/at the IN-UPAS 53, some combination of these, and/or the like. In various non-limiting embodiments, the AMMM-DOPE 70a, AMMM-PAST 306a, AMMM-TONE 307a, AMMM-SORT 308a, AMMM-POPS 309a, and, QoS 310 (AMMM-QoS 310a); and/or the DOPE 70, PAST 306, TONE 307, SORT 308, POPS 309, and, QoS 310 values may be further aggregated and/or processed for reporting and/or for detecting network communication issue, quality, probability, problems, resolution-probability, and/or the like.

In various non-limiting embodiments, the mobile applications 244 may perform networking functions such as telephony, email, text-messaging, web-browsing, and/or other functions such as audio/video playing, digital picture/video capturing, streaming, uploading of data/content, downloading of data/content, sharing, etc. Some examples of the mobile applications may include, without limitation, Voice over IP (VoIP), web-browsing, audio and/or video streaming, gaming, and other networking related applications. During operation, the mobile applications 244 may communicate with their respective mobile application servers 242 via the network 300.

In various non-limiting embodiments, the mobile application server 242 may communicate with the mobile applications 244 to provide different types of services, such as, without limitation, telephony, email, text-messaging, or real-time audio/video streaming services to the plurality of mobile devices 61. In various non-limiting embodiments, the UPAM 53 and/or the Applet 43, individually, and/or in combination with another module/tool, say the AMMM, may determine the AMMM-DOPE 70a, AMMM-PAST 306a, AMMM-TONE 307a, AMMM-SORT 308a, AMMM-POPS 309a, and, QoS 310 (AMMM-QoS 310a); and/or the DOPE 70, PAST 306, TONE 307, SORT 308, POPS 309, and, QoS 310 criteria of the mobile applications 244 communicating with the mobile application server 242 via the network 300. In various non-limiting embodiments, the Applet 43 can perform functions such as determining the types of the mobile applications 244 that are available in the mobile device 61, detecting the initialization and execution of the mobile applications 244, collecting the network usage measurements and/or characteristics of the mobile applications 244, and/or determining the AMMM-DOPE 70a, AMMM-PAST 306a, AMMM-TONE 307a, AMMM-SORT 308a, AMMM-POPS 309a, and, QoS 310 (AMMM-QoS 310a);
and/or the DOPE 70, PAST 306, TONE 307, SORT 308, POPS 309, and, QoS 310 of the mobile applications 244. The details of the Applet 43 with the UPAM 53 are further described herein (also see FIGS. 13a-16b).

In various non-limiting embodiments, the AMMM 312 may reside in the U-PAS (&/or IN-U-PAS 51) alongside or including in the UPAM 53. In various non-limiting embodiments, the AMMM 312 may be configured as a separate and distinct system with a server or a router coupled to the network 300 and may communicate with the one or more Applets 43 executing on the one or more mobile devices 61. In various non-limiting embodiments, the QoS module 310 of the AMMM 312 may receive network usage measurements and/or DOPE 70, PAST 306, TONE 307, SORT 308, POPS 309, and, QoS 310 values from the one or more Applets 43. Afterward, the QoS module 310 may determine the AMMM-DOPE 70a, AMMM-PAST 306a, AMMM-TONE 307a, AMMM-SORT 308a, AMMM-POPS 309a, and, QoS 310 (AMMM-QoS 310a); and/or the DOPE 70, PAST 306, TONE 307, SORT 308, POPS 309, and, QoS 310 of the mobile applications 244 executing on their respective mobile devices 61 in real-time or near real-time. In various non-limiting embodiments, the resulting DOPE 70, PAST 306, TONE 307, SORT 308, POPS 309, and, QoS 310 values may be reported to the MNO 25 (e.g. a Telco service provider), the providers of the mobile application server 242 (e.g. a third party, such as iTunes®), and/or the mobile devices 61 for, by way of example, status reporting, feature enhancement, performance enhancements, quality enhancements, format changes, upgrades/downgrades, overage/alert, debugging purposes, change in contract, insurance for overage, new thresholds and/or the like. In various non-limiting embodiments, the Applets 43 may be executing on the AMMM 312, which are monitoring and communicating with their respective mobile devices 61 via the mobile network 300. More details of the AMMM 312 and the QoS module 310 are further described herein.

In various non-limiting embodiments, the processor (e.g. 328) may generally control the operations of the AMMM 312 in performing QoS monitoring and reporting, and the memory (e.g. 324) may be configured to store the data transmitted to or received from the network 300. In various non-limiting embodiments, the U-PAS 50 and further, may comprise the U-PAS Server 42, Processor 328 & UPAM 53: the MSE, a Media Server, and a plurality of databases associated data comprising an Event Database, a Request Db, a Web Crawler Db, a Content Db, a Potential Offender Db, an Account Db, a Playlist Db, a Request-List Db, an Event-List Db, a Scheduled-Playlist Db, a Shopping List Db, a Wish List Db, Contact manager Db, Calendar Db, email/STMP Db, and/or the like. In various non-limiting embodiments, the U-PAS 50 is typically operatively connected to the Internet 40, the Network 300, the MNO 2542, the PSTN/ISDN/PDN/Etc. 60, and/or the like via the U-PAS Server 42 directly or via, say an AP 47 (Access Point 47) or similar (see FIGS. 1-4a, and 17-19).

In various non-limiting embodiments, the communication device may also be a Voice over Internet Protocol (VoIP) device. For example, the communication device may be a computing device, such as the desktop computer, laptop computer, tablet computer, or PDA, with software enabling the computing device to make VoIP calls over the Internet, or the communication device could simply be a device that plays audio and accepts commands, such as voice commands. In various non-limiting embodiments, the communication device does not require packet data communications to interact with the U-PAS 50. For example, the U-PAS 50 may send an audio message alert to a Landline Phone 64, where the Landline Phone 64 does not employ a packet data protocol/communications.

FIG. 4a depicts an embodiment of a network communication protocol stack, an illustrative embodiment of associations among different identifiers. As depicted in FIG. 4a, the Potential Offender 46 utilizing the mobile device 61 (or similar computer) where an Applet 43 or a mobile app 244 executing on the mobile device 61 in an Application Layer 363 may utilize a Device Protocol Stack 362. In various non-limiting embodiments, the Device Protocol Stack 362, displayed in a top-down order, to conduct a network communication session. Each layer in the Device Protocol Stack 362 may implement a collection of functions which provide services to the layer above it, and utilize services from the layer below it. For example, before a message originating from a mobile app 244 in FIG. 3, such as the mobile application 244 in FIG. 1, is transmitted to the network 300, the mobile app 244 may generate a network message 377 or 377a225 by encapsulating the message with header and/or footer information associated with each of the layers 363-367 in the Device Protocol Stack 362.

In various non-limiting embodiments, the Device Protocol Stack 362 may contain the application layer 363, an operating system layer 364, a network layer 365, a data link layer 366, and a physical layer 367, all according to various known network communication standards. In various non-limiting embodiments, the application layer 363 may also contain the Applet 43. In various non-limiting embodiments, the network layer 365 may also contain the Probe 69. Further, the Device Protocol Stack 362 may contain additional or different network communication layers based on the networking functions that need to be supported.

In various non-limiting embodiments, the Applet 43 and/or the UPAM 53 may invoke different network utility tools to collect network usage measurements from the network communication layers 363-367. Alternatively, the Applet 43 and/or the UPAM 53 may contain programming logic to listen to (i.e., monitor) different communication channels and ports, and collect the network usage measurements and/or characteristics at the different network communication layers 363-367. For example, the Applet 43 and/or the UPAM 53 may execute a network utility tool similar to UNIX's “ps” command at the operating system layer 364 to retrieve a list of mobile apps 244 executing on the mobile device. In various non-limiting embodiments, the outcomes of the “ps” like network utility tool may contain network usage measurements such as, without limitation, process names, Process UIDs, and system resource usages. Similarly, the Applet 43 and/or the UPAM 53 may use a “netstat” like network utility tool in a MS WINDOWS® environment to collect TCP/IP metrics from the network layer 365. The Applet 43 may use similar network utility tools to collect from the network layers 365 additional TCP/IP network usage measurements, which may include, without limitation, name of the protocols associated with the network communication sessions, local address, foreign address and the port number used during the network communication sessions.

In various non-limiting embodiments, the network usage measurements and/or characteristics collected from the network layer 365 may be originated from multiple network communication sessions, and may be associated with various mobile apps 244 executing on the mobile device 61. To better measure the relative usage and performance of a specific mobile app 244, the Applet 43 and/or the UPAM 53 may process the collected network usage measurements by extracting a subset of the network usage measurements and/or characteristics related to a specific mobile app 244, and use the subset of the network usage measurements and/or characteristics to determine and/or relatively compare the “application-specific usage data” for the specific mobile app 244. In various non-limiting embodiments, the Applet 43 may then use the application-specific usage data to determine and/or relatively compare with the DOPE 70, PAST 306, TONE 307, SORT 308, POPS 309, and, QoS 310 value(s) for the specific mobile app 244 or type of application/app (or mobile application/app type; e.g. app OS, application classification, app manufacturer, app function, app purpose, app age-range, app market, app segment, user segment, and/or the like).

In various non-limiting embodiments, the subset of the network usage measurements and/or characteristics may be extracted from the entire set of network usage measurements using one or more identifiers that can be used to uniquely identify the specific mobile app 244 type of app. In some instances, each collected network usage measurement may contain a single identifier which may be sufficient for identifying the mobile app 244 type of app that is responsible for the network usage measurement. In this case, the subset of the network usage measurements and/or characteristics may be extracted from the entire set of network usage measurements using the single identifier. In other instances, each network usage measurement may contain multiple identifiers which may be sufficient for identifying the mobile app 244 type of app. These multiple identifiers may then be used to extract the subset of measurements from the entire set of network usage measurements and/or criteria. In some further instances, the one or more identifiers contained in the collected network usage measurements may not be sufficient for identifying specific mobile apps 244 or type of app. In this case, the Applet 43 and/or the UPAM 53 may use associations to ascertain additional identifiers based on the one or more identifiers, and employ the additional identifiers to identify the specific mobile app 244, a particular application, application profile, and/or extract the subset of relative network usage measurements/data.

Elaborating on the description above, the network usage measurements and/or characteristics collected from the operating system layer 364 may contain a Process UID 370. In various non-limiting embodiments, the Process UID 370 may be sufficient for identifying a specific mobile app 244, application type, application profile, and/or the like, executing on the mobile device. By filtering the network usage measurements and/or characteristics collected from the operating system layer 364 using the Process UID 370, the Applet 43 and/or the UPAM 53 may extract the subset of network usage measurements (which is associated with the specific mobile app 244 or similar) from the entire set of network usage measurements (which is for all the mobile apps 244 executing on the mobile device). In various non-limiting embodiments, the Applet 43 may further analyze and process the subset of network usage measurements to generate the application-specific usage data and/or the application specific profile.

In some instances, the network usage measurements and/or characteristics, application data/type/profile/relationships and/or the like, collected from the network layer 365 may not contain a single identifier such as a process name or a Process UID. Rather, they may contain multiple identifiers which are sufficient for identifying the specific mobile app 244 or application type/profile relationship and/or the like. For example, if the specific mobile application's network communication port and destination address (e.g., a port number & destination address 372) are known and unique, then the port number & the destination address 372 may be deemed the multiple identifiers that can be used to identify the specific mobile app 244 or application type/profile/relationship and/or the like. To illustrate, suppose a browser mobile app 244 is the only mobile app 244 in the mobile device 61 accessing a web site “www.netflix.com” via the port 80. Then any network usage measurement that is associated with the port 80 and the destination address for “www.netflix.com” may be related to the browser mobile app 244. In other words, based on the multiple identifiers (e.g., the port number & destination address 372), a subset of network usage measurements for the specific mobile app 244 may be identified and extracted from the entire set of network usage measurements and/or profile.

In other instances, the network usage measurements and/or characteristics collected from the different network communication layers 364-367 may contain different identifiers, and some network usage measurements collected from a particular network communication layer may contain one or more identifiers that are insufficient for identifying the specific mobile app 244. In this case, the Applet 43 and/or the UPAM 53 may try to ascertain additional identifiers that are related to the one or more identifiers, and use the additional identifiers to identify the specific mobile app 244, application type/profile/relationship, and/or the like. For example, assume the network usage measurements and/or characteristics collected from the operating system layer 364 may contain a single identifier (Process UID 370). In various non-limiting embodiments, the network usage measurements and/or characteristics collected from the network layer 365 may contain multiple identifiers (port number & destination address 372). In various non-limiting embodiments, the network usage measurements and/or characteristics collected from the data link layer 366 may contain a physical destination address 374 (e.g., media access control (MAC) address). And the network usage measurements and/or characteristics collected from the physical layer 367 may contain a Dynamic Routing 376 path/means. In various non-limiting embodiments, the physical destination address 374 or the Dynamic Routing 376 may be the identifiers that are insufficient for identifying the specific mobile app 244 by themselves, but may or may not relate with a particular application, type, profile, or profile characteristic.

In various non-limiting embodiments, the physical destination address 374 may have an association 373 with additional identifiers (e.g., port number and destination address 372). An association may be a relationship between two different sets of identifiers. In other words, when the physical destination address 374 is uniquely related to the destination address of the “port number & destination address 372”, and when the specific mobile app 244 may be identified using the “port number & destination address 372”, the specific mobile app 244 may be identified using the identifier “physical destination address 374” and the identifiers “port number & destination address 372”, which are obtained via the association 373.

Similarly, when the “port number & destination address” 372 are not sufficient for identifying the specific mobile app 244, and there is an association 371 between the “port number & destination address 372” and the identifier “Process UID 370”, the Applet 43 and/or the UPAM 53 may identify the specific mobile app 244, application type and/or profile, using the “port number & destination address 372”, and the “Process UID 370” (which is obtained via the association 371) or similar. Specifically, the Applet 43 and/or the UPAM 53 may process a particular network usage measurement collected from the data link layer 366 to obtain its physical destination address 374, then use the physical destination address 374 to obtain the port number & destination address 372 via the association 373, and then use the port number & destination address 372 to find the Process UID 370 via the association 371. Based on the Process UID 370, the Applet 43 and/or the UPAM 53 may ascertain the specific mobile app 244 that is responsible for the particular network usage measurement, overage, potential overage, and/or the like.

In addition, when the “port number & destination address” 372 are not sufficient for identifying the specific mobile app 244, and there is an association 371 between the “port number & destination address 372” and other identifiers, say within the DOPE 70, PAST 306, TONE 307, SORT 308, POPS 309, and, QoS 310 values along with the associated DOPE parameters 71, PAST parameters 76, TONE parameters 79, SORT parameters 88, POPS parameters 95, and, QoS parameters, values, scores and/or the like; where the UPAM 53 and/or the Applet 43 may identify the specific mobile app 244, application type and/or profile, using the “port number & destination address” 372, the “Process UID” 370, and/or the similar (which is obtained association with say the IN-UPAS 51, U-PAS 52, UPAM 53, Applet 43, and/or the like, say via the Applet 43 and a computer/network connection).

In various non-limiting embodiments, the Applet 43 and/or the UPAM 53 may establish associations among the different identifier sets by processing the network usage measurements and/or characteristics collected from the different network communication layers 363-367. For example, the network usage measurements and/or characteristics collected from the data link layer 366 (“data link layer measurements”) may contain the identifier “physical destination address 374”, as well as some specific network transmission information such as Dynamic Routing. A first routing path (e.g. a faster-rated dynamic routing path) may allow the network data frames to be quickly transmitted by the physical layer 367, while a second routing path (e.g. a slower-rated dynamic routing path) may ensure that the network data frames be transmitted more reliably.

In addition, network usage measurements collected from the physical layer 367 (“physical layer measurements”) may also contain and/or share the Dynamic Routing characteristics, relative values, scores, and/or the like from a profile. Thus, the Dynamic Routing 376 information that exist in the data link layer 366 and the physical layer 367 may be used to create association 375 between the identifier “physical destination address 374” and the identifier Dynamic Routing 376.” In other words, if a physical layer measurement or profile characteristic of the first routing path relative to speed and/or throughput, and a data link layer measurement or profile characteristic of the first routing path relative to speed and/or throughput are considered measurably and/or reliably similar, then it might be likely that the data link layer measurement and the physical layer measurement may be related. Thus, the Applet 43 and/or the UPAM 53 may extract the identifier “Dynamic Routing 376 data, values, scores, and/or the like, from the physical layer measurement, ascertain or relatively discern the identifier “physical destination address 375” via the association 375, ascertain or relatively discern the identifiers “port number and destination address” 372 via the association 373, and ascertain or relatively discern the identifier “Process UID” 370 via the association 371 and/or profile.

Similarly, when an “Application UID” 368 are not sufficient for identifying the specific mobile app 244, and there is an association 369 between the “Application UID” 368 and the identifier “Process UID” 370, the Applet 43 and/or the UPAM 53 may identify the specific mobile app 244, application type and/or profile, using the “Application UID” 368, and the “Process UID” 370 (which is obtained via the association 369) or similar. Specifically, the Applet 43 and/or the UPAM 53 may process a particular network usage measurement collected from the data link layer 366 to obtain its physical destination address 374, then use the physical destination address 374 to obtain the port number & destination address 372 via the association 373, and then use the port number & destination address 372 to find the Process UID 370 via the association 371, and then use the Process UID 370 to find the Application UID via the association 369. Based on the Application UID 368, the Applet 43 and/or the UPAM 53 may ascertain the specific mobile app 244 that is responsible for the particular network usage measurement and/or profile.

In various non-limiting embodiments, the Applet 43 may then identify the specific mobile app 244 for the physical layer measurement using the identifier “Process UID” 370. In addition, network usage measurements collected from the application layer 363 (“application layer measurements”) may also contain an Application UID 368 characteristics, relative values, scores, and/or the like from a profile. Thus, the Application UID 376 information that exist in the data link layer 366 and the physical layer 367 may be used to create association 375 between the identifier “physical destination address 374” and the identifier Dynamic Routing 376.”

Similarly to the “port number & destination address” 372 and “Process UID” 370 association further above, where there is not sufficient for identifying the specific mobile app 244, application type and/or profile, there can be association ascertained or relatively discerned from the data between all the layers, links, applications, profiles, characteristics, devices, users, MNOs, contracts, usage, elements, values, scores, profiles, and/or the like, For example, utilizing the historical, current, and/or predictive data of the DOPE 70, PAST 306, TONE 307, SORT 308, POPS 309, and, QoS 310 values along with the associated DOPE parameters 71, PAST parameters 76, TONE parameters 79, SORT parameters 88, POPS parameters 95, and, QoS parameters, values, scores and/or the like; where the UPAM 53 and/or Applet 43 may identify the specific mobile app 244, application type and/or profile, using the “port number & destination address” 372, the “Process UID” 370, and/or the like (which is obtained in association with and/or via a relatively comparable characteristic with, say the IN-UPAS 51, U-PAS 52, UPAM 53, Applet 43, and/or the like, say via the Applet 43 and the computer/network connection).

In addition, the mobile device 61 utilized by the Potential Offender 46 in the embodiment of FIG. 4a could be connected to a specific Mobile Network 24a via link 377a, the Internet 40 via a link 377b, the network 300 via a link 377, and/or a particular Wireless Network 21c via a link 377c. Here the system would preferably uniquely identify data per the connection, path, methods, patterns, network volume, limitations, and/or the like, and further incorporate data correlations for ascertaining and relatively discerning associations.

In an alternative embodiment in FIG. 4a, the Potential Offender 46 is utilizing the laptop computer verses the mobile device 61 where the laptop computer could again be connected to a specific Mobile Network 24a via link 377a, the Internet 40 via a link 377b, the network 300 via the link 377, and/or a particular Wireless Network 21c via a link 377c. Here again the system could uniquely identify data per the connection, path, methods, patterns, network volume, limitations, and/or the like, and further incorporate data correlations for ascertaining and relatively discerning associations. Further, where data, metrics, and statistics are isolated, interrogated, analyzed and electronically stored to create correlations between a variety of devices, computers, tablets 65, laptops 63, PDAs, IPTVs, car computers, and/or the like; as well as the associated OS/version, BIOS/version, antenna/version, network/version, firm-ware/version, memory, storage capacity, data contract, user patterns, and/or the like.

FIG. 4b depicts an illustrative embodiment of a decision tree for determining, isolating, and/or generating relative prompt determinations of the identifiers of applications (e.g. mobile apps 244) utilizing the network communication stack in FIG. 4a. In various non-limiting embodiments, to improve performance, the Applet 43 and/or the UPAM 53 may utilize a decision tree starting with a terminator 380 to quickly manage and traverse the associations among the different identifiers for the network usage measurements and/or characteristics collected from the network communication layers 363-367. Each node of the decision tree 380 may be a value determination for a particular identifier, and the links among the nodes may represent the associations among the different identifiers. During its processing of the various network usage measurements collected and analysis from the different network layers 363-367, the Applet 43 and/or the UPAM 53 may dynamically construct and update the decision tree 380 based on the identifiers and associations discovered among the network usage measurements and/or characteristics. Starting with a step 381, where a “Latest DOPE iteration UID” and its associated data, parameters, characteristics, scores, rules, and/or are retrieved. If the latest DOPE iteration UID is not available within a timer threshold, the process proceeds with the previously DOPE iteration UID.

Next, the process proceeds to a step 382 with a “Routes Available,” where the system provides a list of routes available per the DOPE. In various non-limiting embodiments, the Routes Available would preferably be persistently analyzed where the routes available and the associated list would be determined in a step 383 with a “Dynamic Routing Analysis” The Dynamic Routing Analysis would then select a path between the available options, depicted here as an option 384 with a “Select First Path” option and an option 385 with a “Select Second Path” option.

For example, in the generated decision tree 380, the “first path” identifier may be associated with a “Physical Addresses?” 386 (which may include address A or B), where the “first path” is relatively different in a quantifiable or qualifiable means when compared to a “second path” say in terms of performance and/or customer satisfaction scores say regarding throughput, speed, traffic volume, and/or the like. The relative difference between the “first path” and the “second path” could be in terms of performance and/or customer satisfaction scores say among device types, OS types, firmware types, mobile application 244 types, content types, MNO 25 types, contract types, and/the like, where the first path scores higher than the second path. Further, where the second path scores higher than a third path (not shown) and so on, creating a prioritized list of paths relative to a particular measurement, and/or characteristic, say among iPhone 5 users for a particular application when located in a particular metropolitan area when under a particular contract term or set of terms with a particular MNO 25 and/or the like.

The “first path” may be associated with a “Physical Addresses?” 386 (which may include address A or B) where “address A” may be associated with a “port number & destination address” 388; and the “port number & destination address” 388 may be associated with a “Process UID Process UI” (392); and the “Process UID Process UI” (392) may be associated with an “Application (App) UID” (396) and similar for Address B. Similarly, the “second path” may be associated with a “Physical Addresses?” 387 (which may include address C or D) where “address D” may be associated with a “port number & destination address” 391; and the “port number & destination address” 391 may be associated with a “Process UID Process UI” (395); and the “Process UID Process UI” (395) may be associated with an “Application (App) UID” (399), and similar for Address C. By organizing the above associations in a tree-like structure, the resulting decision tree 380 may be quickly traversed.

In various non-limiting embodiments, the system can dynamically select the second path where and when the measurable and/or relatively discerned benefit for a particular decision of say the first or second path is relatively negligible, and where the available first path may be better utilized in serving subsequent traffic, where the measurable and/or relatively discerned benefit could be described as relatively far more substantial, say in terms of likely customer satisfaction, speed, throughput, and/or the like. In addition, the decision via a measured threshold can incorporate a budget and/or a bid, where the decision incorporates an availability of, say currency in a budget, data plan (e.g. Current Plan), and/or a highest bidder for that particular measurable and/or relatively discerned benefit.

In some embodiments, by using the exemplary decision tree 380, the Applet 43 and/or the UPAM 53 may quickly determine the mobile apps 244 for the network usage measurements and/or characteristics collected from the physical layer 367. For example, for each physical layer network usage measurement, the Applet 43 and/or the UPAM 53 may extract its Dynamic Routing characteristic. Assuming the network usage measurement shows that the physical layer communication uses a “first path” approach, the Applet 43 and/or the UPAM 53 may then select the left-branch (or first path) of the decision tree. If previous determination has identified that at the time of the network usage measurements and/or characteristics are collected, only “address A” has been used for communication at the data link layer 366, then the Applet 43 and/or the UPAM 53 may select the left path (or first path) of the “Physical Addresses?” node 386. Based on the associations among nodes 386, 388, 392, and/or 396, the Applet 43 and/or the UPAM 53 may quickly determine that “Process UID” may be the mobile app 244 that is likely related to the specific network usage measurement, characteristic, and/or profile.

In some embodiments, even when unique association may not be established among the different identifiers, the above approach may greatly narrow down the potential mobile app(s) 244 that are related to the specific network usage measurements and/or characteristics. Such an approach may still allow the Applet 43 and/or the UPAM 53 to estimate the possible application, application characteristic, and/or profile, as well as the DOPE 70, PAST 306, TONE 307, SORT 308, POPS 309, and, QoS 310; and/or narrow-down/isolate which to analyze, compare and determine the possible network issues or opportunities (e.g. upsell) for the mobile app(s) 244 and/or device.

Note that in various non-limiting embodiments, the UPAM 53 and/or the Applet 43 may reside on the mobile device 61 or be an “on-device” applet, but the UPAM 53 and/or the Applet 43 and/or its functionality may also reside elsewhere, say in/at another computer, device, IN-UPAS 51, U-PAS 52, UPAM 53, and/or the like, and say communicating via the computer/network connection).

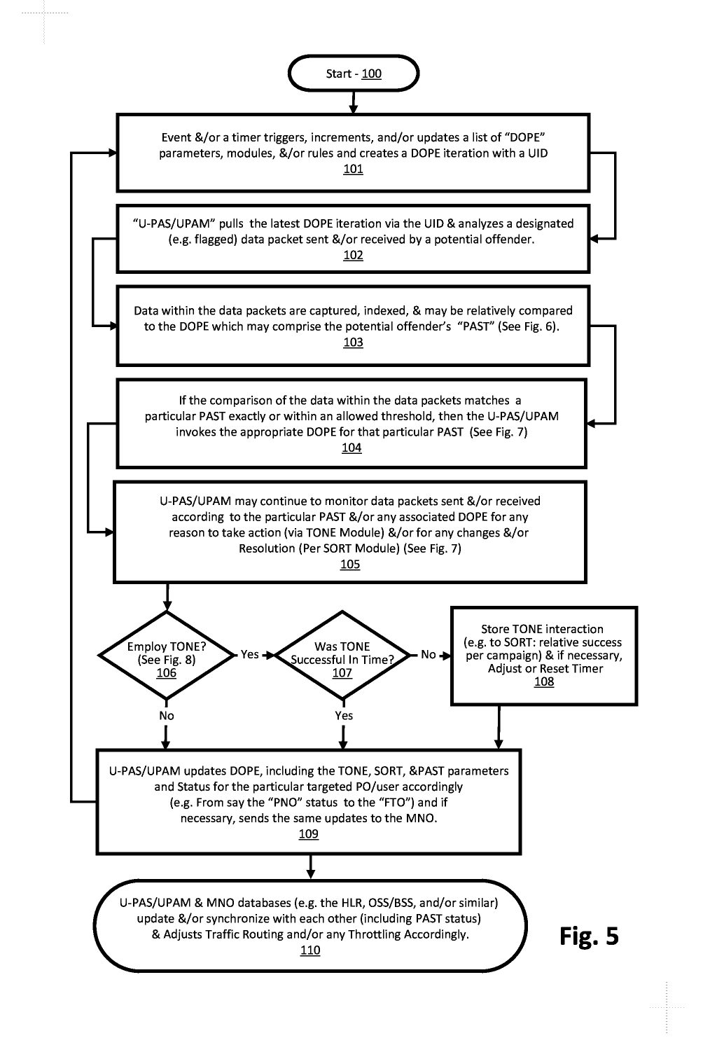

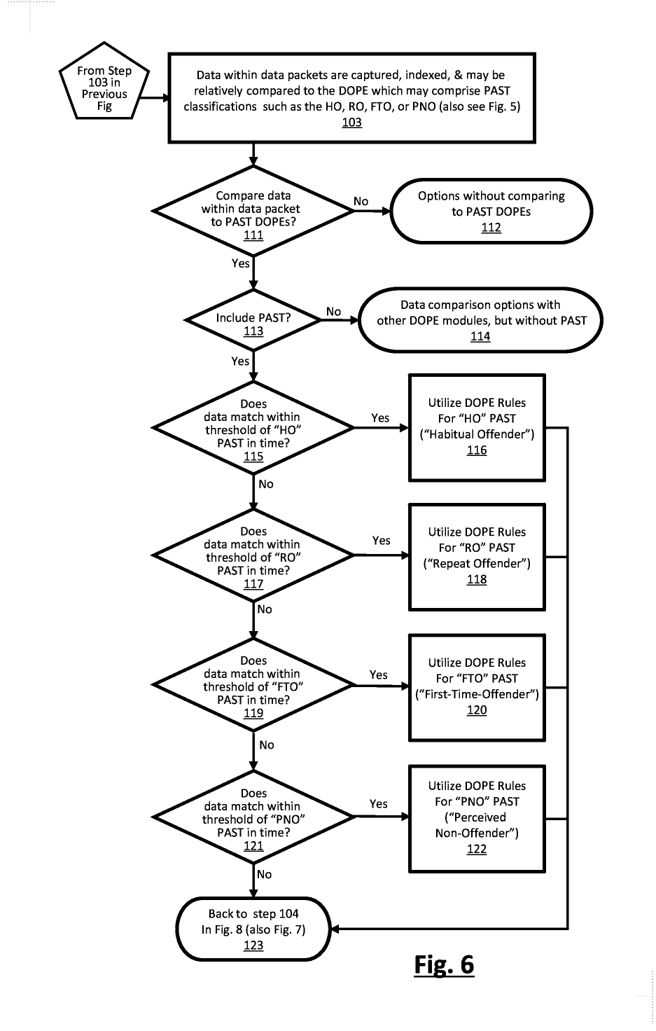

FIG. 5 depicts a flowchart of an embodiment of the U-PAS 50/UPAM 53 generating parameters and employing a Dynamic Offender Policies and Enforcement (DOPE) 70 module. Starting with a terminal 100 followed by a step 101, where an “Event &/or a timer triggers, increments, and/or updates a list of “DOPE” parameters, modules, &/or rules and creates a DOPE iteration with a UID (unique ID)” is performed. Next, a step 102, is where a “U-PAS” pulls the latest DOPE iteration via the UID & analyzes a designated (e.g. flagged) data packet sent &/or received by the potential offender” is performed. Followed by a step 103, where a “Data within data packets are captured, indexed, and may be relatively compared to the DOPE which may comprise PAST classifications such as the HO, the RO, the FTO, or the PNO,” is performed (See FIG. 6),” is performed.

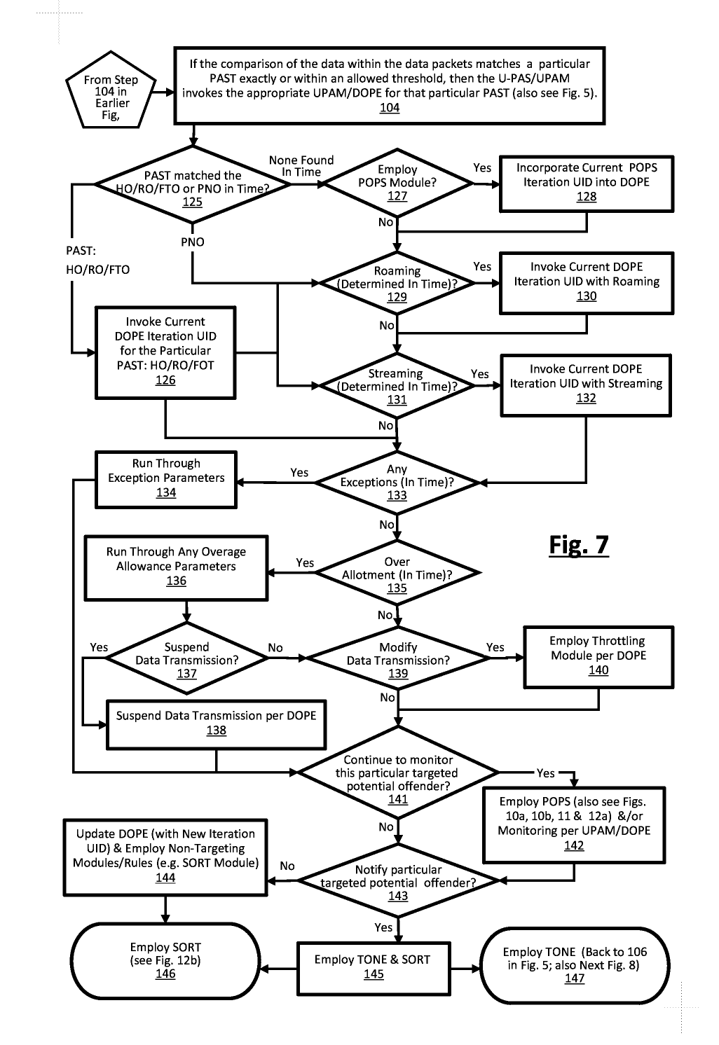

The process proceeds to a step 104, where “If the comparison of the data within the data packets matches a particular PAST exactly or within an allowed threshold, then the U-PAS invokes the appropriate DOPE for that particular PAST (See FIG. 7),” is executed. Followed by a step 105, where a “U-PAS may continue to monitor data packets sent &/or received according to the particular PAST &/or any associated DOPE for any reason to take action (via TONE Module) &/or for any changes &/or Resolution (Per SORT Module) (See FIG. 7),” is performed.

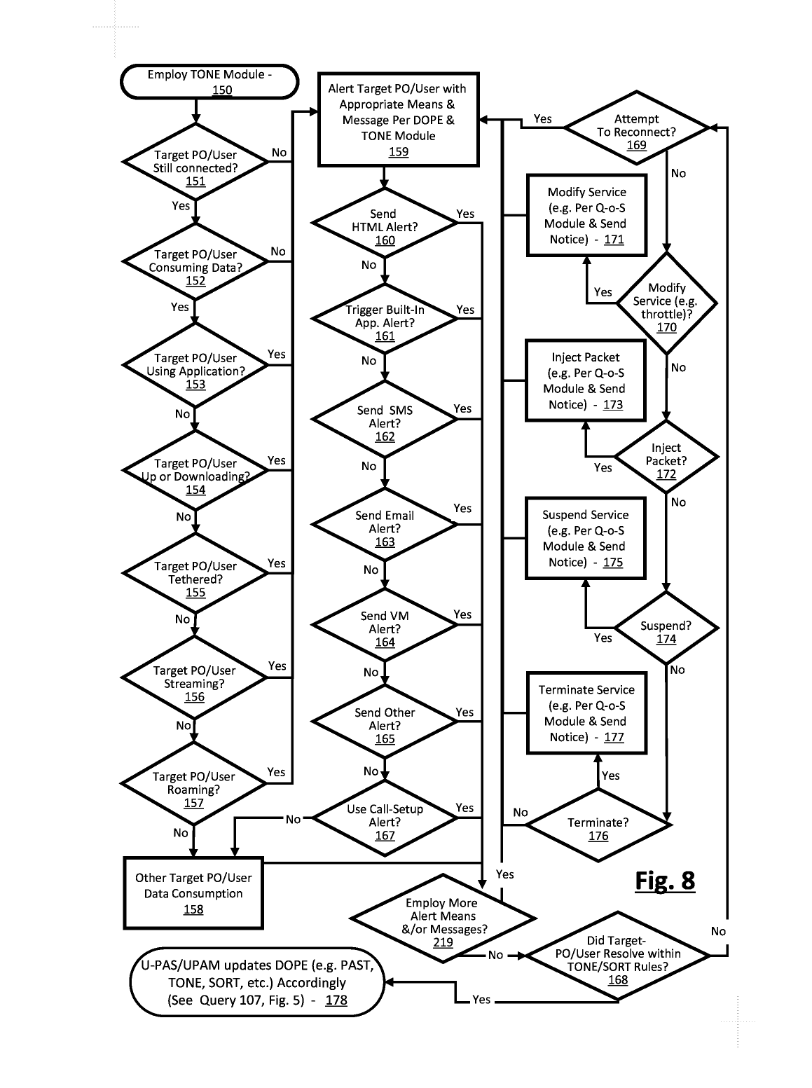

The results pass to a query 106, which asks whether to “Employ TONE? (See FIG. 8),” is performed. If the answer to query 106 is “no” then process proceeds to a step 109. If the answer to query 106 is instead “yes” then the process proceeds to a query 107, which asks “Was [the] TONE Successful In Time?” is performed. If the answer to query 107 is “Yes” the process proceeds to the step 109. If the answer to query 107 is instead “No,” then the process proceeds to a step 108, where a “Store TONE interaction (e.g. relatively success per campaign) & if necessary, Adjust or Reset Timer,” is performed.

From step 107 the process proceeds to the step 109 where a “U-PAS updates DOPE, including the TONE, SORT, &PAST parameters and Status for the particular targeted PO/user accordingly (e.g. From say the “PNO” status to the “FTO”) and if necessary, sends the same updates to the MNO 25,” is performed. Depending on the process performed and the results of the step 109, any necessary updates are either looped or cycled back from step 109 to the step 101 and/or the process proceeds to a terminator 110 where a “U-PAS & MNO 25 databases (e.g. a MSC, HLR, VLR, OSS/BSS, and/or similar) update &/or synchronize with each other (including PAST status) & Adjusts Traffic Routing and/or any Throttling Accordingly,” is performed.

FIG. 6 depicts a flowchart of an embodiment of the U-PAS 50/UPAM 53 generating parameters and employing the DOPE 70 module in association with the PAST module 306. Starting with an off page connector from step 103 in the previous figure where the “Data within data packets are captured, indexed, and may be relatively compared to the DOPE which may comprise PAST classifications such as the HO, RO, FTO, or PNO (also see FIG. 5),” is performed.

Next a query 111, asks whether to “Compare data within data packet to PAST DOPEs?” If the answer to query 111 is “No,” the process proceeds to a terminal 112, where an “Options without comparing to PAST DOPEs,” is executed. If the answer to query is 111 is instead “Yes,” the process proceeds to a query 113, which asks whether to “Include PAST?” If the answer to query 113 is “No,” the process proceeds to a terminal 114, where a “Data comparison options with other DOPE modules, but without PAST,” is executed.

If the answer to query 113 is instead “Yes,” the process proceeds to a query 115, which asks “Does data match within threshold of “HO” PAST in time?” If the answer to query 115 is “Yes,” the process proceeds to a step 116, where a “Utilize DOPE Rules for ‘HO’ PAST (“Habitual Offender”),” is executed. For example, the HO classification/criteria may be defined as someone who is/has exceeded the definition of the RO criteria/threshold. For example, say someone who has/had exceeded his/her data limits (e.g. under the Current Plan) three out of the last four months previously. These definitions, ranges, thresholds, conditions, and/or rules for the PAST classifications would preferably be set by the Current Plan provider (e.g. MNO 25), but could also be set by and/or adjusted by others with the proper permissions and access, say the father or mother of a group plan, and/or the like.

If the answer back at query 115 is instead “No,” the process proceeds to a query 117 which asks “Does data match within threshold of ‘RO’ PAST in time?” If the answer to query 117 is “Yes,” the process proceeds to a step 118, where a “Utilize DOPE Rules For ‘RO’ PAST (‘Repeat Offender’),” is performed. For example, the RO classification/criteria may be defined as someone who is/has exceeded the definition of the FTO criteria/threshold. For example, say someone who has/had exceeded his/her data limits (e.g. under the Current Plan) more than once since the Current Plan was started. These definitions, ranges, thresholds, conditions, and/or rules for the PAST classifications would preferably predefined and consistent among a particular group or segment (e.g. a particular MNO 25). The PAST Classifications could be added and associated to a user/device profile, account, and treated similar to, or along with, a credit and/or a FICO score.

If the answer back at query 117 is instead “No,” the process proceeds to a query 119, which asks “Does data match within threshold of ‘FTO’ PAST in time?” If the answer to query 119 is “Yes,” the process proceeds to a step 120, where a “Utilize DOPE Rules For ‘FTO’ PAST (‘First-Time-Offender’),” is performed. For example, the FTO classification/criteria may be defined as someone who is/has exceeded the definition of the non-offender or PNO criteria/threshold. For example, say someone who has/had never previously exceeded his/her data limits (e.g. under the Current Plan), say since the Current Plan was started. These PAST classifications would preferably allow for and/or provide a fair system with exceptions, corrections, challenges, appeals, and/or the like. The PAST Classifications and associated rules for when and how determined, implemented, evaluated, and/or the like, would preferably include a scaling and/or weighting system, where there could be, say more or less strict rules, conditions, thresholds, and/or the like, per relatively more or less offenses committed, say in relation to a window of time, a particular offense, a particular activity, a particular data plan, a particular group plan, a particular application, and/or the like.

If the answer back at query 119 is instead “No,” the process proceeds to a query 121, which asks “Does data match within threshold of ‘PNO’ PAST in time?” If the answer to query 121 is “Yes,” the process proceeds to a step 122, where a “Utilize DOPE Rules For ‘PNO’ PAST (′Perceived Non-Offender′),” is performed. If the answer back at query 121 is instead “No,” the process proceeds to a terminal 123, which goes “Back to step 104 in the previous figure and in the next figure.

For example, the PNO classification/criteria may be defined as someone who is/has never been a known or discerned past offender. For example, say someone who has never known to have exceeded his/her data limits (e.g. under the Current Plan) since the Current Plan was started or ever. These PAST classifications and associated ranges, thresholds, conditions, and/or rules, could also be relative to a particular window of time (e.g. up to age 18, where it could start over), a particular offense (e.g. overage for texting, but not data), a particular activity (e.g. overage for downloading, but nothing else), a particular location (e.g. at a college campus, but nowhere else), a particular group plan member (e.g. a 15 year old child on a plan with, say 3 others), a particular application (e.g. a specific GPS app, but none others), and/or the like. Further, where, for example, the PAST classification could be remedied in such a manner to reduce or remove the offense, PAST classification, thresholds, PAST score/profile and/or the like.

In an alternative embodiment of the flowchart depicted in FIG. 6, a nearly identical flowchart could compare data and attributes of applications, where query 111 currently asks whether to “Compare data within data packet to PAST DOPEs?,” the query could instead ask to “Compare data with an application to PAST DOPEs?,” and proceed similarly to FIG. 6, where the results would terminate at terminator 123 and where the data could be store relative to the user, device, application, and/or the like.

FIG. 7 depicts a flowchart of an embodiment of the U-PAS 50/UPAM 53 generating parameters and employing the DOPE 70 module in association with the PAST module 306, the TONE 307 module and the SORT 308 module. Starting with an off page connector from step 104 in an earlier FIG. where “If the comparison of the data within the data packets matches a particular PAST exactly or within an allowed threshold, then the U-PAS/UPAM invokes the appropriate DOPE for that particular PAST,” was performed. Next a query 125 asks whether “PAST matched the HO/RO/FTO or PNO in Time?,” where a timer may be employed. If the answer to query 125 is “None Found In Time,” the process proceeds to a query 127, where it asks whether to “Employ POPS Module?” If the answer to query 127 is “Yes,” the process proceeds to a step 128, where an “Incorporate Current POPS Iteration UID into DOPE,” is performed and passed to a query 129.

If the answer back at query 125 is “PNO” then the process splits and the appropriate answer, data and process all proceed to the query 129 and a query 131. If the answer to query 125 is the “PAST [is]: HO/RO/FTO,” then the answer, data, and process both proceeds to a step 126 where an “Invoke Current DOPE Iteration UID for the Particular PAST: HO/RO/FOT,” is performed. From step 126, the process splits and the appropriate answer, data, and process are all provided to the queries 129, 131 and a query 133. The query 129 asks if “Roaming (Determined In Time)?” If the answer to 129 is “Yes,” then the process proceeds to a step 130, where an “Invoke Current DOPE Iteration UID with Roaming,” is performed and then proceeds to the query 131. If the answer to 129 is instead “No,” then the process proceeds to the query 131. The query 131 asks if “Streaming (Determined In Time)?”

If the answer to 131 is “Yes” then the process proceeds to a step 132, where an “Invoke Current DOPE Iteration UID with Streaming,” is performed and then proceeds to the query 133. If the answer to 131 is instead “No,” then the process proceeds to the query 133. The query 133 asks if there are “Any Exceptions (In Time)?” (e.g. per the TONE parameters and criteria). If the answer to 133 is “Yes” then the process proceeds to a step 134, where a “Run Through Exception Parameters,” is performed and then proceeds to a query 141. If the answer to 133 is instead “No,” then the process proceeds to a query 135. The query 135 asks whether “Over Allotment (In Time)?,” where, for example, the U-PAS/UPAM compare data to an allotment/threshold/range (e.g. per the Current Plan and/or the threshold allowance/settings). The phrase “In Time,” typically refers to a computing determination or result that must be arrived at and/or concluded within a particular time allotment/threshold allowed/set by the timer. Further, where the U-PAS/UPAM would preferably have default conditions or alternative paths when such determinations or results were not arrived at and/or concluded in time.

If the answer back in 135 is “No,” then the process proceeds to a query 139. If the answer to 135 is instead “Yes” then the process proceeds to a step 137, where a “Run Through Any Overage Allowance Parameters,” is performed and then proceeds to a query 137. The query 137 asks whether to “Suspend Data Transmission?” If the answer to 137 is “Yes” then the process proceeds to a step 138, where a “Suspend Data Transmission per DOPE,” is performed and then proceeds to the query 141. If the answer to 137 is instead “No,” then the process proceeds to the query 139.

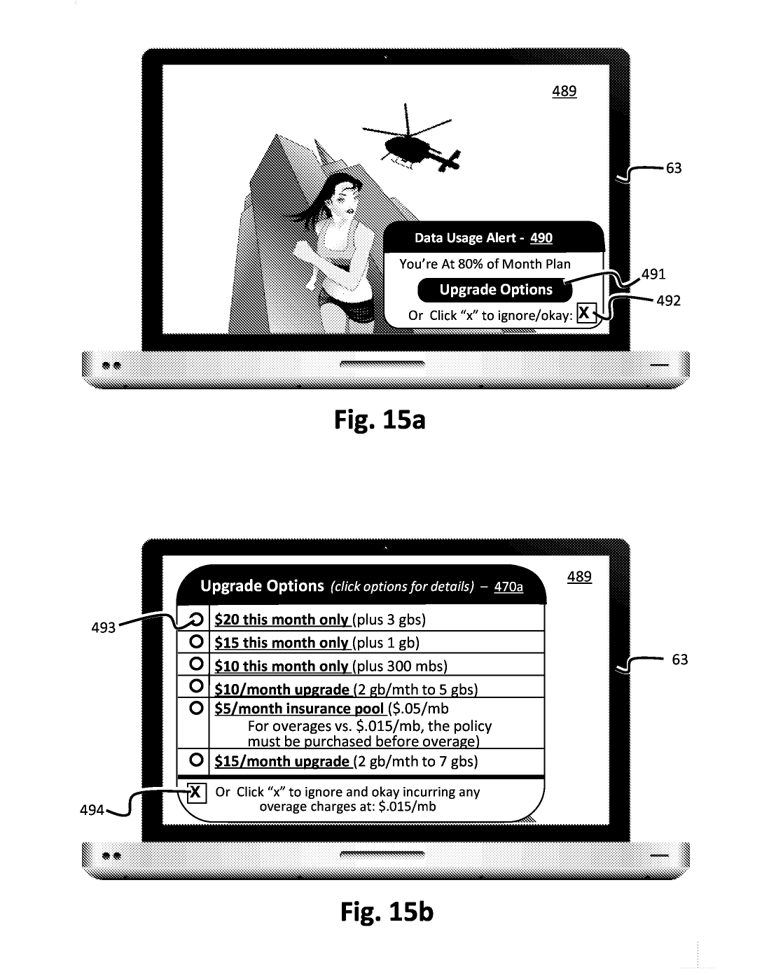

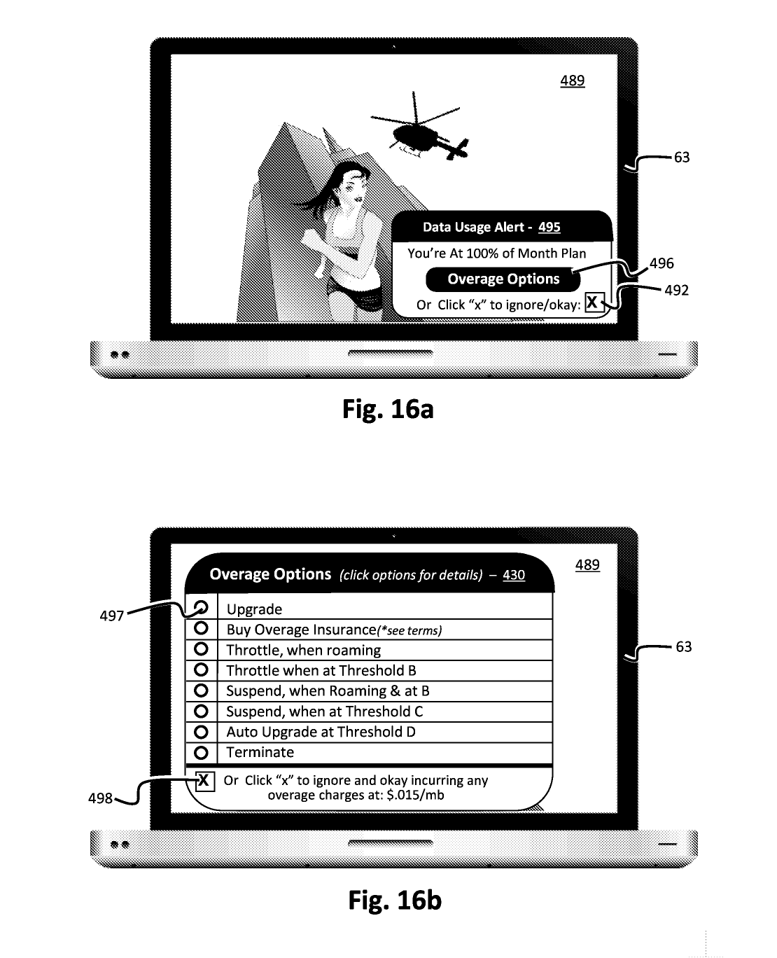

The query 139 asks whether to “Modify Data Transmission?” If the answer to 139 is “Yes” then the process proceeds to a step 140, where an “Employ Throttling Module per DOPE,” is performed and then proceeds to the query 141. If the answer to 139 is instead “No,” then the process proceeds to the query 141. The query 141 asks whether to “Continue to monitor this particular targeted potential offender?” If the answer to 141 is “Yes” then the process proceeds to a step 142, where an “Employ POPS (FIGS. 10a/b, 11, & 12a) &/or Monitoring per DOPE,” is performed and then proceeds to a query 143. If the answer to 141 is instead “No,” then the process proceeds to the query 143. The query 143 asks whether to “Notify particular targeted potential offender?,” for example with an alert (also see FIGS. 15a-16b)

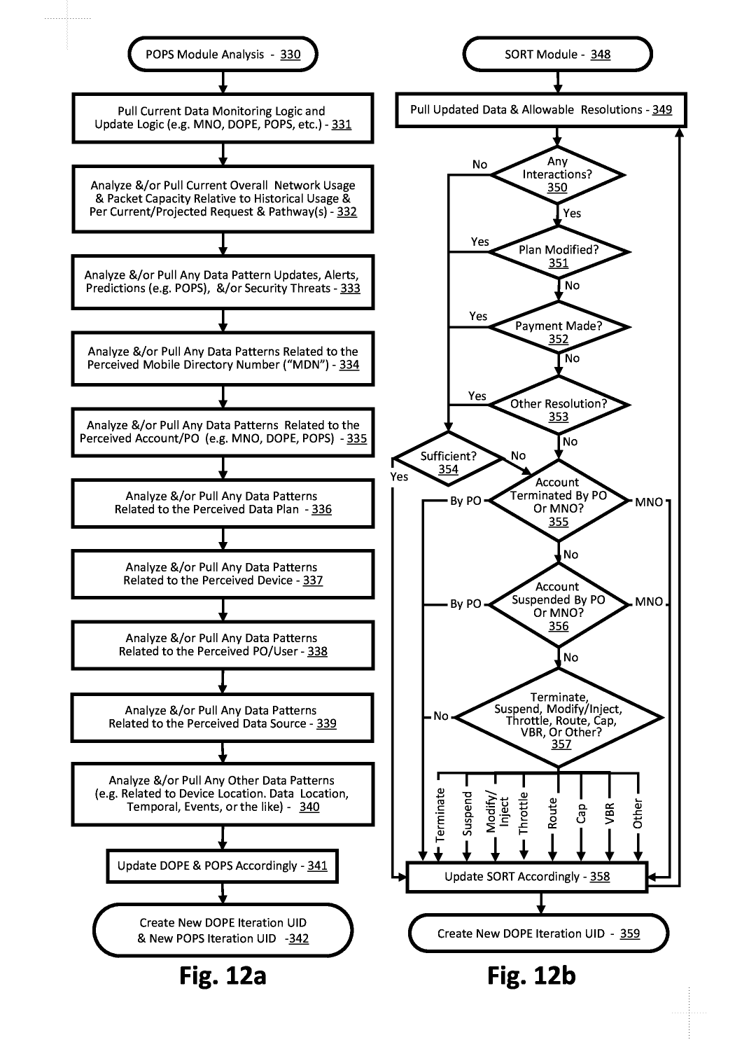

If the answer to 143 is “No” then the process proceeds to a step 144, where an “Update DOPE (with New Iteration UID) & Employ Non-Targeting Modules/Rules (e.g. SORT Module),” is performed and then proceeds to a terminator 146 where an “Employ SORT (see FIG. 12b)” is executed. If the answer to 143 is instead “Yes,” then the process proceeds to a step 145, where an “Employ TONE & SORT” is executed and the results are passed to both the terminator 146 and a terminator 147, where an “Employ TONE (Back to 106 in FIG. 5; also next FIG. 8)” is executed.

FIG. 8 depicts a flowchart of an embodiment of the U-PAS 50/UPAM 53 generating parameters and employing the TONE 307 module. Starting with a terminal 150 with an “Employ Tone Module,” the process proceeds to a query 151, which asks if “Target PO/User Still connected?” If the answer to query 151 is “No” then the process proceeds to a step 159, where an “Alert Target PO/User with Appropriate Means & Message Per DOPE & TONE Module.” If the answer to query 151 is instead “Yes,” then the process proceeds to a query 152, where it asks if a “Target PO/User [is] Consuming Data?,” where a timer value and a set of conditions would typically be applied to create a “yes” or “no” result.

If the answer to query 152 is “No” then the process proceeds to the step 159. If the answer to query 152 is instead “Yes,” then the process proceeds to a query 153, where it asks if a “Target PO/User [is] Using [an] Application?” If the answer to query 153 is “Yes” then the process proceeds to the step 159. If the answer to query 153 is instead “No,” then the process proceeds to a query 154, where it asks if a “Target PO/User [is] Up[loading] or Downloading?” If the answer to query 154 is “Yes” then the process proceeds to the step 159. If the answer to query 154 is instead “No,” then the process proceeds to a query 155, where it asks if a “Target PO/User [is] Tethered?” If the answer to query 155 is “Yes” then the process proceeds to the step 159. If the answer to query 155 is instead “No,” then the process proceeds to a query 156, where it asks if a “Target PO/User [is] Streaming?” If the answer to query 156 is “Yes” then the process proceeds to the step 159.

If the answer to query 156 is instead “No,” then the process proceeds to a query 157, where it asks if a “Target PO/User [is] Roaming?” If the answer to query 157 is “No,” then the process proceeds to a step 158, where a “Other Target PO/User Data Consumption,” is performed before proceeding to a query 219, where it asks “Employ More Alert Means &/or Messages?” If the answer back at query 157 is instead “Yes” then the process proceeds to the step 159. At the step 159, the process performs an “Alert Target PO/User with Appropriate Means & Message Per DOPE & TONE Module,” followed by a query 160, where it asks whether to “Send HTML Alert?” If the answer to query 160 is “Yes,” then the process is executed, where, for example, the html formatted alert is sent to the user (e.g. the offender and/or some other appointed/assigned device/user, e.g. the boss of a group), and the process proceeds to the query 219. If the answer to query 160 is instead “No” then it proceeds to a query 161, which asks if there is a “Trigger Built-in Application Alert?” If the answer to query 161 is “Yes,” then the process is executed, where, for example, the built-in application alert is triggered and displays a Pop-Up to the user (e.g. the offender and/or also sent to some other appointed/assigned device/user/built-in-application, e.g. the father of a family plan), and the process proceeds to the query 219.

If the answer to query 161 is instead “No,” then the process proceeds to a query 162, which asks whether to “Send SMS Alert?” If the answer to query 162 is “Yes,” then the process is executed, where, for example, the SMS formatted text alert is sent to the user (e.g. the offender and/or some other appointed/assigned device/user, e.g. another device/party designated by user), and the process proceeds to the query 219. If the answer to query 162 is instead “No” then it proceeds to a query 163, which asks whether to “Send Email Alert?” If the answer to query 163 is “Yes,” then the process is executed, where, for example, the formatted email message/alert is sent to the user (e.g. the offender and/or some other appointed/assigned device/user/email address, e.g. another device/party/email designated by user), and the process proceeds to the query 219.

If the answer to query 163 is instead “No,” then the process proceeds to a query 164, which asks whether to “Send VM [voicemail] Alert?” If the answer to query 164 is “Yes,” then the process is and proceeds to the query 219. If the answer to query 164 is instead “No” then it proceeds to a query 165, which asks whether to “Send Other Alert?” If the answer to query 165 is “Yes,” then the process is executed, where some other formatted message/alert is sent to the user (e.g. a direct mail piece to the offender and/or some other appointed/assigned device/user/location/address), and the process proceeds to the query 219.

If the answer to query 165 is instead “No,” then the process proceeds to a query 167, which asks whether to “Use Call-Setup Alert?” If the answer to query 167 is “Yes,” then the process is executed, where, for example, the Call Setup Alert (or AAM) is prepared, with the user/device flagged, and eventually sent when the user makes a phone call (e.g. the next phone by the offender and/or some other appointed/assigned device/user), proceeds to the query 219. If the answer to query 167 is instead “No,” then the process proceeds to the query 219. If the answer to query 219 is “Yes” then the process proceeds to the step 159. If the answer to query 219 is instead “No,” then the process proceeds to a query 168, where it asks “Did Target-PO/User Resolve within the TONE/SORT Rules?” If the answer to query 168 is instead “No,” then the process proceeds to the query 169, where it asks whether to “Attempt To Reconnect?” If the answer to query 169 is “Yes” then the process proceeds to the step 159. If the answer to query 169 is instead “No,” then the process proceeds to a query 170, where it asks whether to “Modify Service (e.g. throttle)?” If the answer to query 170 is “Yes” then the process proceeds to a step 171, where a “Modify Service (e.g. Per Q-o-S Module & Send Notice),” is performed and the results are forwarded to the step 159.

If the answer to query 170 is instead “No,” then the process proceeds to a query 172, where it asks whether to “Inject [a] Packet?” If the answer to query 172 is “Yes” then the process proceeds to a step 173, where an “Inject Packet (e.g. Per Q-o-S Module & Send Notice),” is performed and the results are forwarded to the step 159. If the answer to query 172 is instead “No,” then the process proceeds to a query 174, where it asks whether to “Suspend?” If the answer to query 174 is “Yes” then the process proceeds to a step 175, where a “Suspend Service (e.g. Per Q-o-S Module & Send Notice),” is performed and the results are forwarded to the step 159. If the answer to query 174 is instead “No,” then the process proceeds to a query 176, where it asks whether to “Terminate?” If the answer to query 176 is “Yes” then the process proceeds to a step 177, where a “Terminate Service (e.g. Per Q-o-S Module & Send Notice),” is performed and the results are forwarded to the step 159. If the answer to query 176 is instead “No,” then the process proceeds to step 159. If the answer back at query 168 is “Yes” then the process proceeds to a terminator 178 where a “U-PAS updates DOPE (e.g. PAST, TONE, SORT, etc.) Accordingly (See Query 107, FIG. 5).”

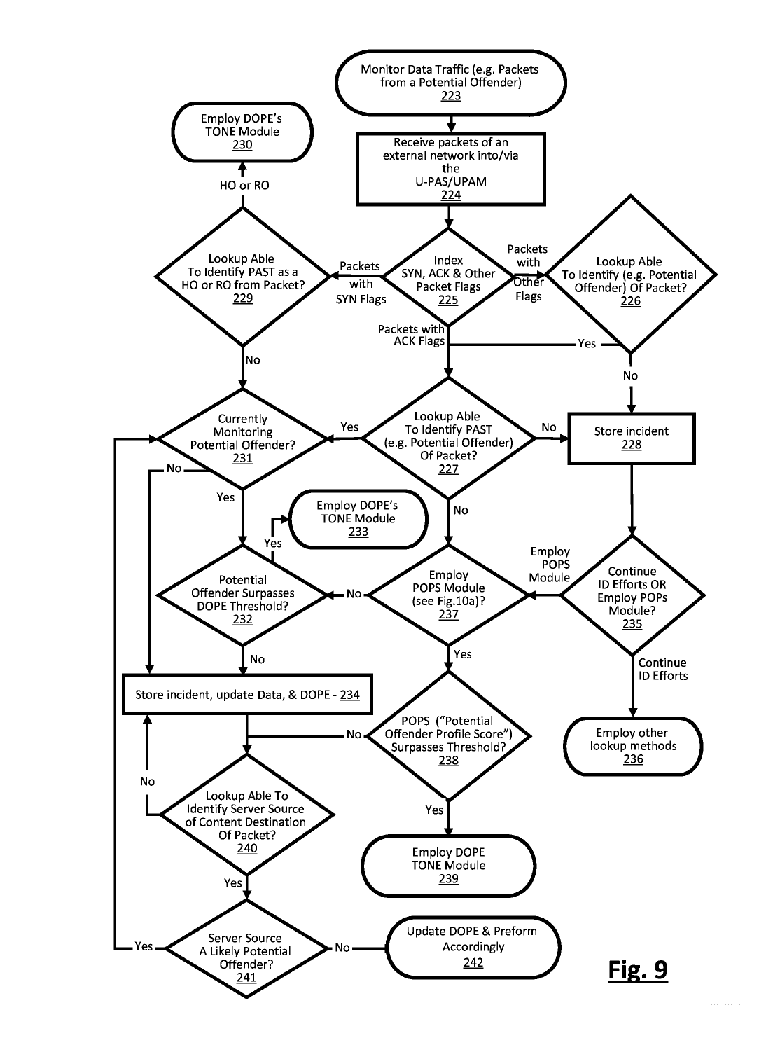

FIG. 9 depicts a flowchart of an embodiment of the U-PAS 50/UPAM 53 generating iterations employing the DOPE 70 module in association with the PAST module 306, the TONE 307 module, the SORT 308 module, and a Potential Offender Profile Score (POPS) 309 module. Starting with a terminal 223 for a “Monitor Data Traffic (e.g. Packets from the Potential Offender),” the process advances to a step 224, where the computer implemented system and method “Receive packets of an external network via the U-PAS.”

Next, the process proceeds to a query 225, which asks to identify and “Index SYN, ACK & Other Packet Flags.” If the answer/results to query 225 is “Packets with SYN Flags,” then those packets are forwarded to a query 229, where it asks if a “Lookup [is] Able To Identify PAST as a HO or RO from Packet?” If the answer to query 229 is “HO or RO,” then process proceeds to a terminal 230 where an “Employ DOPE's TONE Module,” is executed. If the answer to query 229 is instead “No,” then process proceeds to a query 231, where it asks whether “Currently Monitoring Potential Offender?”

If the answer to query 231 is “No,” then process proceeds to a step 234 where a “Store Incident, update Data, & DOPE,” are performed, before proceeding to a query 240. If the answer to query 231, is instead “Yes,” then the process proceeds to a query 232 which asks if “Potential Offender Surpasses DOPE Threshold?” If the answer to query 232 is “Yes,” the process proceeds to a terminal 233 where an “Employ DOPE's TONE Module” is executed. If the answer to query 232 is instead “No,” then the process proceeds to the step 234. Referring back to query 225, if the answer/results is instead “Packets with Other Flags,” then those packets are forwarded to a query 226, where it asks if a “Lookup [is] Able To Identify (e.g. Potential Offender) Of Packet?” If the answer to query 226 is “No,” then process proceeds to a step 228, where a “Store Incident,” is performed. If the answer to query 226 is instead “Yes,” then process proceeds to a query 227.

If the answer/results back at query 225, is instead “Packets with ACK Flags,” then the process proceeds to the query 227, which asks if a “Lookup [is] Able To Identify PAST (e.g. Potential Offender) Of Packet?” If the answer to query 227 is “No,” the process proceeds to both a query 237 and the step 228 and then to a query 235, which asks whether to “Continue ID Efforts Or Employ POPs Module?” If the answer to query 235 is “Continue ID Efforts,” then the process proceeds to a terminal 236 where an “Employ other lookup methods” is executed. If the answer to query 235 is instead “Employ POPs Module,” then process proceeds to the query 237, which asks whether to “Employ POPs Module (see FIG. 10a)?” If the answer is “Yes,” the process proceeds to a query 238. If the answer is instead “No,” the process proceeds to a query 232. Back at query 227, if the answer is instead “Yes,” then the process proceeds to the step 231.

Referring back to the query 240, which asks if a “Lookup [is] Able To Identify Server Source of Content Destination Of Packet?” If the answer to query 240 is “No,” then the process proceeds to the step 234. If the answer to query 240 is instead “Yes,” then the process proceeds to a query 241, where it asks if “Server Source A Likely Potential Offender?′ If the answer to query 241 is “Yes,” then process loops back to query 231. If the answer to query 241 is instead “No,” then process proceeds to a terminator 242, where an “Update DOPE & Preform Accordingly” is executed.

Referring back to the query 238, which asks if a “POPS (“Potential Offender Profile Score”) Surpasses Threshold?” If the answer to query 238 is “No,” then the process proceeds to the query 240. If the answer to query 238 is instead “Yes,” then process proceeds to a terminator 239, where an “Employ DOPE TONE Module” is executed.

FIG. 10a depicts a flowchart of an embodiment of the U-PAS 50/UPAM 53 generating parameters and employing the POPS 309 module. Starting with a terminator 180 where an “Employ POPS Module” the process then proceeds to a query 181 which asks for “Request For Latest POPS Iteration UID (unique ID)?” If the answer to query 181 is “yes,” then the process proceeds to a terminator 182, where a “Supply Latest POPS Iteration Via UID” is executed. If the answer to the query 181 is instead “No,” then the process proceeds to a step 183 where a “Pull Current POPS Analysis (see FIG. 12a) & Query List (see FIG. 11),” is performed.

Next, the process proceeds to a query 184, which asks if “Any Data [is] Missing?” If the answer to query 184 is “No,” then the process proceeds to a step 194 where an “Update POPS Accordingly” is performed. If the answer to query 184 is instead “yes,” then the process proceeds to a step 185 where an “Employ POPS Reattempt Rules” is executed.

From step 185 the process proceeds to a set of options starting with a “Select Query Q” 186 option and a “Select Query Q1” 187 option, where the “Select Query Q” 186 option could represent the first in a series of question/queries, and where the “Select Query Q1” 187 option is an ability to increment and track where a particular list of questions remain to be addressed and/or answered. From options 186-187, the process proceeds to a set of options starting with a “Select Source S” 188 option and a “Select Source S¹” 189 option, where again the “Select Source S” 188 option could represent the first in a series of sources/question, and where the “Select Source S¹” 189 option is an ability to increment and track where a particular list of questions remain to be addressed and/or answered per a particular source.

From options 188-189, the process proceeds to a query 190, which asks if “Data [was] Collected In Time?,” where a timer may be implemented to maintain relative comparisons per time limits, for limited resource consumption by time allowances, reduce data bottlenecks, and/or the like. If the answer to query 190 is “no,” then the process proceeds to the step 194. If the answer to query 190 is instead “yes” then the process proceeds to a query 191, which asks if “Data Creates An Approved Fact?” If the answer to query 191 is “yes,” where data collected generates an approved fact, for say, determining a location of user, a type of application in usage, a type of content being downloaded, and/or the like, then the process proceeds to step 194.

If the answer to query 191 is instead “No,” where there is insufficient data to surpass a threshold of an approved fact, then the process proceeds to a query 192, which asks if “Data Creates An Assumption?” If the answer to query 192 is “No,” then the process proceeds to the step 194. If the answer to query 192 is instead “yes,” where there is insufficient data available to generate a fact, but sufficient data to surpass an assumption threshold, then the process proceeds to a query 193, which asks if “Assumption [has been] Approved or Verified?,” where the system may automatically, systematically, conditionally, and/or user-selectively perform a list of steps to approve and/or verify the assumption. For example, relatively compare the data to other facts, assumptions, and/or the like for the same user, device, location, at the same time; relatively compare data to historical data, and/or other users, with the same and/or similar devices, locations, time windows, conditions, circumstances, events, histories, and/or the like.

If the answer to query 193 is “yes,” then the process performs such approvals and/or verifications according to the current rules and conditions, before proceeding to the step 194. If the answer to the query 193 is instead “No,” then the process proceeds to the same step 194, where rules and conditions could be set to revisit the assumption, and/or relatively score the assumption based upon other data, facts, and/or assumptions. Lastly, from the Update POPS Accordingly in the step 194 the process ends with a terminator 195 where a “Create New POPS iteration UID” is executed. Iterative POPS UID allow for historical, current, and future data comparisons relative to time and/or the ability to retrieve data, facts, assumptions, and/or the like for future needs, e.g. an assumption, verification, comparison, and/or the like.

FIG. 10b depicts a flowchart of an embodiment of the POPS 309 module for a query selection and querying methods per FIG. 10a. Starting with a terminator 200 where an “Example of FIG. 10a ‘Select Query Q’,” is invoked, and the process then proceeds to a step 268a, which retrieves the appropriate question per rules, conditions, and last/previous question asked/addressed/answered, where in this example the system retrieved and asked the query/question regarding “Past Overall Usage?” (step 268 per next FIG. 11).

Next the process proceeds to a step 201, where the system explains a list of parameters to determine if there are any “Missing Data Fields” per query. In this example of “Past Overall Usage” the data fields could include a “Voice Minutes/Per Connection/Time” field/option 202, a “Data Consumed/Connection/Time” field/option 203, a “Destination IP Address/Use” field/option 204, a “Source IP Address/Use” field/option 205, a “Data Types/Use” field/option 206, and a “Other Missing Fields” field/option 207. For this example, the “Voice Minutes/Per Connection/Time” field/option 202 would preferably highlight what data was missing, was considered a fact, or was considered an assumption (e.g. approved or verified) for any past voice minutes consumed per connection per time and/or the like. The “Data Consumed/Connection/Time” field/option 203 would preferably highlight what data was missing, was considered a fact, or was considered an assumption (e.g. approved or verified) for any past data consumption per connection per time and/or the like.

The “Destination IP Address/Use” field/option 204 would preferably highlight what data was missing, was considered a fact, or was considered an assumption (e.g. approved or verified) for any destination IP address utilized per usage window and/or the like. The “Source IP Address/Use” field/option 205 would preferably highlight what data was missing, was considered a fact, or was considered an assumption (e.g. approved or verified) for any source IP address utilized per usage window and/or the like. The “Data Types/Use” field/option 206 would preferably highlight what data was missing, was considered a fact, or was considered an assumption (e.g. approved or verified) for any data type classification per usage, usage window and/or the like. The “Other Missing Fields” field/option 207 is a catch-all and would preferably highlight what other key data was missing, was considered a fact, or was considered an assumption (e.g. approved or verified) and/or the like.

From fields/options 202-207, the process proceeds to step 208 where a “Select Sources (Per POPs Reattempt Rules)” is performed. In this example with “Past Overall Usage (268 query from FIG. 11)” the source options could include a “Source: MNO 25HLR” option 209, a “Source MNO 25OSS/BSS” option 210, a “Source MNO 25SMS/MMS Gateway” option 211, a “Source Survey PO/User” option 212, a “Source Credit History” option 213, and a “Source Other” option 214. For this example, the “Source: MNO 25HLR” option 209 would preferably interrogate the appropriate and suitable Mobile Network Operator(s) HLR(s) source databases and/or the like to obtain the necessary missing data, queries, fact thresholds/conditions/rules, assumption thresholds/conditions/rules, assumption approvals, validations, and/or the like.

The “Source MNO 25OSS/BSS” option 210 would preferably interrogate the appropriate and suitable Mobile Network Operator(s) OSS(s)/BSS(s) source databases and/or the like to obtain the necessary missing data, queries, fact thresholds/conditions/rules, assumption thresholds/conditions/rules, assumption approvals, validations, and/or the like. Here, for example, the U-PAS 50/UPAM 53 could seek to obtain/verify a user/device's Current Plan. The “Source MNO 25SMS/MMS Gateway” option 211 would preferably interrogate the appropriate and suitable Mobile Network Operator(s) SMS/MMS Gateway source databases and/or the like to obtain the necessary missing data, queries, fact thresholds/conditions/rules, assumption thresholds/conditions/rules, assumption approvals, validations, and/or the like.

The “Source Survey PO/User” option 212 would preferably interrogate the appropriate and suitable Potential Offender Survey per User source databases and/or the like to obtain the necessary missing data, queries, fact thresholds/conditions/rules, assumption thresholds/conditions/rules, assumption approvals, validations, and/or the like. The “Source Credit History” option 213 would preferably interrogate the appropriate and suitable Credit History source databases and/or the like to obtain the necessary missing data, queries, fact thresholds/conditions/rules, assumption thresholds/conditions/rules, assumption approvals, validations, and/or the like. The “Source Other” option 214 is a catchall that would preferably interrogate any other key appropriate and suitable other source databases and/or the like to obtain the necessary missing data, queries, fact thresholds/conditions/rules, assumption thresholds/conditions/rules, assumption approvals, validations, and/or the like. Lastly, from source options 209-214 the process ends with a terminator 215, where the process returns “Back To Query 190 in FIG. 10a” is executed.

FIG. 11 depicts a flowchart of an embodiment of the POPS 309 module for query selection and querying methods in more detail. Starting with step 246 “POPS Query Qs” then proceeds to a query 247, which asks if a “Plan [is] Known?” If the answer to query 247 is “details” where there are new details discovered, and/or sufficient details to add regarding the particular query (e.g. here “Plan Known”), then the process proceeds to a step 248 where the UPAM 53/POPS performs an “Adjust Profile Score with [new] facts and details [collected, along] with each date and time; and advance[s] to next question.” If the answer to query 247 is an “assumption” then the process proceeds to a step 249 where an “Adjust Profile with Calculated Prediction and Advance to Next Question” is performed. If the answer to query 247 is instead has an “Insufficient Data” result, where rules and condition would preferably mark, store, and score each “insufficient data” situation for follow-up analysis and potential remedies, and the process proceeds to the next query, here a query 250, which asks “Parties in Group Plan?”

If the answer to query 250 is “Details” then the process proceeds to step 248. If the answer to query 250 is “assumption” then the process proceeds to step 249. If the answer to query 250 is instead “Insufficient Data,” then the process proceeds to a query 251, which asks “Has Internet At Home?” If the answer to query 251 is “Details” then the process proceeds to step 248. If the answer to query 251 is “assumption” then the process proceeds to step 249. If the answer to query 251 is instead “Insufficient Data,” then the process proceeds to a query 252, which asks “In School?”

If the answer to query 252 is “Details” then the process proceeds to step 248. If the answer to query 252 is “assumption” then the process proceeds to step 249. If the answer to query 250 is instead “Insufficient Data,” then the process proceeds to a query 253, which asks “Other Data Usage/WiFi?” If the answer to query 253 is “Details” then the process proceeds to step 248. If the answer to query 253 is “assumption” then the process proceeds to step 249. If the answer to query 253 is instead “Insufficient Data,” then the process proceeds to a query 254, which asks “Overall Device History?”

If the answer to query 254 is “Details” then the process proceeds to step 248. If the answer to query 253 is “assumption” then the process proceeds to step 249. If the answer to query 254 is instead “Insufficient Data,” then the process proceeds to a query 255, which asks “Credit/FICO?,” where for example, the U-PAS 50/UPAM 53 would seek to obtain and/or verify a particular data point, say regarding a particular user's credit history and/or FICO score. Further, where this data could be periodically updated, compared, and/or verified according to rules, conditions, PAST classifications, changes, economy, statistics, the timer, plan changes, modification requests, insurance request, a particular event (e.g. an overage) and/or the like. In addition, where these periodically updates, comparisons, verifications and/or the like could setup to function automatically, systematically, conditionally, and/or user-selectively.

If the answer back at query 255 is “Details” then the process proceeds to step 248. If the answer to query 255 is “assumption” then the process proceeds to step 249. If the answer to query 255 is instead “Insufficient Data,” then the process proceeds to a query 256, which asks “Commuter?,” where, for example, the U-PAS 50/UPAM 53 would seek to obtain and/or verify a particular data point, say regarding a particular user or device belongs to someone who commutes, say where location-tracking data could reveal a location and/or pattern associated with a particular commuting pattern, say for a commuter train. In addition, there could be data correlation and/or data verification requests regarding banking and/or credit card data. Where, for example, there could be train passes purchased, toll booth payments, food purchased in train stations, and/or the like. This commuter data and associations could be periodically updated, compared, and/or verified according to rules, conditions, PAST classifications, changes, economy, statistics, the timer, plan changes, modification requests, insurance request, a particular event (e.g. an overage) and/or the like. In addition, where these periodically updates, comparisons, verifications and/or the like could setup to function automatically, systematically, conditionally, and/or user-selectively.

If the answer back at query 256 is “Details” then the process proceeds to step 248. If the answer to query 256 is “assumption” then the process proceeds to step 249. If the answer to query 256 is instead “Insufficient Data,” then the process proceeds to a query 257, which asks “Demographics?” If the answer to query 257 is “Details” then the process proceeds to step 248. If the answer to query 257 is “assumption” then the process proceeds to step 249. If the answer to query 257 is instead “Insufficient Data,” then the process proceeds to a query 258, which asks “Psychographics?”

If the answer to query 258 is “Details” then the process proceeds to step 248. If the answer to query 258 is “assumption” then the process proceeds to step 249. If the answer to query 258 is instead “Insufficient Data,” then the process proceeds to a query 259, which asks “SMS Usage?” If the answer to query 259 is “Details” then the process proceeds to a step 260 with an “Adjust Profile Score with facts and details with each data source per date & time; and Advance to the Next Question,” where the same or similar step to 248 is performed. If the answer to query 259 is “assumption” then the process proceeds to step 249. If the answer to query 259 is instead “Insufficient Data,” then the process proceeds to a query 261, which asks “Email Usage?”

If the answer to query 261 is “Details” then the process proceeds to step 260. If the answer to query 261 is “assumption” then the process proceeds to step 249. If the answer to query 261 is instead “Insufficient Data,” then the process proceeds to a query 262, which asks “Downloads?” If the answer to query 262 is “Details” then the process proceeds to step 260. If the answer to query 262 is “assumption” then the process proceeds to step 249. If the answer to query 259 is instead “Insufficient Data,” then the process proceeds to a query 263, which asks “Streaming Services?”

If the answer to query 263 is “Details” then the process proceeds to step 260. If the answer to query 263 is “assumption” then the process proceeds to step 249. If the answer to query 263 is instead “Insufficient Data,” then the process proceeds to a query 264, which asks “Tethered Usage?” If the answer to query 264 is “Details” then the process proceeds to step 260. If the answer to query 264 is “assumption” then the process proceeds to step 249. If the answer to query 264 is instead “Insufficient Data,” then the process proceeds to a query 265, which asks “GPS Usage?”

If the answer to query 265 is “Details” then the process proceeds to step 260. If the answer to query 265 is “assumption” then the process proceeds to step 249. If the answer to query 265 is instead “Insufficient Data,” then the process proceeds to a query 266, which asks “Application Usage?” If the answer to query 266 is “Details” then the process proceeds to step 260. If the answer to query 266 is “assumption” then the process proceeds to step 249. If the answer to query 266 is instead “Insufficient Data,” then the process proceeds to a query 267, which asks “Roaming Usage?”

If the answer to query 267 is “Details” then the process proceeds to step 260. If the answer to query 267 is “assumption” then the process proceeds to step 249. If the answer to query 267 is instead “Insufficient Data,” then the process proceeds to a query 268, which asks “Past Overall Usage?” If the answer to query 268 is “Details” then the process proceeds to step 260. If the answer to query 268 is “assumption” then the process proceeds to step 249. If the answer to query 268 is instead “Insufficient Data,” then the process proceeds to a query 269, which asks “Past Resolutions?”

If the answer to query 269 is “Details” then the process proceeds to step 260. If the answer to query 269 is “assumption” then the process proceeds to step 249. If the answer to query 269 is instead “No,” then the process ends with a terminator 270, where “Update ‘POPS’ & iteration UID (99) (Potential Offender Profile Score′).”

FIG. 12a depicts a flowchart of an embodiment of the POPS 309 module analysis and methods in more detail. Starting with a terminator 330 where a “POPS Module Analysis” process then proceeds to a step 331 where a “Pull Current Data Monitoring Logic and Update Logic (e.g. MNO 25, DOPE, POPS, etc.)” is performed.

Next, the process proceeds to a step 332 where an “Analyze &/or Pull Current Overall Network Usage & Packet Capacity Relative to Historical Usage & Per Current/Projected Request& Pathway(s)” is performed (also see FIGS. 4a/b). From step 332 the process proceeds to a step 333 where an “Analyze &/or Pull Any Data Pattern Updates, Alerts, Predictions (e.g. POPS), & or Security Threats” is performed. Here the U-PAS 50/UPAM 53 can pull from the data previously obtained and/or verified by the POPS, including, say for other “details,” facts, assumptions, and/or correlations.

From step 333 the process proceeds to a step 334 where an “Analyze &/or Pull Any Data Patterns Related to the Perceived Mobile Directory Number (‘MDN’)” is performed. From step 334 the process proceeds to a step 335 where an “Analyze &/or Pull Any Data Patterns related to the Perceived Account/PO (e.g. MNO 25, DOPE, POPS)” is performed. From step 335 the process proceeds to a step 336 where an “Analyze &/or Pull Any Data Patterns Related to the Perceived Data Plan” is performed. From step 336 the process proceeds to a step 337 where an “Analyze &/or Pull Any Data Patterns Related to the Perceived Device” is performed.

From step 337 the process proceeds to a step 338 where an “Analyze &/or Pull Any Data Patterns Related to the Perceived PO/User” is performed. From step 338 the process proceeds to a step 339 where an “Analyze &/or Pull Any Data Patterns Related to the Perceived Data Source” is performed.

From step 339 the process proceeds to a step 340 where an “Analyze &/or Pull Any Other Data Patterns (e.g. Related to Device Location. Data Location, Temporal, Events, or the like)” is performed. From step 340 the process proceeds to a step 341 where an “Update DOPE & POPS Accordingly” is performed. From step 341 the process ends with a terminator where a “Create New DOPE Iteration UID & New POPS Iteration UID” 342 is executed. Where, for example, a similar process could be also be executed for the AMMM and the above functionality and methods.

FIG. 12b depicts a flowchart of an embodiment of the SORT 308 module analysis and methods in more detail. Starting with a terminator 348 where a “SORT Module” is executed. From terminator 348 the process proceeds to a step 349 where a “Pull Updated Data & Allowable Resolutions” is performed. From step 349 the process proceeds to a query 350 which asks “Any Interactions?” Here the U-PAS 50/UPAM 53 monitors and determines if there are any interactions with the user/device. Where, for example, depending on a set of predefined/established conditions, thresholds, rules and/or the like; a particular interaction with a user/device, may or may not be anticipated, required, appropriate, and/or the like. Further, where the set of predefined/established conditions, thresholds, rules and/or the like; may include a particular interaction sent to and/or received from the device, involving the on-device applet, application, and/or the like, where the interaction may or may not be performed by or via the user's input/interaction.

If the answer back at query 350 is “No,” then the process proceeds to a query 354, which asks “Sufficient?” Here, for example, the U-PAS/UPAM (depending on the circumstances and what query the process previously passed from) would preferably determine if the query result (e.g. interaction, modification, payment, resolution, etc.) was “sufficient,” per a predefined/established set of conditions, thresholds, rules and/or the like.

If the answer back at 350 is instead “yes,” then the process proceeds to a query 351, which asks if “Plan [was] Modified?” If the answer to query 351 is “yes” then the process proceeds to query 354. If the answer to query 351 is instead “No,” then the process proceeds to a query 352, which asks “Payment Made?” From query 352, If the answer to query 352 is “yes” then the process proceeds to query 354. If the answer to query 352 is instead “No,” then the process proceeds to a query 353, which asks “Other Resolution?”

If the answer to query 353 is “yes” then the process proceeds to a query 354. If the answer to query 354 is “yes,” the process then proceeds to a step 358, where an “Update SORT Accordingly is Performed.” If the answer to query 354 is instead “No,” then the process proceeds to a query 355, which asks “Account Terminated by PO or MNO?”

If the answer to query 355 is “By PO” then the process proceeds to step 358. If the answer to query 355 is “MNO” then the process proceeds to step 358. If the answer to query 355 is instead “NO” then the process proceeds to a query 356, which asks “Account Suspended By PO Or MNO?” From query 356, If the answer to query 356 is “By PO” then the process proceeds to step 358. If the answer to query 356 is “MNO” then the process proceeds to a step 358. If the answer to query 356 is instead “NO” then the process proceeds to a query 357, which asks “Terminate, Suspend, Inject, Throttle, Route, Cap, VBR, Or Other?”

If the answer to query 357 is “NO” then the process proceeds to step 358. If the answer to query 357 is “Terminate,” then appropriate terminate function is performed before proceeding to the step 358. If the answer to query 357 is “Suspend,” then appropriate suspend function is performed before proceeding to the step 358. If the answer to query 357 is “Inject,” then appropriate inject function is performed before proceeding to the step 358.

If the answer to query 357 is “Throttle,” then appropriate throttle function is performed before proceeding to the step 358 (explained further herein). If the answer to query 357 is “Route,” then appropriate route function is performed before proceeding to the step 358 (also see FIGS. 4a/b). If the answer to query 357 is “Cap,” then appropriate cap function is performed before proceeding to the step 358. For example, a Cap could be set utilizing particular threshold or ceiling for, say data usage within a given time period, event, location, per content type, user, usage pattern (e.g. via WiFi), device, OS, and/or the like. If the answer to query 357 is “VBR,” then appropriate VBR (Variable Bit-Rate) function is performed before proceeding to the step 358. If the answer to query 357 is “Other,” then appropriate other function is performed before proceeding to the step 358. From step 358 the process ends where a terminator 359 “Create New DOPE iteration UID” is executed.

In various non-limiting embodiments, the queries above 357 provide functionality and/or the ability for the PO or the MNO to also interact/participate with the resolution/remedy, pay/collect, suspend, terminate, and/or the like, whereas query 357 would preferably a central decision point, say a collective or end decision point. In various non-limiting embodiments, the this end/collective/central decision point would preferably be controlled by the U-PAS 50 (&/or IN-U-PAS 51 &/or UPAM 53), but could be in concert with a particular MNO, PO, plurality of MNOs, POs, users, and/or forwarded to the particular MNO, PO, plurality of MNOs, POs, users and/or the like, say during/after terminator 359.

FIG. 13a is an embodiment of an example screenshot of a graphical user-interface for mobile monitoring and alerts. Starting with a title header with a “Mobile Monitor & Alert Setup” 400, followed by an “Overage Options” 401 function (see FIG. 13b), a “Details” 402 function, an “Acknowledge Alert” 403 function, a “Data Usage” 404 drop down menu, a “Time Period” 405 drop down menu, a “Current Plan” 406 drop down menu, a Billing Cycle 407 drop down menu, an “As of Time Indicator” 408 drop down menu.

Next, a variety of Threshold options D-A, starting with a “Threshold D” 409 drop down menu, where the current input is depicted as “110% Auto Upgrade” and where such a setting would preferably include setting and conditions to automatically upgrade a particular user account when his/her consumption surpasses the 110% preset threshold selected under Threshold D 409. Next, is a “Threshold C” 410 drop down menu where the current input is depicted as “100% Pop-Up Alert” and where such a setting would preferably include setting and conditions to automatically alert the particular user account with a specific and/or conditional pop-up alert/message when his/her consumption surpasses the 100% preset threshold selected under Threshold C 410.

Next, is a “Threshold B” 411 drop down menu where the current input is depicted as “90% Pop-Up Alert” and where such a setting would preferably include setting and conditions to automatically alert the particular user account with say the same Pop-Up Alert as Threshold C or another specific and/or conditional pop-up alert/message when his/her consumption surpasses the 90% preset threshold selected under Threshold B 411.

Next, is a “Threshold A” 412 drop down menu where the current input is depicted as “80% SMS Me” and where such a setting would preferably include setting and conditions to automatically send the particular user an SMS with a specific and/or conditional SMS alert/message when his/her consumption surpasses the 80% preset threshold selected under Threshold A 412. Alerts can be set as conditional based upon time, location, devices, OS, applications in use, packet parameters, data consumed historically, events, and/or the like.

Next, a variety of Preferred Alert Methods can be selected and/or prioritized starting with a first 413 preferred alert method 413, where the current input is depicted as “1-Pop-Up, if Online” selected via the drop down menu, where the particular user has indicated an alert method preference (e.g. for communication interaction between service provider and user) for Pop-Up messages if a threshold is surpassed while Online.

Next, is a second preferred alert method 414, where the current input is depicted as “2-SMS, On/Offline” selected via the drop down menu, where the particular user has indicated an alert method preference for SMS messages whether online or offline when sending the SMS. For example, when the particular user is closing or hibernating his/her laptop in the middle of a download session, streaming video, cloud session, and/or the like. Next, is a third preferred alert method 415, where the current input is depicted as “3-AAM, if Offline” has been selected via the drop down menu, and where the particular user has indicated an alert method preference for the AAM when offline. For example, when the particular user wishes to be alerted via the Actionable Audio Message (AAM-also see described earlier/herein) during the call setup time at the start of his/her next cellular phone call, where the alert is conditionally generated and suitable, and where the alert is still appropriate (e.g. as the overage is still unresolved).

Next, is a “Throttling” 416 drop down menu, where the current input is depicted as “Notify & may okay.” Here, the particular user has indicated a request to be notified should a potential or actual overage occur (e.g. via threshold) and where an allowable remedy is throttling and where the particular user has indicated a potential willingness to approve (e.g. Okay) the throttling remedy, say temporally, conditionally, and/or the like.

Next, is a “Prefer Not To Get” section for listing communication methods that the particular user would prefer not be utilized at all, conditionally, and/or the like. Here, the particular user has listed “Voicemail” via a drop down menu 417 and “Direct Mail” via a drop down menu 418 as two methods in particular that he/she would prefer not be utilized by the service provider, and/or conditionally, as other methods are attempted, exhausted, as-a-last-resort and/or the like.

Moving to the top-left side of the screenshot, there is a “Notify Me At Each Threshold” 419 check box and drop down, where the particular user would preferably indicate his/her desire to be notified or not per each threshold in sections 409-412. Next, is a “Notify Me When Roaming” 420 check box and drop down, where the particular user would preferably indicate his/her desire to be notified or not when roaming. Next, is an “Allow/Notify Content Options” 421 check box and drop down (also see FIG. 13c), where the particular user would preferably indicate his/her desire to allow and/or notify the particular with content options. For example, an ability to conditionally reduce the bit-rate, bandwidth, data consumptions, and/or the like for a particular piece of content, event, and/or the like.

Next, is an “Allow Built-In Alerts” 422 check box and drop down, where the particular user would preferably indicate his/her desire to allow alerts to appear that are built-into, say content, applications, software, applets, and/or the like. For example, while watching a movie (see FIGS. 15a/b-16a/b).

Next, is an “Allow Overages w/o Upgrading” 423 check box and drop down, where the particular user would preferably indicate his/her desire to allow overages without upgrading, say conditionally, where he/she could set limits to the data overage threshold limit, dollar overage threshold limits, and/or the like. For example, while watching a movie when there is less than ten minutes left, within 5 days of the end of my billing cycle, and where the overage would not exceed $15.

Below the checkboxes depicted is a visual indicator for the amount of data consumed by the particular user where there is an “As of 3:44 pm” 424 time indicator to reflect the last time the data was updated, along with indicators for the thresholds A-D, a “Plot Point/Node” 425 to reflect the particular user's current consumption, and an “Area of Consumption” 426 depicted by the gray area.

FIG. 13b is an example embodiment of an Overage Options of the graphical user-interface for mobile monitoring and alerts in FIG. 13a. Starting with an Overage Options 430 title header, followed by a list of options, starting with an “Upgrade” 431 option, a “Buy Overage Insurance (*see terms)” 432 option, a “Throttle, when roaming” 433 option, a “Throttle when at Threshold B” 434 option, a “Suspend, when Roaming & at B” 435 option, a—“Suspend, when at Threshold C” 436 option, “Auto Upgrade at Threshold D” 437 option, and a “Terminate” 438 option.

In various non-limiting embodiments, the “Upgrade” 431 option would preferably allow the particular user to setup a set of conditions and rules, whereby his/her account would automatically, systematically, conditionally, and/or user-selectively upgrade his/her account per overage, per event, per location, per time window, per content, per threshold, per user, per device, per contract, per OS, per application, and/or the like.

In various non-limiting embodiments, the “Buy Overage Insurance (*see terms)” 432 option would preferably allow the particular user to setup a set of conditions and rules, whereby his/her account would automatically, systematically, conditionally, and/or user-selectively pre-purchase overage insurance for his/her account prior to an overage incident, particular event, entering a particular location, prior to a particular time window, prior to downloading and/or consuming a particular content, prior to a particular threshold, per user, per device, per contract, per OS, per application, and/or the like.

In various non-limiting embodiments, the “Throttle, when roaming” 433 option would preferably allow the particular user to setup a set of conditions and rules, whereby his/her account would automatically, systematically, conditionally, and/or user-selectively throttle his/her account per overage, per event, per location, per time window, per content, per threshold, per user, per device, per contract, per OS, per application, and/or the like. In various non-limiting embodiments, the “Throttle when at Threshold B” 434 option would preferably allow the particular user to setup a set of conditions and rules, whereby his/her account would automatically, systematically, conditionally, and/or user-selectively throttle his/her account at threshold B, depending on the overage, event, location, time window, content, user, device, contract, OS, application, and/or the like.

In various non-limiting embodiments, the “Suspend, when Roaming & at B” 435 option would preferably allow the particular user to setup a set of conditions and rules, whereby his/her account would automatically, systematically, conditionally, and/or user-selectively suspend his/her account when roaming and at threshold B, depending on the overage, event, location, time window, content, user, device, contract, OS, application, and/or the like. In various non-limiting embodiments, the “Suspend, when at Threshold C” 436 option would preferably allow the particular user to setup a set of conditions and rules, whereby his/her account would automatically, systematically, conditionally, and/or user-selectively suspend his/her account at threshold C, depending on the overage, event, location, time window, content, user, device, contract, OS, application, and/or the like.

In various non-limiting embodiments, the “Auto Upgrade at Threshold D” 437 option would preferably allow the particular user to setup a set of conditions and rules, whereby his/her account would automatically, systematically, conditionally, and/or user-selectively upgrade his/her account at threshold D, depending on the overage, event, location, time window, content, user, device, contract, OS, application, and/or the like. In various non-limiting embodiments, the “Terminate” 438 option would preferably allow the particular user to setup a set of conditions and rules, whereby his/her account would automatically, systematically, conditionally, and/or user-selectively terminate his/her service and/or account, depending on the threshold, overage, event, location, time window, content, user, device, contract, OS, application, and/or the like.

FIG. 13c is an example embodiment of a Content Options of the graphical user-interface for mobile monitoring and alerts in FIG. 13a. Starting with a “Content Options” 440 title header followed by a content indicator 441 where the example depicts “You Are Currently at 80% Streaming The Movie ‘Alien’ at High Resolution from the url: www.mymovies.com,” followed by a list of user options 442-446. Starting with a “Continue at High Res. &Alert at Next Threshold” 442 option, where the particular user would preferably indicate his/her desire to continue at high resolution and alert him/her at the next threshold, or select another option, such as a “Continue, but drop to Stand. Def. at Next Threshold” 434 option, a “Drop to Standard Definition Now” 444 option, a “Try our www.ourmovies.com & get movie for free” 445 option, or a “Signup for www.ourmovies.com & get 5+ gbs/mth” 446 option.

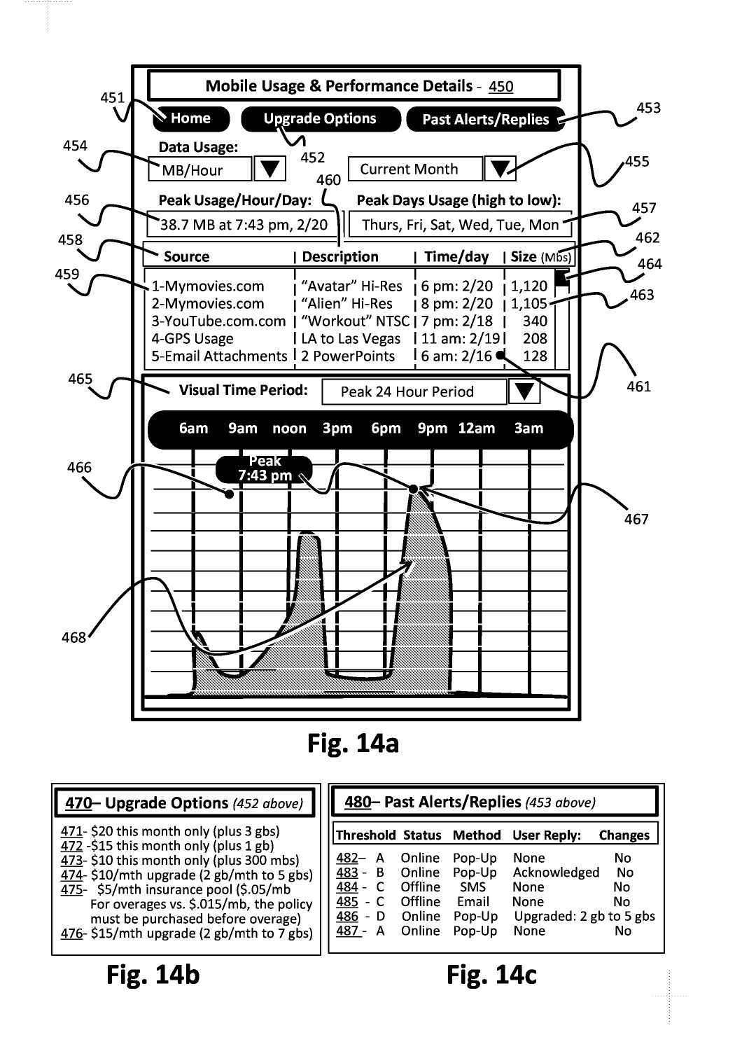

FIG. 14a is an embodiment of an example screenshot of a graphical user-interface for mobile monitoring usage and performance details. Starting with a title header 450 stating a “Mobile Usage & Performance Details” screen/screenshot, where below there is a “Home” 451 button/function, along with an “Upgrade Options” 452 button/function (see FIG. 14b), and a “Past Alerts/Replies” 453 button/function (see FIG. 14c). Below is a “Data Usage” 455 drop down menu in this example depicting “mb/hour,” and where the user would preferably select data usage context/format/units and/or the like to view below. Next, a “Time Period” 456 drop down menu is where the user would preferably select a time window/date/event and/or the like. In this example, depicted as “current month” where the system would retrieve the appropriate data to display.

Below, is a “Peak Usage/Hour/Day” field where the example depicts has “38.7 MB at 7:43 pm, 2/20,” where the user may retrieve and review his/her historical peak usage with the hour and date per the “time period” selected with drop down 455. Next, a “Peak Usage/Hour/Day” 456 field is depicted with a “38.7 MB at 7:43, 2/20,” example. Followed by a Peak Days Usage (High to Low)” 457 field which has a “Thurs, Fri, Sat, Wed, Tue, Mon” depicted in the example.

Below is a data table starting with a “Source” 458 column header, where a list of content sources is listed below starting with a “1-Mymovies.com” 459 item/row. The next header is for a “Description” 460 column header where there is a list of descriptions for the source content, such as a movie name and format. The next header is a “Time/Day” header, where there is a list of consumption times, and where a data pointer 461 depicts an example with “6 am: 2/16,” as the time/day the content was consumed. Next, a “Size (Mbs) (per 454 drop down)” 462 column header is followed by the appropriate list of data amounts, here depicted as a “1,105 [mbs]” by indicator line 463 in row two, and last a thumb 464 allows the user to scroll down beyond the five items currently listed.

The lower half of the GUI screenshot depicts a graphical histogram with a Visual Time Period 465 drop down menu depicted here with “Peak 24 hour Period.” Below is are time indicators across the top of graphical histogram starting with a “6 am to 3 am.” A visual time indicator 466 for the time the actual data peak occurred and depicted here as a “Peak [at] 7:43 pm,” where an arrowhead 467 points to the particular visual peak/point in time along the histogram graphic. An arrow 468 points to the user's consumption depicted by the gray area.

FIG. 14b is an example embodiment of an Upgrade Options of the graphical user-interface for mobile monitoring usage and performance details in FIG. 14a. Starting with an “Upgrade Options (452 above) “470 title header followed by a list of option, here starting with an option 471, where the example depicts an”$20 this month only (plus 3 gbs)” option. Here the user would preferably find and select an upgrade option from the list of options, further including an option 472 depicted with an “$15 this month only (plus 1 gb)” option, a 473 option depicted with a “$10 this month only (plus 300 mbs)” option, an option 474 depicted with a “$10/mth upgrade (2 gb/mth to 5 gbs)” option, a 475 option depicted with a “$5/mth insurance pool ($0.05/mb for overages vs. $0.015/mb, [where] the policy must be purchased before [the] overage)” option, and an option 476 depicted with a “$15/mth upgrade (2 gb/mth to 7 gbs” option.

FIG. 14c is an embodiment of a Past Alerts/Replies of the graphical user-interface for mobile monitoring usage and performance details in FIG. 14a. Starting with a “Past Alerts/Replies (453 above)” 480 title header followed by a table with a list of headers: Threshold/Status/Method/User Reply: Changes. The first row 482 is depicted with an example where an “A/Online/Pop-Up/None: No,” where each is aligned with column headers of: Threshold/Status/Method/User Reply: Changes above. The first row 482, is followed by a second row 483 depicted with a “B/Online/Pop-Up/Acknowledged: No” row, followed by a third row 484 depicted with a “C/Offline/SMS/None: No” row, followed by a forth row 485 depicted with a “C/Offline/Email/None: No” row, followed by a fifth row 486 depicted with a “D/Online/Pop-Up/Upgraded: 2 gb to 5 gbs” row, and followed by a last and sixth row 487 depicted by an “A/Online/Pop-Up/None: No” 487 row.

The first row 482 reflects that the user did not acknowledge the Pop-up prompted at Threshold A, whereas the second row 483 reflects that the user did acknowledge the Pop-up at Threshold B. The third row 484 reflects the user was sent an SMS at threshold C and was considered offline at the time and did not acknowledge receipt of the SMS, where this may or may not include a method to verify that the SMS was delivered, viewed, and/or the like. The fourth row 485 reflects the user was also sent an email at threshold C and was considered offline at the time and here too did not acknowledge receipt of the email, where this email notification may or may not include a method to verify that the email was delivered, viewed, and/or the like.

The fifth row 486 reflects the user was considered online at threshold D, where a Pop-Up was delivered and the upgraded from a 2 gb/month data plan to a 5 gb/month data plan. Here, for example, the upgrade could be per event, per window of time (e.g. minutes, hour, day, month, year), per content, per application, per device, per user, per plan, per family, per company, and/or the like. Last, the sixth row 487 reflects the user was considered online at threshold A, where a Pop-Up was delivered, but the “User Reply” was “None” and thus “No” “Charges” were associated, applied, and/or approved by the user.

FIG. 15a is an embodiment of an example screenshot of a graphical user-interface for a data usage alert prompted by a threshold with Upgrade Options. As depicted in FIG. 15a, there is a screenshot 489 on a computer 63 with a pop-up alert displayed with a “Data Usage Alert” 490 message title stating to the user “You're At 80% of Month Plan” with an “Overage Options” 491 button/function and an “Or Click ‘x’ to ignore/okay” 492 check box. Here, in this example, the system can be set to freeze the screen per the screenshot 489, black the screen out, replace with a placeholder (e.g. info, ad, options, etc.) and/or allow the video to continue to play, say in a smaller window (not shown) where the decision to allow the continual video play in the background may, among other conditions, be threshold dependent.

In various non-limiting embodiments, the pop-up alert displayed would preferably be triggered by a threshold set automatically, systematically, conditionally, and/or incorporate user-selections, where the “Data Usage Alert” 490 message title could be depict a range of titles appropriate for the alert and the options either from the Applet 43, UPAM 53, IN-U-PAS 51, U-PAS 50, and/or the like. In various non-limiting embodiments, the “Overage Options” 491 button/function would preferably be relative to the options dynamically selected by the UPAM 53 (on device via the Applet 43 or via the network connect), say per the conditions, contract, content, and/or the like, as well as the user, his/her DOPE, PAST, TONE, POPS, budget, bids, and/or the like. The “Or Click ‘x’ to ignore/okay” allows the system to collect a user acknowledgement and/or approval for potentially going over data plan and/or incurring any overage charges (per user plan, preset conditions, rules, thresholds, and/or the like).

FIG. 15b is an embodiment of an example screenshot of a graphical user-interface for the Upgrade Options for the data usage alert in FIG. 15a. As depicted in FIG. 15b, there is the screenshot 489 on the computer 63 display after the user has clicked the “Upgrade Options” 491 button/function above in FIG. 15a. Here, in this example, an “Upgrade Options (click options for details) 470a title appears at the top of the pop-up window with a list of options selectable via radio buttons. For example, a 493 radio button option allows the user to click and select an upgrade with a “20 this month only (plus 3 gbs)” upgrade option over the remaining upgrade options or to click a checkbox 494 at the bottom where it has “Or Click ‘x’ to ignore and okay incurring any overage charges at: $0.015/mb.” The 494 checkbox for “Or Click ‘x’ to ignore and okay incurring any overage charges at: $0.015/mb” in this example, allows the system to collect a user acknowledgement and/or approval for potentially incurring the overage charges and at, say a particular rate.

FIG. 16a is an embodiment of an example screenshot of a graphical user-interface for the data usage alert prompted by the threshold with the Overage Options. As depicted in FIG. 16a, there is a screenshot 489 on a computer 63 with a pop-up alert displayed with a “Data Usage Alert” 495 message title stating to the user “You're At 100% of Month Plan” with an “Overage Options” 496 button/function and an “Or Click ‘x’ to ignore/okay” 492 check box. Here again, in this example, the system can be set to freeze the screen per the screenshot 489, black the screen out, replace with a placeholder (e.g. info, ad, options, etc.) and/or allow the video to continue to play, say in a smaller window (not shown), where the decision to allow the continual video play in the background may, among other conditions, be threshold dependent.

In various non-limiting embodiments, the pop-up alert displayed would preferably be triggered by a threshold set automatically, systematically, conditionally, and/or incorporate user-selections, where the “Data Usage Alert” 495 message title could be depict a range of titles appropriate for the alert and the options either from the Applet 43, UPAM 53, IN-U-PAS 51, U-PAS 50, and/or the like. In various non-limiting embodiments, the “Overage Options” 496 button/function would preferably be relative to the options dynamically selected by the UPAM 53, say per the conditions, contract, content, and/or the like, as well as the user, his/her DOPE, PAST, TONE, POPS, budget, bids, and/or the like. In various non-limiting embodiments, the “Or Click ‘x’ to ignore/okay” allows the system to collect a user acknowledgement and/or approval for incurring any overage charges.

FIG. 16b is an embodiment of an example screenshot of a graphical user-interface for the Overage Options for the data usage alert in FIG. 16a. As depicted in FIG. 16b, there is the screenshot 489 on the computer 63 display after the user has clicked the “Overage Options” 496 button/function above in FIG. 16a. Here, in this example, an “Overage Options (click options for details) 430 title appears at the top of the pop-up window with a list of options selectable via radio buttons. For example, a 497 radio button option allows the user to click and select this “Upgrade” option over the remaining option or to click a checkbox at the bottom where it has a checkbox 498 with the associated text of “Or Click ‘x’ to ignore and okay incurring any overage charges at: $0.015/mb.” The 498 checkbox for “Or Click ‘x’ to ignore and okay incurring any overage charges at: $0.015/mb” in this example, allows the system to collect a user acknowledgement and/or approval for incurring the overage charges and rate.

The described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure. Therefore, one having ordinary skill in the art will readily understand that the disclosure as discussed above may be practiced with steps in a different order, may be practiced with hardware elements in configurations which are different than those which are disclosed, and that embodiments may be combined in any appropriate manner.

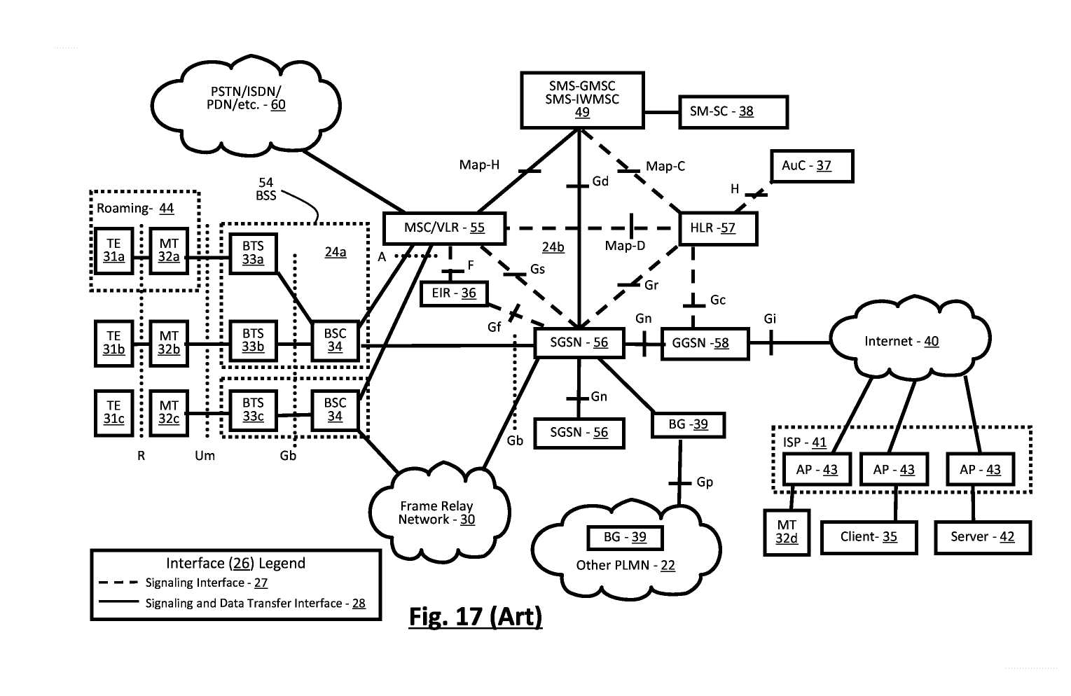

FIG. 17 is a block diagram depicting an embodiment of a typical GPRS/UMTS mobile network. U.S. Pat. No. 7,466,652 B2 to Lau et al. entitled “Auto-IP Traffic Optimization in Mobile Telecommunications Systems” is hereby incorporated by reference in its entirety for all purposes, where the abstract mentions an implementation of fine-grained quality of service in a mobile telecommunications environment uses an Auto-IP Policy Decision Point (PDP) to determine what traffic optimizations actions should be taken in reaction to various network conditions.

The Lau et al. patent, describes the capturing and analyzing of incoming packets, where cell-specific traffic and resource information collected by the Auto-IP PDP, where various optimizations are describe as being applied at the Auto-IP Traffic Optimizer to help manage the resources in each cell of a cellular network. Lau et al describes customer and service differentiation which required identification of a user or a set of users, and/or the services subscribed, where the service differentiation is then provided with respect to quality of service guarantee, access priority, or charging or credit incentives. To identify the user(s) in the mobile context, Lau et al employs a set of common attributes as listed in Table seven of the Lau et al patent, which methods are hereby incorporated in various non-limiting embodiments.

Lau et al, goes on describe policies and user-location mappings that are input into the Auto-IP Traffic Optimizer by the Auto-IP PDP, where the Policies and mappings first arrive at a filter management module that interprets the policy and controls traffic filter. Further, where the IP packets of voice and data can arrive from a server and get separated based on the IP addresses and port numbers by a traffic filter are also hereby incorporated in various non-limiting embodiment.

Continuing with the Lau et al. patent, is a description of traffic shaping where the system can limit the bandwidth allocated to a particular traffic stream or class of traffic. Per Lau et al., the Auto-IP PDP must configure the traffic shaping based on the total capacity of the cell and on the quantities of each class of traffic put into the network. Besides other limitations/differences, the Lau et al patent discloses cell-specific optimization for, say, congestion avoidance so that the maximum bandwidth is reached sooner at the beginning of a TCP session or after a packet has been lost.

Whereas, the present disclosure, among other things/differences, presents methods to specifically monitor data traffic, content and application usage relative to a particular user, and/or segment of users, and address contract obligations and related performance issues via a series of tracked interactions and resolutions steps. Where, for example, the U-PAS 50/UPAM 53 can invoke methods to interact directly with the user, the device, and/or the on-device applet, applications, and/or the like, regarding a potential, perceived, anticipated, and/or actual overage.

Turning back to the FIGS: FIG. 18 is a block diagram depicting an embodiment of the NCS 20 as presented. In various non-limiting embodiments, the NCS 20 may comprise any network (e.g. Mobile, LAN/WAN, WLAN, MAN, Internet, Intranet, and/or the like) depicted here as the Mobile Network 24 (e.g. 24a, 24b); operationally connected to a Public Switched Telephone Network (PSTN), Integrated Services Digital Network (ISDN), Public Data Network (PDN), etc. (PSTN/ISDN/PDN/Etc.) 60; the U-PAS 50, the internet 40, Other Public Mobile Network (PLMN) 22, Frame Relay Network 30, and/or the like; where each may be operatively connected to each other and/or a variety of computer clients, communication devices, servers, storage, devices, peripherals, and/or the like.

In various non-limiting embodiments, the U-PAS 50 (e.g. depicted as an U-PAS 50a and an U-PAS 50b) would preferably reside outside the mobile network 24, where the U-PAS 50 is operationally connected to the mobile network 24 via the communication link that allows for packet traffic, monitoring, and analysis. In an embodiment, the IN-U-PAS 51 (e.g. depicted as the IN-U-PAS 50a and the IN-U-PAS 51b) would preferably operate similarly to the U-PAS 50, but would preferably reside inside the mobile network 24. In various non-limiting embodiments, the IN-U-PAS 51 is operationally connected to the mobile network 24 via the communication link that allows for packet traffic, monitoring, and analysis. In various non-limiting embodiments, the IN-U-PAS 51 may also operationally connect to the U-PAS 50 outside the mobile network 24, where both the IN-U-PAS 51 and the U-PAS 50 are operationally connected to the mobile network 24 via the communication link that allows for packet traffic, monitoring, and analysis.

In an embodiment, each operational connection, communication link, protocol, and/or the like, inside the NCS 20 may be any type appropriate and/or suitable for a functioning network protocol, connection, communication link and/or the like, such as a Transmission Control Protocol (TCP connection, a Transmission Control Protocol/Internet Protocol (TCP/IP) connection a User Datagram Protocol (UDP), a User Datagram Protocol/Internet Protocol (UDP/IP), a hypertext transfer protocol (HTTP) and/or the like. In various non-limiting embodiments, the network connection and communication link/protocol may also incorporate and/or comprise a Signal System Number 7 (SS7) network with a Voice Trunk Connection (SS7/VTC), an IP Multimedia Subsystem (IMS) or other Long Term Evolution (LTE) communication protocols, communication links, connections, and/or the like.

In an embodiment, there is the at least one MNO 25, which is preferably operationally connected to the at least one U-PAS 50 (and/or IN-U-PAS 51). In an embodiment, there may be a plurality of MNO 25 operationally interconnected to the at least one U-PAS 50 (and/or IN-U-PAS 51). In an embodiment, each reference to the U-PAS 50 implies a variety of alternatives, where a first alternative is the at least one U-PAS 50 is operationally connected to an at least one IN-U-PAS 51, a second alternative of where the at least one IN-U-PAS 51 is operationally replaced by the at least one U-PAS 50, a third alternative allows for a plurality of U-PASs 50 and/or a plurality of IN-U-PASs 51; a fourth alternative allows for some combination of these variations; a fifth alternative allows for some permutation of these variations/alternatives; and/or the like.

In various non-limiting embodiments, the MNO 25 may incorporate traditional equipment and means for communication and data exchange comprising cell towers which allow calling parties to operationally connect via radio-telecommunications links and where the cell tower is operationally connected to a mobile switching center (MSC) over multi-frequency (MF) trunk. In various non-limiting embodiments, the MSC includes a plurality of loop-back trunks, where the loop-back trunk has an outbound side and an inbound side with respect to the MSC.

U.S. Pat. No. 5,396,543 to Beeson, Jr. et al. entitled “Signaling arrangements in a cellular mobile telecommunications switching system” is hereby incorporated by reference in its entirety for all purposes, where the abstract states: Apparatus and methods for providing cellular mobile telecommunication service in accordance with the requirements of the Global Systems for Mobile Communications (GSM) standard. A modular switching system is provided which performs the functions of the mobile switching center plus those of [the] home location register, authentication center, visitor location register, and equipment identity register. The latter functions are advantageously spread among the modules of the switching system, thus avoiding the getting started cost of expensive dedicated data bases. A wireless global switching module advantageously switches mobile communications control messages among the modules of the system and between the modules and the base station systems, and terminates signaling links between the mobile switching center and the base station systems.

U.S. Pat. No. 5,459,727 to Vannucci entitled “Wireless Telecommunication System” is hereby incorporated by reference in its entirety for all purposes, where the abstract mentions its purpose to divide coverage areas, improve communication paths, and reduce distortion.

U.S. Pat. No. 4,124,773 to Elkins entitled “Audio storage and distribution system” is hereby incorporated by reference in its entirety for all purposes, where the abstract mentions an electronic system and method for storing and distributing audio signals over existing communication lines.

U.S. Pat. No. 5,101,501 to Gilhousen et al. entitled “Method and system for providing a soft handoff in communications in a CDMA Cellular Telephone System” is hereby incorporated by reference in its entirety for all purposes, where the abstract states: In a cellular telephone system a system for directing communications between a mobile user and cell-sites as a mobile user changes cell-site service areas. The mobile user includes an apparatus for, while in communication with another system user via one cell-site, determining a transition of the mobile user from the cell-site service area to the service area of another cell-site. The system includes circuitry responsive to the indication for coupling communications between the mobile user and the other system user via the new cell-site while the mobile user also remains in communication with the system user via the first cell-site. The system further includes apparatus responsive to the coupling of the communications between the mobile user and the other system user via the new cell-site for terminating the communications between the mobile user and another system user via cell-site with communications continuing between the mobile user and the system user via the new cell-site.

Turning back to the present disclosure, where in various non-limiting embodiments, the Public Switched Telephone Network 60a may also operationally communication and exchange data with the U-PAS 50 and allows communications and data exchange with typically Wired-line clients 111; and/or the like. There may be a plurality of PSTN 60a independently connected (not shown). In various non-limiting embodiments, the PSTN 60a may incorporate traditional equipment and means for communication and data exchange.

In various non-limiting embodiments, the U-PAS 50 may communication with the MNO 25 from, in one embodiment, outside the network via any communication connection via the SS7NTC and/or the TCP/IP connection. In various non-limiting embodiments, the U-PAS 50 is typically also operatively connected to the Internet 40 and/or the Network 300 where each may allow for a variety of computer client (e.g. communication device) and server two-way communications, such as the VOIP Client 66, the Mobile Device 61, the Desktop Computer 67, the Server 42 and/or the like. In various non-limiting embodiments, the U-PAS 50 is typically also operatively connected to a storage (e.g. an electronic database). In various non-limiting embodiments, the storage may incorporate and/or comprise a plurality of hardware devices, virtual hardware, software, and methodologies, including stand-alone hardware, the storage through the Internet 40 and/or the Network 300, storage interconnected via other computers/devices such as storage in the cloud, and/or the like.

In various non-limiting embodiments, the software inventory, along with, application, video, data, audio, packets 44, and/or the like for the mobile device 61 are received from a cloud service. For example, a cloud-based platform could provide a global app cache (e.g., the U-PAS 50 could service a plurality of enterprise app stores), including a cache designated for caching results for previously analyzed packets. In various non-limiting embodiments, the cloud-based platform can be in communication with a series of data collection engines, including: a disassembly engine, a decompilation engine, an instrumented emulation engine, a URL and IP reputation engine, a malware detection engine, and a behavior-based analysis engine. For example, the platform can include various engines, not all shown, for performing various functions and collecting various data based on the functions, which can be later used for risk assessment, likelihood of overage assessment, and potential offender/PAST assessments and/or analysis, as well as, shared with one or more of the various other engines, modules, databases, criteria, sources, and/or the like; such as described herein with respect to various embodiments.

FIG. 19 is a structural diagram depicting an embodiment of the NCS 20, where there are a variety of interconnected communication networks. In various non-limiting embodiments, the NCS 20 may comprise a “Subscriber's Mobile Network” 500, a “Mobile Network A” 501, a “Mobile Network B” 502, a “Network C” 503, a “Network D” 504, a “Peering Point(s)” 505a, the Internet 40, and the U-PAS 50. In various non-limiting embodiments, the potential offender 46 is a particular mobile subscriber of the “Subscriber's Mobile Network. In various non-limiting embodiments, the potential offender 46 (e.g. the mobile subscriber/device) would preferably have his/her/its transmitted data packets (e.g. sent and/or received) monitored by the IN-U-PAS 51 and/or a Probe 69 (e.g. 69a, 69b, 69c, 69d, 69e, 69f, 69g, and 69h), where the Probes 69 (e.g. 69a-h) would preferably be operationally connected to the IN-U-PAS 51 and/or the U-PAS 50 for packet monitoring, analyzing, and managing.

In various non-limiting embodiment, the Peering Point 505a broadly refers to a place where many networks interconnect together to exchange traffic on a peering basis—that is a place where many networks peer. For example, the Peering Point 505a would preferably allow the network to peer with many other networks but only endure the expense of a connection to one place. Peering and peering points can reduce the number of networks that data must traverse to get to its destination and therefore improve the speed and reliability of the Internet (or applicable network). If geographically close networks peer, then data can travel a short path no matter what the configuration of transit provider's networks may be (see: http://www.ugh.net.au/˜andrew/peering/explanation.html, hereby referenced in its entirety). In various non-limiting embodiment of present disclosure, the Peering Point 505a may or may not be necessary or utilized.

In various non-limiting embodiment of the present disclosure the mobile device 61 would preferably be allowed to roam across different networks, network types, and/or boundaries, such as roaming across countries. For example, as is depicted in FIG. 19, where the structural diagram of five network entities: with three (3) depicted here as mobile phone networks (e.g. Subscriber's mobile network, Mobile Network A, and Mobile Network B) and two (2) depicted here as other networks (C & D) according to an embodiment. In various non-limiting embodiments, the network entity referred to as a mobile subscriber's home network, is also referred to here as the “Subscriber's Mobile Network” 500, which comprises: the Base Station Controller (BSC) 34s, the Base Transceiver Station (BTS) 33s, the Mobile Terminated (MT) 32s, the Terminal Equipment (TE) 31s, a Mobile Switching Center/Visiting Location Register (MSC/VLR) 55s, the SGSN 56, GGSN 58, the HLR 57s, and the IN-U-PAS 51 wherein various non-limiting embodiment, would preferably include the functionality of a Roaming Number Manager (e.g. herein the IN-U-PAS 51) per U.S. Pat. No. 7,613,454 B2 by Zhang entitled “Network and Method of Realizing Local Roaming for Subscribers” which is hereby incorporated in its entirety by reference.

Zhang's abstract mentions a network for implementing localized roaming of mobile subscribers includes: a base transceiver station, a base station controller, the MSC, a Visiting Location Register (VLR) and the Home Location Register (HLR), and a Roaming Number Manager (RNM); wherein the RNM, connected with the HLR in the home network and the MSC/VLR in a contracted roaming network, and manages mobile phone/device numbers in the home network and local mobile phone/device numbers in the contracted roaming network, takes collection of a locally-assigned-numbers in the contracted roaming network as a resource pool, and allocates the mobile phone/device numbers in the contracted roaming network to subscribers roaming in the contracted roaming network dynamically through the MSC/VLR in the contracted roaming network.”

In various non-limiting embodiment, the implementation and functionality of the RNM is physically based and/or fully operational from, to, and/or inside each network (not depicted, e.g. each Mobile Network, Internet, Network). In various non-limiting embodiment, the implementation and functionality of the RNM is based and fully operational from the U-PAS 50 and/or the IN-U-PAS 51.

A “localized roaming” refers to a particular system and method where the subscriber's mobile device 61 (e.g. mobile phone) is in a roaming state and obtains a locally-assigned-number in the roaming region, and can initiate calls or answer calls with the locally-assigned-number, where the subscriber would preferably be able to utilize network resource in the roaming region as if local and enjoy localized services or localized-like roaming service. Similar to a local subscriber in the roaming region, and thus avoiding unnecessary voice path detour and reducing communication cost in the roaming state.

In various non-limiting embodiment, the implementation of localized roaming of mobile phones/devices according to the network provided by the present disclosure, a mobile phone/device (e.g. subscriber) when roaming is automatically allocated with the locally-assigned-number in the roaming region by the device's/user's home network, where the roaming region is a contracted roaming region (which is reached by, say some agreement with the home operator). In various non-limiting embodiment, when the subscriber leaves a contracted roaming region, a home network releases the temporary number (e.g. the locally-assigned-number) used by the subscriber. In the contracted roaming region, the subscriber uses the locally-assigned-number to initiate calls or answer calls and enjoy localized roaming service or localized-like roaming service. For example, when the subscriber is roaming in a particular roaming network, the subscriber would not have to pay the typical roaming charges associated with international toll calls when he/she answers calls; thus the communication cost in the roaming state could be reduced.

In various non-limiting embodiments, the IN-U-PAS is connected with the HLR 57s; the IN-U-PAS 51 is a network entity, which may be utilized to manage mobile phone/device numbers in the contracted roaming network; the IN-U-PAS 51 can take the collection of obtained mobile phone/device numbers (similar to Zhang's RNM, here part of the UPAM) in the contracted roaming network as a resource pool, and allocates the mobile phone/device numbers in the contracted roaming network to roaming subscribers dynamically; furthermore, IN-U-PAS 51 is also used to: one, store mobile phone/device numbers in the contracted roaming network; two, determine the current default phone number of the subscriber. In various non-limiting embodiment, when the subscriber roams to the contracted roaming network, the IN-U-PAS 51 allocates a mobile phone/device number from the available numbers in the contracted roaming network to the subscriber as the current default phone number of the subscriber in the roaming network, and stores the mapping between the subscriber and the number. Otherwise the IN-U-PAS 51 designates the subscriber's mobile phone/device number in the network Subscriber's Mobile Network as the current default phone number of the subscriber in the roaming network.

In various non-limiting embodiments, the release of the locally-assigned-number in the contracted roaming network which is allocated to the subscriber/user/device, when the mobile phone/device subscriber leaves the contracted roaming network and registers his/her location in another network. Here, the appropriate HLR in the (home network) Subscriber's Mobile Network informs the IN-U-PAS 51 in the (home network) Subscriber's Mobile Network of the subscriber's location update to indicate that the subscriber has moved out of the network. In various non-limiting embodiments, this would preferably cause the IN-U-PAS 51 to release the locally-assigned-number occupied by the subscriber and break the mapping between the number and the subscriber. In various non-limiting embodiments, the time span from allocation of the number to releasing is referred to as the life time of the number. In various non-limiting embodiment, it would preferably require an appropriate policy/permission/condition to reuse the released locally-assigned-number in the contracted roaming network.

In various non-limiting embodiment, to avoid any possible subscriber number conflict in the dynamic allocation process, the IN-U-PAS 51 reuses released numbers with certain anti-conflict policies or combinations of policies. In various non-limiting embodiment, a practicable policy could temporarily withhold/lockout the usage/releasing of the locally-assigned-number for a certain period of lockout time. In various non-limiting embodiment, the certain period of lockout time would preferably be proportional to the life time of the number, where after the time period threshold was exceeded, the locally-assigned-number may be reallocated to another roaming subscriber.

In various non-limiting embodiments, the IN-U-PAS 51 stores and exercises above policies. In various non-limiting embodiments, the IN-U-PAS 51 binds a particular locally-assigned-number to a particular subscriber/user/device while within a particular contracted network or roaming network. In various non-limiting embodiments, the relative demand on a particular roaming network may conditionally bind and/or release the locally-assigned-number. In various non-limiting embodiments, even if the subscriber/user is not in the roaming network, the mapping and relationships between the number and the subscriber would preferably still be maintained.

Above operations are called number binding (or a locally-assigned-number-binding), and the binding relation is electronically stored in the IN-U-PAS 51 in the home network. If the network shown in FIG. 19 is used, the operator delivering localized roaming service requires obtaining mobile phone/device numbers and/or a locally-assigned-number in some roaming countries for the roaming service; those countries are called contracted roaming countries, and the amount of the required phone numbers (e.g. locally-assigned-numbers) in a contracted roaming network relates to the number of subscribers (e.g. locally-assigned-numbers) roaming in that network. In various non-limiting embodiments, the more the roaming subscribers there are, the more the required phone numbers (e.g. locally-assigned-numbers) there could be allocated. As shown in FIG. 19, in the home network, the subscriber uses number N; in the contracted roaming network A, where he/she uses a local mobile phone/device number N1; in the non-contracted roaming network B, where he/she is still using the mobile phone/device number N in the home network.

In various non-limiting embodiments, the mobile phone/device number N, N1, etc. allows the system and associated methods to further track, monitor, interrogate, and interact with a particular device/user while he/she/it is roaming. In addition, the monitoring, tracking, interrogating, and interacting of a particular mobile phone/device number N (and others, N1) allows the U-PAS 50/UPAM 53 and associated methods to further interrogate, isolate, analyze and compare data, such as roaming data, roaming patterns, roaming behaviors, roaming risks, interactions, patterns, and/or the like with a particular device/user while he/she/it is roaming. Further, such data analysis can help predict other mobile devices 61, mobile applications 244, users, locally-assigned-numbers, and/or the like that are relatively likely to: roam, have an overage, consume particular content, increase a burden on the network, U-PAS, IN-U-PAS, UPAM, other system, location, device, application, and/or the like. In addition, such data analysis can help predict, say potential issues, bottlenecks, and overages and suggest resolutions, remedies, user-interactions, upsells, recommendations, application, equipment upgrades, OS upgrades, and/or the like that have been found historically to relatively improve performance of a particular mobile device 61, mobile application 244, mobile OS, locally-assigned-number, and/or the like; as well as historical data on decreasing costs to the mobile network, costs to the subscriber, costs to other network providers, and/or the like.

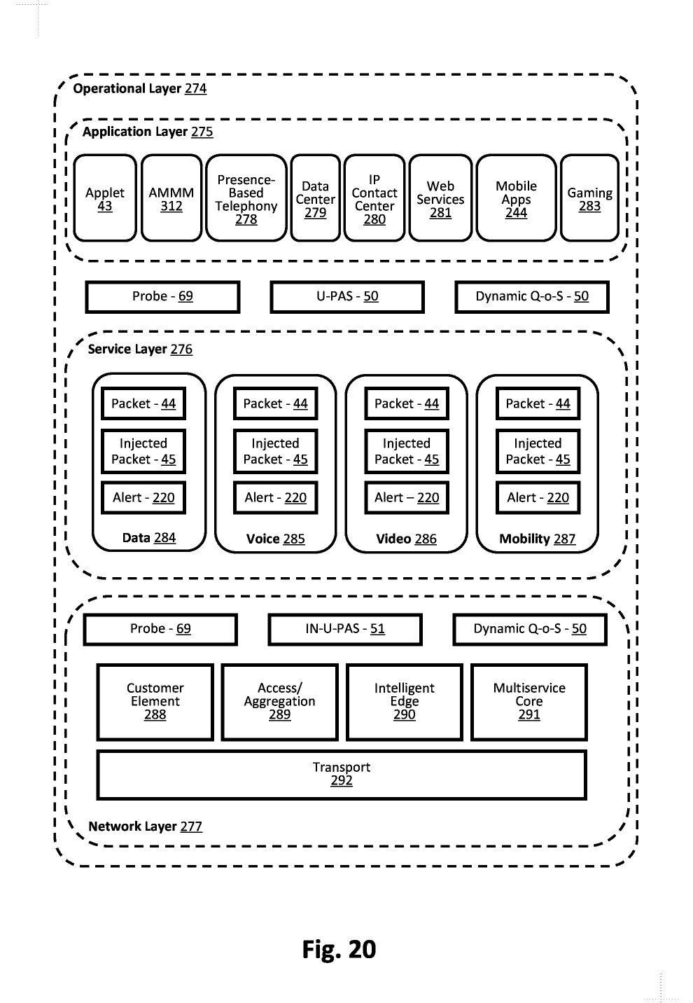

FIG. 20 depicts a flowchart of an embodiment of the QoS module and mechanisms. Here an Operational Layer 274 comprises an Application Layer 275, a Service Layer 276, a Network Layer 277, the Probe 69, the U-PAS 50, and the Dynamic O-o-S 50. The Application Layer 275 comprises the Applet 43, the AMMM 312, a Presence-Based Telephony 278, a Data Center 279, an IP Contact Center 280, a Web Services 281, the Mobile Apps 244, and a Gaming 283 applications. The Service Layer 276 comprises a Data 284, a Voice 285, a Video 286, and a Mobility 287 services. The Data 284, Voice 285, Video 286, and the Mobility 287 services may each contain the Packet 44, the Injected Packet 45, and an Alert 220 (e.g. AAM, SMS, MMS, email, direct mail, voicemail, customer service call, and/or the like). The Network Layer 277 comprises a Customer Element 288, an Access/Aggregation 289, an Intelligent Edge 290, a Multiservice Core 291, a Transport 292 layer and may also contain the Probe 69, the IN-U-PAS 51, and the Dynamic O-o-S 50.

Implementing, determining, and providing a system for providing network support services and premises gateway support infrastructure (operational via a computer processor) and (computer-processor-based) method is described in U.S. Pat. No. 8,281,010 B2, Ansari et al., is hereby incorporated by reference in its entirety for all purposes, which can be implemented in various non-limiting embodiments of the present disclosure. Described in Ansari et al. is a high-level diagram of the architecture of a gateway-service management center network, as well as a logical flow of how a specific Application Client (e.g. residing at a User Premises) that can interact with an Application Service (AS) in a gateway device that is being managed in the gateway-service management center network configuration. Further, application services are described that can form part of an Application Service Delivery Platform were logically positioned at the Application Service Layer (or AS Layer) on the network side of a Network Service Provider Demarcation. According to Ansari et al., many of these application services were previously offered from network-side servers have now been moved across a Network Service Provider Demarcation and now logically reside at the AS Layer in the User Premises Network, i.e., on the hardware components located in the user premises, such as, by example, a gateway device.

In particular, Ansari, et al. mentions that the programming that implements application services is logically positioned on the user premises side of the Network Service Provider Demarcation. The application service on the user premises side that enforces authorization, authentication, configuration, or use of the respective service via an endpoint device are logically depicted in Ansari et al. as an Application Services Enforcement module [not to be confused with the Action Selection Engine (ASE) referenced earlier] in the AS Layer of the User Premises Network. According to Ansari, et al., the Application Services Enforcement module may also communicate via the wide area network with an Application Services Management (ASM) logic residing in the service management center.

Ansari, et al., goes on to explain that the system includes application service logic that provides enforcement regarding authorization, authentication, configuration, and/or use of the respective service via the endpoint devices. The application service includes service and feature functions, implemented and controlled by the application service logic. Management of the application service is based on communications with the service management center via the wide area network. An illustrated architecture in Ansari, et al. depicts a gateway device-service management center network that enables other features and capabilities. For instance, peer-to-peer application communication between or among gateways without the need to go through, or utilize resources at, an external service management center is possible. Communications through the service management center are also possible. In addition, an ability to manage the various endpoint devices associated with it, where a user interface with the gateway can be presented and utilized on the home TV. Additionally, information from other endpoint devices, such as the PC, network sources (such as an RSS (Really Simple Syndication) service), may be overlaid on the TV screen so that, for example, PC messages, or weather information, can be viewed on the TV screen, and the functionality of the PC (or other home networked end-point devices) can be accessed from the TV screen.

Referring back to the present disclosure, the communication device may be a computing device, such as the Television/IPTV 68 back in FIG. 1, or other network appliance capable of communicating over the network 300, such as private networks, WiFi, WiMax, mesh networks, and/or the like, where such network management methods and functionality as is described in Ansari could be employed in various non-limiting embodiments.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In addition, the term application as used herein refers to computer software program in general and can further encompass data, configuration settings, etc., used by the computer software program. Examples include utilities such as e-mail, Short Message Service (SMS) text utility, DTMF, IM, chat interface, web browsers, calculators, viewers, media players, games, calendars, tasks, to-do-lists, shopping-lists, contact managers, home monitoring/security surveillance, etc. In an exemplary aspect, application can refer to software that is suitable for use on the mobile device 61, especially to being downloaded via a Wireless Local Access Network (WLAN) or Wireless Wide Area Network (WWAN).

The word “exemplary” used anywhere herein is to mean serving as an example, instance, or illustration. Any aspect or design described herein as “exemplary” is not necessarily to be construed as preferred or advantageous over other aspects or designs. Various aspects will be presented in terms of systems that may include a number of components, modules, and the like. For example, a reference to the U-PAS 50 (system) would broadly imply the UPAM 53 (module) as well. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing the network such as the Internet or the local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that any claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, acronyms, antecedent-basis, statements, or other disclosure material set forth herein, will only be incorporated to the extent that no conflict arises between that incorporated material and the existing disclosure material.

The present disclosure has advanced various systems and modules which support various systems and methods, which include, but are not limited to, the following methods, which can themselves, include various methods.

Method 1. A computer-implemented method, comprising: receiving a data packet from a second node at a first node, wherein the first node comprises a usage and performance analyzer module (UPAM); determining a data attribute from the data packet, wherein the data attribute identifies the second node; classifying the data attribute according to a predetermined stored policy, the policy with an association with a predetermined behavior of the second node or of an application of the second node; determining, if the classification meets a predefined criteria; generating and transmitting a message to the second node in accordance with the predetermined stored policy.

Method 2. Method 1, wherein the second node comprises a mobile device.

Method 3. Method 2, wherein the mobile device includes an on-device applet for monitoring usage and performance.

Method 4. Any of Methods 1 to 3, wherein the usage and performance analyzer module (UPAM) implements the predetermined stored policy, and the policy comprises a dynamic offender policies and enforcement (DOPE) module, the dynamic offender policies and enforcement module comprising a dynamic offender policies and enforcement criteria and parameters.

Method 5. Method 4, wherein the dynamic offender policies and enforcement criteria and parameters comprise: a past actions status and timers (PAST) module comprising past actions status and timers criteria and parameters; a targeted offers notifications and enforcement (TONE) module comprising targeted offers notifications and enforcement criteria and parameters; a success of offers remedies and termination (SORT) module comprising success of offers notifications and enforcement criteria and parameters; a potential offender profile score (POPS) module comprising potential offender profile score criteria and parameters.

Method 6. Any of Methods 4 or 5, wherein the predetermined stored policy is persistently monitored according to the dynamic offender policies and enforcement module.

Method 7. Method 6, wherein the dynamic offender policies and enforcement module performs an exchange and update of information with a mobile network operator and vice versa.

Method 8. Any of Methods 1 to 7, wherein the classification comprises a past offense count representing a number of offenses of the predetermined stored policy.

Method 9. Any of Methods 5 to 8, wherein the classification is tracked by the past actions status and timers module.

Method 10. Any of Methods 5 to 9, wherein the classifying the data attribute according to a predetermined stored policy includes classifying the data attribute into one of a plurality of classifications, the plurality of classifications comprising: a perceived non-offender classification, a first time offender classification, a repeat offender classification, and a habitual offender classification.

Method 11. Method 10, wherein the classifications are associated with a specific computer.

Method 12. Method 11, wherein the specific computer comprises a unique identifier, wherein the unique identifier preferably comprises at least one of: a mobile directory number, electronic serial number, locally-assigned-number, port number, destination address, media access control address, phone number, directory number, forwarding number, call-back number, mobile phone number, fax number, VoIP number, extension phone number, phone number area code, phone number prefix, and country code phone number.

Method 13. Any of Methods 1 to 12, wherein the second node is associated with a specific user, wherein preferably the specific user is associated with a current plan and a specific mobile network operator.

Method 14. Method 13, wherein the current plan includes a limit, wherein preferably the limit comprises an in-networking calling limit, calling limit, and roaming limit.

Method 15. An arrangement, comprising: a processing circuitry configured to: receive a data packet from a second node at a first node, wherein the first node comprises a usage and performance analyzer module (UPAM); determine a data attribute from the data packet, wherein the data attribute identifies the second node; classify the data attribute according to a predetermined stored policy, the policy describing a predetermined behavior of the second node or of an application of the second node; determine, if the classification meets a predefined criteria; generate and transmitting a message to the second node in accordance with predetermined stored policy.

Method 16. A computer-implemented method, comprising: classifying a first usage pattern from a plurality of inputs from an at least one node; wherein the first usage pattern is stored as a first stored usage pattern; monitoring the plurality of inputs of the at least one node; determining, if a second usage pattern of the at least one node meets a stored relationship policy in relationship with the first stored usage pattern; generating and transmitting an event in accordance with the determination of the stored relationship policy.

Method 17. Method 16, wherein the at least one node comprises a mobile device.

Method 18. Method 16 to 17, wherein the mobile device includes an on-device applet for persistently monitoring usage and performance.

Method 19. Any of Methods 16 to 18, wherein the on-device applet for monitoring usage and performance includes a usage and performance analyzer module (UPAM).

Method 20. Any of Methods 16 to 19, wherein the usage and performance analyzer module (UPAM) implements the stored relationship policy based in part on a web browsing input and/or an application input.

Method 21. Method 16 to 20, wherein the stored relationship policy in relationship with the first stored usage pattern is affected by an input from the group comprising the plurality of inputs from the at least one node, a plurality of inputs from a plurality of nodes, a plurality of inputs from a predefined group of nodes, a plurality of inputs from a predefined segmentation of nodes, some combinations of these inputs, or some permutation of these inputs.

Method 22. Method 16 to 21, wherein the generated and transmission of the event in accordance with the stored relationship policy and determination includes an offer to the at least one node.

Method 23. Any of Methods 16 to 22, wherein the classification comprises a past usage pattern representing a number of inputs according to the stored relationship policy in relationship with the first stored usage pattern.

Method 24. Any of Methods 16 to 23, wherein the classification is tracked by the past actions status and timers module.

Method 25. Any of Methods 16 to 24, wherein the classifying the first usage pattern from a plurality of inputs from an at least one node includes classifying the data attribute into one of a plurality of classifications, the plurality of classifications comprising: a perceived non-opportunity classification, a first time opportunity classification, a repeat opportunity classification, and a repeat-loyalty opportunity classification.

Method 26. A computer-implemented method comprising: receiving a data packet from a second node at a first node; evaluating the data packet to determine a data attribute wherein the data attribute identifies the second node; evaluating a classification of the data attribute according to a policy; determining, if the classification meets a criteria; invoking the policy according to the criteria.

Method 27. Method 26, wherein the second node comprises a second computer.

Method 28. Method 27, wherein the computer comprises a mobile device.

Method 29. Method 28, wherein the mobile device includes an on-device applet for monitoring usage and performance.

Method 30. Method 26, wherein the first node comprises a first computer.

Method 31. Method 30, wherein the first computer comprises a usage and performance analyzer system (UPAS).

Method 32. Method 31, wherein the UPAS includes a UPAS server.

Method 33. Method 31, wherein the UPAS comprises a usage and performance analyzer module (UPAM).

Method 34. Method 33, wherein the UPAM implements the policy and the policy comprises a dynamic offender polices and enforcement (DOPE) module.

Method 35. Method 34, wherein the DOPE module comprising a DOPE criteria and parameters.

Method 36. Method 35, wherein the DOPE criteria and parameters comprises; a past actions status and timers (PAST) module, the PAST module comprising PAST criteria and parameters; a targeted offers notifications and enforcement (TONE) module, the TONE module comprising TONE criteria and parameters; a success of offers remedies and termination (SORT) module, the SORT module comprising SORT criteria and parameters; a potential offender profile score (POPS) module, the POPS module comprising POPS criteria and parameters.

Method 37. Method 35, wherein the policy is persistently monitored according to the DOPE module.

Method 38. Method 37, wherein the DOPE performs an exchange and update of information with a mobile network operator (MNO) and vice versa.

Method 39. Method 38, wherein the exchange and update of information with the MNO includes a mobile switching center (MSC), a visiting location register (LVR), an operations support systems/business support system (OSS/BSS), a home locator recorder (HLR), an in network UPAS (INUPAS), and a mobile app server.

Method 40. Method 35, wherein the DOPE module performs the exchange and update of information with an Internet service provider (ISP) and vice versa.

Method 41. Method 26, wherein the classification is performed by a PAST module.

Method 42. Method 41, wherein the performance of the classifications comprises a past offense count.

Method 43. Method 42, wherein the performance of the classification comprises a time period and a time windows measured.

Method 44. Method 26, wherein the classification is tracked by the PAST module.

Method 45. Method 44, wherein the classifications performed by the PAST module comprise non-overlapping classifications.

Method 46. Method 45, wherein the series of non-overlapping classifications include a perceived non-offender (PNO) classification up to a first time offender (FTO) classification up to a repeat offender (RO) classification up to a habitual offender (HO) classification.

Method 47. Method 46, wherein the series of non-overlapping classifications are associated with a specific computer.

Method 48. Method 47, wherein the series of non-overlapping classifications comprises a criteria range, bottom threshold, and top threshold relative to the perceived non-offender (PNO) classification, first time offender (FTO) classification, repeat offender (RO) classification, and habitual offender (HO) classification.

Method 49. Method 48, wherein the series of non-overlapping classifications incorporates an ascension from the perceived non-offender (PNO) classification up to the first time offender (FTO) classification up to the repeat offender (RO) classification up to the habitual offender (HO) classification.

Method 50. Method 49, wherein the ascension generates a list comprising a policy, policy unique identifier, priority, timer, remedy, payment, contract modification, upgrade, insurance, challenge, reversion, reverting, packet injection, service variance, performance variance, compression, suspension, service cap, throttling, and termination.

Method 51. Method 50, wherein the ascension initializes a list comprising a policy, policy unique identifier, priority, timer, remedy, payment, contract modification, upgrade, insurance, challenge, reversion, reverting, packet injection, service variance, performance variance, compression, suspension, service cap, throttling, and termination.

Method 52. Method 47, wherein the specific computer comprises a unique identifier.

Method 53. Method 52, wherein the unique identifier comprises a mobile directory number (MDN), an electronic serial number, a locally-assigned-number, port number, destination address, media access control (MAC) address, phone number, directory number, forwarding number, call-back number, mobile phone number, fax number, VoIP number, extension phone number, phone number area code, phone number prefix, and country code phone number.

Method 54. Method 53, wherein the specific computer comprises a mobile device.

Method 55. Method 54, wherein the mobile device is associated with a specific network.

Method 56. Method 54, wherein the mobile device is browsing a network.

Method 57. Method 56, wherein the network browsing generates a browsing history.

Method 58. Method 57, wherein the browsing history comprise a characteristic.

Method 59. Method 58, wherein the characteristic comprise a targeting attribute based upon an association with the characteristic.

Method 60. Method 59, wherein the targeting attribute comprises a notification, alert, offer, option, warning, message, audio, video, html-based alert, email, SMS, voicemail, upgrade option, upsell opportunity, modification option, negotiation-settlement, payment option, credit request, QoS modification, on-device monitoring applet, contract adjustment, product, service, segmentation option, billing option, and bidding option.

Method 61. Method 60, wherein the targeting attribute comprises a location, xyz coordinates, GPS coordinates, triangulation location, signal strength approximation, pattern of usage, temporal component, usage history, and zip code.

Method 62. Method 36, wherein the DOPE criteria is based in part on an exchange and update of information supplied by a mobile network (MN).

Method 63. Method 62, wherein the exchange and update of information supplied by the MN includes parameters.

Method 64. Method 63, wherein the DOPE criteria is based in part on the exchange and update of information supplied by the MNO.

Method 65. Method 64, wherein the exchange and update of information supplied by the MNO includes parameters.

Method 66. Method 65, wherein the MNO parameters comprise a capacity.

Method 67. Method 66, wherein the capacity is relative to a group comprising an overall network, pathway, route, location, physical destination address, port number and destination address, process unique identifier (UID), application UID, IP address, device, peering point, and access point address.

Method 68. Method 66, wherein the capacity is relative to a group comprising an application layer, operating system layer, network layer, data link layer, and physical later.

Method 69. Method 66, wherein the capacity is relative to a group comprising an operational layer, application layer, service layer, network layer, transport layer, dynamic quality of service (QoS) and probe.

Method 70. Method 66, wherein the capacity is relative to a group comprising an Function, comprising downloading, streaming, tethering, browsing, roaming, emailing, calling out, call receiving, application usage.

Method 71. Method 66, wherein the capacity is relative to a group comprising a proximate location of the mobile device.

Method 72. Method 66, wherein the capacity comprises a current consumption, consumption rate, consumption allowance, consumption duration, allowance duration, duration time, and allowance timer.

Method 73. Method 66, wherein the capacity comprises a ratio of consumption per allowance.

Method 74. Method 73, wherein the ratio of consumption per allowance includes consumption and allowance from the group comprising, data, calling minutes, SMS texting characters, SMS interactions, VoIP minutes, WiFi usage, tethering, roaming data, roaming minutes, GPS usage, in-vehicle usage, IPTV usage, on-mobile-device usage, specific application usage, applet usage, cloud-based, mobile application server usage, specific content usage, specific location usage, event usage, specific network usage, and locally-assigned-number usage.

Method 75. Method 66, wherein the capacity is relative to a group comprising a specific device, plurality of devices, plurality of specific devices, segment of devices, and classification of devices.

Method 76. Method 63, wherein the MN parameters are assigned by the MNO.

Method 77. Method 65, wherein the MNO parameters are assigned by the MNO.

Method 78. Method 26, wherein the second node is associated with a specific user.

Method 79. Method 78, wherein the specific user is associated with a current plan and a specific MNO.

Method 80. Method 79, wherein the current plan includes a plurality of users.

Method 81. Method 80, wherein the plurality of users constitutes a group plan.

Method 82. Method 79, wherein the current plan includes a limit.

Method 83. Method 82, wherein the limit comprises an in-networking calling limit, calling limit, and roaming limit.

Method 84. Method 82, wherein the limit is relative to temporal component.

Method 85. Method 81, wherein the limit is relative to a specific device in the group plan.

Method 86. Method 82, wherein the limit includes a threshold.

Method 87. Method 82, wherein the limit generates a default threshold.

Method 88. Method 86, wherein a specific user adjusts the threshold.

Method 89. Method 86, wherein exceeding the threshold triggers the policy.

Method 90. Method 86, wherein exceeding the threshold triggers a list of remedies.

Method 91. Method 86, wherein exceeding the threshold triggers an attempted interaction or an interaction.

Method 92. Method 90, wherein list of remedies comp comprises a payment, contract modification, upgrade, insurance, challenge, reversion, reverting, packet injection, service variance, performance variance, compression, suspension, service capping, location capping, content reformatting, throttling, and termination.

Method 93. Method 36, wherein the DOPE criteria is based in part on parameters supplied by the specific user.

Method 94. Method 91, wherein the attempted interaction and the interaction are associated with a specific user.

Method 95. Method 94, wherein the attempted interaction and the interaction are tracked and scored for a relative success.

Method 96. Method 95, wherein the tracking and scoring for the relative success is performed by a success of offers remedies and termination (SORT) module.

Method 97. Method 96, wherein the evaluating of the data packet is performed by a packet capture analyze index and inject (PCAII) module to determine data attributes.

Method 98. Method 97, wherein the PCAII module is operationally coupled with a timer, statistics, and a quality of service (QoS) module.

Method 99. A computer-implemented method, comprising: receiving a packet from a data traffic flow in packet-based core network; evaluating the packet via a packet capture, analyze, index and inject (PCAII) module to identify and generate a list of prioritized associations; retrieving information from a customer database and from a usage and performance analyzer (UPAM) module regarding the list of prioritized associations, wherein the information includes a uniquely-identified attribute from the group comprising a specific device, user, contract, interaction, criteria, application, source, event, location, window of time, threshold, or resolution; analyzing the information retrieved and the list of prioritized associations relative to the uniquely-identified attribute to determine a criteria, wherein each criteria includes a unique-iterative-profile along with a variable dynamic management policy with associated instructions; implementing the variable dynamic management policy and associated instructions per the unique-iterative-profile.

Method 100. Method 99, wherein the variable dynamic management policy comprises a priority, timer, remedy, payment, contract modification, upgrade, insurance, challenge, reversion, reverting, packet injection, service variance, performance variance, compression, suspension, service cap, throttling, and termination.

Method 101. Method 99, wherein the unique-iterative-profile comprise parameters, characteristics, criteria, and thresholds.

Method 102. Method 101, wherein the parameter, characteristic, criteria, or threshold of unique-iterative-profile triggers a targeted offers notifications and enforcement (TONE) module.

Method 103. Method 99 wherein implementing the variable dynamic management policy is performed on a device-by-device basis.

Method 104. A computer-implemented method, comprising: receiving a data packet from a second node at a first node; evaluating the data packet to determine a data attribute; initializing a policy, the policy including criteria comprising parameters; comparing the data attribute with at least a first criteria; determining whether the data attribute exceeds a predetermined threshold of a parameter of the criteria, wherein if the predetermined threshold is exceeded an offense is generated; transmitting the offense to the second node through a message selection engine (MSE).

Method 105. A computer-implemented method, comprising: receiving a data packet from a second node at a first node; evaluating the data packet to determine a data attribute; initializing a policy, the policy including criteria comprising parameters; comparing the at least one data attribute with at least a first criteria; determining whether the at least one data attribute exceeds a predetermined threshold of a parameter of the criteria wherein if the predetermined threshold is exceeded an offense is generated; transmitting the offense to the second node through an action selection engine (ASE).

Method 106. A computer-implemented method, comprising: receiving a data packet from a second node at a first node; evaluating the data packet to determine a data attribute; initializing a policy, the policy including criteria comprising parameters; comparing the at least one data attribute with at least a first criteria; determining whether the at least one data attribute exceeds a predetermined threshold of a parameter of the criteria wherein if the predetermined threshold is exceeded a remedy is retrieved; transmitting the remedy to the second node through a targeted offers notifications and enforcement (TONE) module.

Method 107. A computer-implemented method, comprising: receiving a data packet from a second node at a first node; evaluating the data packet to determine a data attribute wherein the data attribute identifies the second node; evaluating a classification of the second node; determining if the classification meets a criteria; determining if an exception applies to the second node; invoking a policy according to the criteria.

Method 108. A computer-implemented method, comprising: receiving a data packet from a second node at a first node; evaluating the data packet to determine a data attribute, wherein the data attribute identifies the second node; retrieving a usage plan associated with the second node; evaluating a criteria of the usage plan; comparing the data attribute with the criteria of the usage plan, wherein if a predetermined threshold is exceeded an offense is generated; transmitting the offense to the second node.

Method 109. A computer-implemented method, comprising: receiving a data packet from a second node at a first node; evaluating the data packet to determine a data attribute, wherein the data attribute identifies the second node; retrieving a usage plan associated with the second node; evaluating a criteria of the usage plan; comparing the data attribute with the criteria of the usage plan, wherein if a predetermined threshold is exceeded a remedy is generated; transmitting the remedy to the second node through a targeted offers notifications and enforcement (TONE) module.

Method 110. A computer-implemented method, comprising: receiving a data packet from a second node; evaluating an attribute from the data packet at a first node, wherein attribute identifies the second node; receiving a policy assigned to the second node; determining, if a condition is met based upon an evaluation of the policy, wherein the condition invokes a list of prioritized remedies; sending a remedy in accordance with the list of prioritized remedies to the second node; monitoring for an interaction performed by the second node, wherein the interaction satisfies the remedy.

Method 111. Method 110, wherein the interaction is tracked and updates the policy.

Method 112. A computer-implemented method, comprising: receiving a data packet from a second node; evaluating an attribute from the data packet at a first node, wherein attribute identifies the second node; receiving a past actions status and timers (PAST) classification assigned to the second node; determining if the PAST classification meets a criteria; invoking a policy according to the criteria.

Method 113. A computer-implemented method, comprising: receiving a data packet associated with a second node at a first node; identify a set of attributes from the data packet; comparing the set of attributes to attributes received from prior nodes; assigning a classification based upon the comparison; determining, if the classification meets a criteria; invoking a policy according to the criteria.

Method 114. A computer-implemented method, comprising: receiving a data packet associated with a second node at a first node; identify a set of attributes from the data packet; comparing the set of attributes to attributes received from a plurality of prior nodes; assigning a classification to the second node based upon the comparison; determining if the classification meets a criteria; invoking a policy according to the criteria.

Method 115. A computer-implemented method, comprising: receiving a data packet associated with a second node; generating an attribute from the data packet at a first node, wherein attribute identifies an application operated on the second node; evaluating the application according to a mobile network operator (MNO) criteria and parameters to generate a policy; incorporating the policy within a dynamic offender policies and enforcement (DOPE) module to enforce the policy; monitoring a mobile network (MN) for a violation of the policy.

Method 116. A computer-implemented method, comprising: receiving a data packet associated with a second node; generating an attribute from the data packet at a first node, wherein attribute identifies an activity on the second node; evaluating the activity according to a usage and performance analyzer module (UPAM) comprising: a dynamic offender polices and enforcement (DOPE) module, the DOPE module comprising a DOPE criteria and parameters; a past actions status and timers (PAST) module, the PAST module comprising DOPE criteria and parameters; a targeted offers notifications and enforcement (TONE) module, the TONE module comprising TONE criteria and parameters; a success of offers remedies and termination (SORT) module, the SORT module comprising SORT criteria and parameters; a potential offender profile score (POPS) module, the POPS module comprising POPS criteria and parameters.

Method 117. A usage and performance analyzer system (UPAS) the system comprising: a packet capture analyze index and inject (PCAII) module to identify data attributes; a quality of service (QoS) module; a usage and performance analyzer module (UPAM) implementing a policy wherein the policy comprises: a dynamic offender polices and enforcement (DOPE) module, the DOPE module comprising a DOPE criteria and parameters; a past actions status and timers (PAST) module, the PAST module comprising DOPE criteria and parameters; a targeted offers notifications and enforcement (TONE) module, the TONE module comprising TONE criteria and parameters; a success of offers remedies and termination (SORT) module, the SORT module comprising SORT criteria and parameters; a potential offender profile score (POPS) module, the POPS module comprising POPS criteria and parameters.

Method 118. The UPAS system of Claim117, wherein the PCAII module is coupled with a statistics.

Method 119. The UPAS system of Claim117, wherein the PCAII module is coupled with a timer.

Method 120. The UPAS system of Claim119, wherein the timer is initialized.

Method 121. The UPAS system of Claim120, wherein the timer initialization is performed according the DOPE module.

Method 122. The UPAS system of Claim117, wherein the UPAS is physically located inside a mobile network (MN).

Method 123. The UPAS system of Claim117, wherein the UPAS is physically located inside a mobile network operator (MNO).

Method 124. The UPAS system of Claim117, wherein the UPAM is physically located on a mobile device.

Method 125. The UPAS system of Claim117, wherein the UPAS is operationally coupled with a probe.

Method 126. The UPAS system of Claim125, wherein the probe is operationally interconnected to a group comprising an internet service provider (ISP), an access point (AP), a public switched telephone network (PSTN), a mobile network (MN), and a mobile network operator (MNO).

Method 127. The UPAS system of Claim125, wherein the probe is operationally interconnected to a group comprising a mobile switching center (MSC), a visiting location register (LVR), an operations support systems/business support system (OSS/BSS), a home locator recorder (HLR), an in network UPAS (INUPAS), a Roaming Number Manager (RNM), and a mobile app server.

Method 128. The UPAS system of Claim125, wherein the probe is operationally interconnected to a group comprising a home mobile network, a first roaming network, a second roaming network, a peering point, a software defined network (SDN), and a wireless network.

Method 129. The UPAS system of Claim117, wherein the DOPE parameters comprise a historical usage parameter, a current plan parameter, a current usage parameter, and a DOPE Iteration UID parameter.

Method 130. The UPAS system of Claim117, wherein the PAST parameters comprise a past offense count parameter, a time period per window-measured parameter, and a PAST classification.

Method 131. The UPAS system of Claim129, wherein the PAST classifications comprise a series of non-overlapping classifications.

Method 132. The UPAS system of Claim88, wherein the series of non-overlapping classifications ascend from a perceived non-offender (PNO) up to a first time offender (FTO) up to a repeat offender (RO) up to a habitual offender (HO).

Method 133. The UPAS system of Claim117, wherein the TONE parameters comprise an exception and allowance parameter, a throttling permission parameter, an interaction method available for the potential offender parameter, a segmentation targeting parameter, a data per each interaction employed parameter, and a time allowed per time-to-resolution parameter.

Method 134. The UPAS system of Claim117, wherein the TONE parameters comprise a plan modification parameter, a payment made per requirement parameter, a suspension parameter, a suspension by whom and when parameter, a termination parameter, a termination performed by whom and when parameter, and an account parameter.

Method 135. The UPAS system of Claim117, wherein the TONE parameters comprise a variance, variable-bit-rate quality, variable-bit-rate quantity, variable-bit-rate output, variable-bit-rate duration, variable-bit-rate adjustment, and bit-rate implementation.

Method 136. The UPAS system of Claim117, wherein the TONE parameters comprise a content format, content format quality, content format quantity, content format duration, content format output, content format adjustment, and content format implementation.

Method 137. The UPAS system of Claim117, wherein the TONE parameters comprise a throttle, throttle quality, throttle quantity, throttle output, throttle duration, throttle adjustment, and throttle implementation.

Method 138. The UPAS system of Claim117, wherein the TONE parameters comprise a packet injection, packet injection output, packet injection adjustment, and packet injection implementation.

Method 139. The UPAS system of Claim117, wherein the TONE parameters comprise a routing path, routing quality, routing quantity, routing output, routing duration, routing adjustment, and routing implementation.

Method 140. The UPAS system of Claim117, wherein the TONE parameters comprise a cap, cap level, cap quality, cap quantity, cap output, cap duration, cap adjustment, and cap implementation.

Method 141. The UPAS system of Claim117, wherein the TONE parameters comprise a compression, compression output, compression level, compression quantity, compression quality, compression duration, compression adjustment, and compression implementation.

Method 142. The UPAS system of Claim117, wherein the TONE parameters comprise a content resolution, content resolution level, content resolution quality, content resolution quantity, content resolution output, content resolution duration, content resolution adjustment, and content resolution implementation.

Method 143. The UPAS system of Claim117, wherein the SORT parameters comprise a tracking of the TONE module, criteria, and parameters.

Method 144. The UPAS system of Claim117, wherein the POPS parameters comprise a profile fact parameter, an approved assumption parameter, an assumption pending parameter, and a POPS iteration UID parameter.

Method 145. The UPAS system of Claim144, wherein the profile fact parameter includes an approved by whom parameter, a verified by what source parameter, a via what query parameter, and a temporal parameter.

Method 146. The UPAS system of Claim144, wherein the assumption pending parameter triggers a series of queries.

Method 147. The UPAS system of Claim146, wherein the series of queries interrogates a list of prioritized sources.

Method 148. The UPAS system of Claim147, wherein the interrogating of the list of prioritized sources generates a detail.

Method 149. The UPAS system of Claim148, wherein the detail constitutes a validation.

Method 150. The UPAS system of Claim149, wherein the validation constitutes a profile fact.

The foregoing description of the present disclosure has been provided for purposes of illustration and description. It is not intended to be exhaustive or to limit the disclosure to the precise forms disclosed. Many modifications and variations will be apparent to the practitioner skilled in the art. Embodiments were chosen and described in order to best explain the principles of the disclosure and its practical application, thereby enabling others skilled in the art to understand the disclosure, the various embodiments and with various modifications that are suited to the particular use contemplated. It is intended that the scope of the disclosure be defined by the following claims and their equivalents.

1. A computer-implemented method, comprising:
receiving a data packet from a second node at a first node, wherein the first node comprises a usage and performance analyzer module (UPAM);
determining a data attribute from the data packet, wherein the data attribute identifies the second node;
classifying the data attribute according to a predetermined stored policy, the policy with an association with a predetermined behavior of the second node or of an application of the second node;
determining, if the classification meets a predefined criteria; and
generating and transmitting a message to the second node in accordance with the predetermined stored policy.

2. The computer-implemented method of claim 1, wherein the second node comprises a mobile device.

3. The computer-implemented method of claim 2, wherein the mobile device includes an on-device applet for monitoring usage and performance.

4. The computer-implemented method of claim 3, wherein the usage and performance analyzer module (UPAM) implements the predetermined stored policy, and the policy comprises a dynamic offender policies and enforcement (DOPE) module, the dynamic offender policies and enforcement module comprising a dynamic offender policies and enforcement criteria and parameters.

5. The computer-implemented method of claim 4, wherein the dynamic offender policies and enforcement criteria and parameters comprise:
a past actions status and timers (PAST) module comprising past actions status and timers criteria and parameters;
a targeted offers notifications and enforcement (TONE) module comprising targeted offers notifications and enforcement criteria and parameters;
a success of offers remedies and termination (SORT) module comprising success of offers notifications and enforcement criteria and parameters; and
a potential offender profile score (POPS) module comprising potential offender profile score criteria and parameters.

6. The computer-implemented method of claim 5, wherein the predetermined stored policy is persistently monitored according to the dynamic offender policies and enforcement module.

7. The computer-implemented method of claim 6, wherein the dynamic offender policies and enforcement module performs an exchange and update of information with a mobile network operator and vice versa.

8. The computer-implemented method of claim 7, wherein the classification comprises a past offense count representing a number of offenses of the predetermined stored policy.

9. The computer-implemented method of claim 8, wherein the classification is tracked by the past actions status and timers module.

10. The computer-implemented method of claim 9, wherein the classifying the data attribute according to a predetermined stored policy includes classifying the data attribute into one of a plurality of classifications, the plurality of classifications comprising: a perceived non-offender classification, a first time offender classification, a repeat offender classification, and a habitual offender classification.

11. The computer-implemented method of claim 10, wherein the classifications are associated with a specific computer.

12. The computer-implemented method of claim 11, wherein the specific computer comprises a unique identifier, wherein the unique identifier preferably comprises at least one of: a mobile directory number, electronic serial number, locally-assigned-number, port number, destination address, media access control address, phone number, directory number, forwarding number, call-back number, mobile phone number, fax number, VoIP number, extension phone number, phone number area code, phone number prefix, and country code phone number.

13. The computer-implemented method of claim 12, wherein the second node is associated with a specific user, wherein preferably the specific user is associated with a current plan and a specific mobile network operator.

14. The computer-implemented method of claim 13, wherein the current plan includes a limit, wherein preferably the limit comprises an in-networking calling limit, calling limit, and roaming limit.

15. An arrangement, comprising: a processing circuitry configured to:
receive a data packet from a second node at a first node, wherein the first node comprises a usage and performance analyzer module (UPAM);
determine a data attribute from the data packet, wherein the data attribute identifies the second node;
classify the data attribute according to a predetermined stored policy, the policy describing a predetermined behavior of the second node or of an application of the second node;
determine, if the classification meets a predefined criteria; and
generate and transmitting a message to the second node in accordance with predetermined stored policy.

16. A computer-implemented method, comprising:
classifying a first usage pattern from a plurality of inputs from an at least one node; wherein the first usage pattern is stored as a first stored usage pattern;
monitoring the plurality of inputs of the at least one node;
determining, if a second usage pattern of the at least one node meets a stored relationship policy in relationship with the first stored usage pattern; and
generating and transmitting an event in accordance with the determination of the stored relationship policy.

17. The computer-implemented method of claim 16, wherein the at least one node comprises a mobile device.

18. The computer-implemented method of claim 17, wherein the mobile device includes an on-device applet for persistently monitoring usage and performance.

19. The computer-implemented method of claim 18, wherein the on-device applet for monitoring usage and performance includes a usage and performance analyzer module (UPAM).

20. The computer-implemented method of claim 19, wherein the usage and performance analyzer module (UPAM) implements the stored relationship policy based in part on a web browsing input and/or an application input.

21. The computer-implemented method of claim 20, wherein the stored relationship policy in relationship with the first stored usage pattern is affected by an input from the group comprising the plurality of inputs from the at least one node, a plurality of inputs from a plurality of nodes, a plurality of inputs from a predefined group of nodes, a plurality of inputs from a predefined segmentation of nodes, some combinations of these inputs, or some permutation of these inputs.

22. The computer-implemented method of claim 21, wherein the generated and transmission of the event in accordance with the stored relationship policy and determination includes an offer to the at least one node.

23. The computer-implemented method of claim 22, wherein the classification comprises a past usage pattern representing a number of inputs according to the stored relationship policy in relationship with the first stored usage pattern.

24. The computer-implemented method of claim 23, wherein the classification is tracked by the past actions status and timers module.

25. The computer-implemented method of claim 24, wherein the classifying the first usage pattern from a plurality of inputs from an at least one node includes classifying the data attribute into one of a plurality of classifications, the plurality of classifications comprising: a perceived non-opportunity classification, a first time opportunity classification, a repeat opportunity classification, and a repeat-loyalty opportunity classification.

26-150. (canceled)
